(19) United States
(12) Patent Application Publication
(10) Pub. No.: US 2025/0126050 A1
(43) Pub. Date: Apr. 17, 2025

(54) DYNAMIC PROGRAMMING OF A SOURCE NODE WITH FLOW INFORMATION

(71) Applicant: Oracle International Corporation, Redwood Shores, CA (US)

(72) Inventors: Christopher David Marlatt, Seattle, WA (US); Shuvabrata Ganguly, Seattle, WA (US); Leonard Thomas Tracy, Bothell, WA (US); Myron Decker King, Arlington, MA (US); Andrey Yurovsky, Poulsbo, WA (US); Lucas Aaron Rider, Seattle, WA (US); Andrey Smirnov, Gig Harbor, WA (US); Mitch Jonathan Carlson, Bellevue, WA (US)

(73) Assignee: Oracle International Corporation, Redwood Shores, CA (US)

(21) Appl. No.: 18/912,311

(22) Filed: Oct. 10, 2024

Related U.S. Application Data
(60) Provisional application No. 63/543,879, filed on Oct. 12, 2023.
(60) Provisional application No. 63/600,910, filed on Nov. 20, 2023.

(51) Int. Cl. H04L 45/00; H04L 43/10

(52) U.S. Cl. CPC H04L 45/22; H04L 43/10

(57) ABSTRACT

Techniques for disintermediating a network path between a source and a destination are described. In an example, the source sends a first packet destined to a destination. A network node on the network path between the source and the destination performs a network operation on this packet and generates a set of instructions indicating the network operation and parameters used for performing the network operations. This set of instructions is sent to the source as a flow update. When the source needs to send a second packet to the destination, the source applies the instructions to the second packet. As such, a similar network operation is performed on the second packet at the source, thereby avoiding the need to send the second packet on the same network path that includes the network node. Accordingly, the second packet is sent on a different network path that bypasses the network node.

### CROSS-REFERENCES TO RELATED APPLICATION

The present application is a non-provisional application of and claims the benefit and priority under 35 U.S.C. 119(e) of U.S. Provisional Application No. 63/543,879, filed Oct. 12, 2023 entitled “DYNAMIC PROGRAMMING OF A SOURCE NODE WITH ROUTING INFORMATION,” and U.S. Provisional Application No. 63/600,910, filed Nov. 20, 2023 entitled “DYNAMIC PROGRAMMING OF A SOURCE NODE WITH ROUTING INFORMATION,” the entire contents of which are incorporated herein by reference for all purposes.

### FIELD OF APPLICATION

The present application relates to a cloud environment, and more specifically to communicating packets between a source node and a destination node in the cloud environment.

### BACKGROUND

The last few years have seen a dramatic increase in the adoption of cloud services and this trend is only going to increase. Various different cloud environments are being provided by different cloud service providers (CSPs), each cloud environment providing a set of one or more cloud services. The set of cloud services offered by a cloud environment may include one or more different types of services including but not restricted to Software-as-a-Service (SaaS) services, Infrastructure-as-a-Service (IaaS) services, Platform-as-a-Service (PaaS) services, and others.

While various different cloud environments are currently available, each cloud environment provides a closed ecosystem for its subscribing customers. As a result, a customer of a cloud environment is restricted to using the services offered by that cloud environment. There is no easy way for a customer subscribing to a cloud environment provided by a CSP to, via that cloud environment, use a service offered provided by a different CSP. Embodiments discussed herein address these and other issues.'

### BRIEF DESCRIPTION OF THE DRAWINGS

Features, embodiments, and advantages of the present disclosure are better understood when the following Detailed Description is read with reference to the accompanying drawings.

FIG. 1 is a high-level diagram of a distributed environment showing a virtual or overlay cloud network hosted by a cloud service provider infrastructure, according to certain embodiments.

FIG. 2 depicts a simplified architectural diagram of the physical components in the physical network within a cloud service provider infrastructure (CSPI), according to certain embodiments.

FIG. 3 shows an example arrangement within CSPI where a host machine is connected to multiple network virtualization devices (NVDs), according to certain embodiments.

FIG. 4 depicts connectivity between a host machine and an NVD for providing I/O virtualization for supporting multitenancy, according to certain embodiments.

FIG. 5 depicts a simplified block diagram of a physical network provided by a CSPI, according to certain embodiments.

FIG. 6 depicts a simplified block diagram for a traffic flow between a source and a destination.

FIG. 7 depicts a simplified block diagram for a traffic flow between a source and a destination using dynamic programming for flow information, according to some embodiments.

FIG. 8 depicts a simplified block diagram for a traffic flow between a source and a destination using an update to dynamic programming for flow information, according to some embodiments.

FIG. 9 depicts a simplified block diagram for a response from a destination to a source, according to some embodiments.

FIG. 10 depicts another simplified block diagram for a response from a destination to a source, according to some embodiments.

FIG. 11 depicts a sequence diagram for a network path disintermediation, according to some embodiments.

FIG. 12 describes a flow implemented by a source for network path disintermediation, according to some embodiments.

FIG. 13 describes a flow implemented by a network node for network path disintermediation, according to some embodiments.

FIG. 14 describes another flow implemented by a network node for network path disintermediation, according to some embodiments.

FIG. 15 describes a flow implemented by a destination for network path disintermediation, according to some embodiments.

FIG. 16 describes a flow implemented by a source for storing instructions as part of a network path disintermediation, according to some embodiments.

FIG. 17 describes a flow implemented by a source for using probe packets as part of a network path disintermediation, according to some embodiments.

FIG. 18 describes a flow implemented by a network node for sending instructions as part of a network path disintermediation, according to some embodiments.

FIG. 19 describes a flow implemented by a network node for responding to probe packets as part of a network path disintermediation, according to some embodiments.

FIG. 20 is a block diagram illustrating one pattern for implementing a cloud infrastructure as a service system, according to certain embodiments.

FIG. 21 is a block diagram illustrating another pattern for implementing a cloud infrastructure as a service system, according to certain embodiments.

FIG. 22 is a block diagram illustrating another pattern for implementing a cloud infrastructure as a service system, according to certain embodiments.

FIG. 23 is a block diagram illustrating another pattern for implementing a cloud infrastructure as a service system, according to certain embodiments.

FIG. 24 is a block diagram illustrating an example computer system, according to certain embodiments.

### DETAILED DESCRIPTION

In the following description, for the purposes of explanation, specific details are set forth in order to provide a thorough understanding of certain embodiments. However, it will be apparent that various embodiments may be practiced without these specific details. The figures and description are not intended to be restrictive. The word “exemplary” is used herein to mean “serving as an example, instance, or illustration.” Any embodiment or design described herein as “exemplary” is not necessarily to be construed as preferred or advantageous over other embodiments or designs.

The present disclosure relates generally to dynamic programming with flow information. In a computer network (which may be a virtualized network), a source sends a packet destined to a destination. The packet flows along a network path between the source and the destination. A network node can receive the packet, update the header of the packet, and forward the updated packet on the network path. This network node can be an intermediary node between the source and the destination (e.g., an intermediary server, where in the case of a virtualized network, the intermediary server can be, for example, a virtualized network load balancer). As the number of sources increase, scaling up the number of intermediary nodes becomes challenging. Further, updating the packet's header also introduces network latency to the traffic flow.

Embodiments of the present disclosure address such and other challenges by using dynamic programming of the source and/or the destination. As far as the source, once a first packet is sent (e.g., the initial packet to establish a connection for traffic flow to the destination) on a first network path (e.g., a network path that connects the source and the destination and that includes the intermediary node), the source can receive instructions (or, more generally, information that the source can generate instructions therefrom) about flow information to use for subsequent packets to send to the destination. The instructions are based on the update made by the intermediary node to the first packet. For example, the instructions specify the update that the intermediary node performed on the first packet, such that the source can perform the same update to the headers of the subsequent packets. As such, for the next packet to be sent to the destination, the source can update its header accordingly and send this packet along a second network path that is different from the first network path and that bypasses the intermediary node. In other words, the update to the packets is shifted from the intermediary node to the source. In this way, as the number of sources increases, the number of intermediary nodes need not be scaled up or scaled at the same rate at the increase to the number of sources. Further, by performing the update at the source, the network latency can be reduced because the packet need not traverse multiple intermediary nodes, thereby reducing the number of such nodes and the overall network path length. These and other advantageous technical effects are further described herein below.

These and other features (e.g., changes to the instructions, capability of supporting the dynamic programming, validating packets from the source, sending acknowledgements, etc.) are further described herein below. In the interest of clarity of explanation, the embodiments are described in connection with dynamic programming of a source. However, the embodiments similarly and equivalently apply to dynamic programming of a destination (e.g., in cases of bidirectional traffic flows). Further, the embodiments are described in connection with virtualized networks (e.g., each of the source, the intermediary node, and the destination is a virtualized resource). Nonetheless, the embodiments can similarly and equivalently apply to physical networks. An introduction to virtualized networks is provided herein below first.

### Examples of Cloud Networks

The term cloud service is generally used to refer to a service that is made available by a cloud services provider (CSP) to users or customers on demand (e.g., via a subscription model) using systems and infrastructure (cloud infrastructure) provided by the CSP. Typically, the servers and systems that make up the CSP's infrastructure are separate from the customer's own on-premise servers and systems. Customers can thus avail themselves of cloud services provided by the CSP without having to purchase separate hardware and software resources for the services. Cloud services are designed to provide a subscribing customer easy, scalable access to applications and computing resources without the customer having to invest in procuring the infrastructure that is used for providing the services.

There are several cloud service providers that offer various types of cloud services. There are various different types or models of cloud services including Software-as-a-Service (SaaS), Platform-as-a-Service (PaaS), Infrastructure-as-a-Service (IaaS), and others.

A customer can subscribe to one or more cloud services provided by a CSP. The customer can be any entity such as an individual, an organization, an enterprise, and the like. When a customer subscribes to or registers for a service provided by a CSP, a tenancy or an account is created for that customer. The customer can then, via this account, access the subscribed-to one or more cloud resources associated with the account.

As noted above, infrastructure as a service (IaaS) is one particular type of cloud computing service. In an IaaS model, the CSP provides infrastructure (referred to as cloud services provider infrastructure or CSPI) that can be used by customers to build their own customizable networks and deploy customer resources. The customer's resources and networks are thus hosted in a distributed environment by infrastructure provided by a CSP. This is different from traditional computing, where the customer's resources and networks are hosted by infrastructure provided by the customer.

The CSPI may comprise interconnected high-performance compute resources including various host machines, memory resources, and network resources that form a physical network, which is also referred to as a substrate network or an underlay network. The resources in CSPI may be spread across one or more data centers that may be geographically spread across one or more geographical regions. Virtualization software may be executed by these physical resources to provide a virtualized distributed environment. The virtualization creates an overlay network (also known as a software-based network, a software-defined network, or a virtual network) over the physical network. The CSPI physical network provides the underlying basis for creating one or more overlay or virtual networks on top of the physical network. The physical network (or substrate network or underlay network) comprises physical network devices such as physical switches, routers, computers and host machines, and the like. An overlay network is a logical (or virtual) network that runs on top of a physical substrate network. A given physical network can support one or multiple overlay networks. Overlay networks typically use encapsulation techniques to differentiate between traffic belonging to different overlay networks. A virtual or overlay network is also referred to as a virtual cloud network (VCN). The virtual networks are implemented using software virtualization technologies (e.g., hypervisors, virtualization functions implemented by network virtualization devices (NVDs) (e.g., smartNICs), top-of-rack (TOR) switches, smart TORs that implement one or more functions performed by an NVD, and other mechanisms) to create layers of network abstraction that can be run on top of the physical network. Virtual networks can take on many forms, including peer-to-peer networks, IP networks, and others. Virtual networks are typically either Layer-3 IP networks or Layer-2 VLANs. This method of virtual or overlay networking is often referred to as virtual or overlay Layer-3 networking. Examples of protocols developed for virtual networks include IP-in-IP (or Generic Routing Encapsulation (GRE)), Virtual Extensible LAN (VXLAN IETF RFC 7348), Virtual Private Networks (VPNs) (e.g., MPLS Layer-3 Virtual Private Networks (RFC 4364)), VMware's NSX, GENEVE (Generic Network Virtualization Encapsulation), and others.

For IaaS, the infrastructure (CSPI) provided by a CSP can be configured to provide virtualized computing resources over a public network (e.g., the Internet). In an IaaS model, a cloud computing services provider can host the infrastructure components (e.g., servers, storage devices, network nodes (e.g., hardware), deployment software, platform virtualization (e.g., a hypervisor layer), or the like). In some cases, an IaaS provider may also supply a variety of services to accompany those infrastructure components (e.g., billing, monitoring, logging, security, load balancing and clustering, etc.). Thus, as these services may be policy-driven, IaaS users may be able to implement policies to drive load balancing to maintain application availability and performance. CSPI provides infrastructure and a set of complementary cloud services that enable customers to build and run a wide range of applications and services in a highly available hosted distributed environment. CSPI offers high-performance compute resources and capabilities and storage capacity in a flexible virtual network that is securely accessible from various networked locations such as from a customer's on-premises network. When a customer subscribes to or registers for an IaaS service provided by a CSP, the tenancy created for that customer is a secure and isolated partition within the CSPI where the customer can create, organize, and administer their cloud resources.

Customers can build their own virtual networks using compute, memory, and networking resources provided by CSPI. One or more customer resources or workloads, such as compute instances, can be deployed on these virtual networks. For example, a customer can use resources provided by CSPI to build one or multiple customizable and private virtual network(s) referred to as virtual cloud networks (VCNs). A customer can deploy one or more customer resources, such as compute instances, on a customer VCN. Compute instances can take the form of virtual machines, bare metal instances, and the like. The CSPI thus provides infrastructure and a set of complementary cloud services that enable customers to build and run a wide range of applications and services in a highly available virtual hosted environment. The customer does not manage or control the underlying physical resources provided by CSPI but has control over operating systems, storage, and deployed applications; and possibly limited control of select networking components (e.g., firewalls).

The CSP may provide a console that enables customers and network administrators to configure, access, and manage resources deployed in the cloud using CSPI resources. In certain embodiments, the console provides a web-based user interface that can be used to access and manage CSPI. In some implementations, the console is a web-based application provided by the CSP.

CSPI may support single-tenancy or multi-tenancy architectures. In a single tenancy architecture, a software (e.g., an application, a database) or a hardware component (e.g., a host machine or a server) serves a single customer or tenant. In a multi-tenancy architecture, a software or a hardware component serves multiple customers or tenants. Thus, in a multi-tenancy architecture, CSPI resources are shared between multiple customers or tenants. In a multi-tenancy situation, precautions are taken and safeguards put in place within CSPI to ensure that each tenant's data is isolated and remains invisible to other tenants.

In a physical network, a network endpoint (“endpoint”) refers to a computing device or system that is connected to a physical network and communicates back and forth with the network to which it is connected. A network endpoint in the physical network may be connected to a Local Area Network (LAN), a Wide Area Network (WAN), or other type of physical network. Examples of traditional endpoints in a physical network include modems, hubs, bridges, switches, routers, and other networking devices, physical computers (or host machines), and the like. Each physical device in the physical network has a fixed network address that can be used to communicate with the device. This fixed network address can be a Layer-2 address (e.g., a MAC address), a fixed Layer-3 address (e.g., an IP address), and the like. In a virtualized environment or in a virtual network, the endpoints can include various virtual endpoints such as virtual machines that are hosted by components of the physical network (e.g., hosted by physical host machines). These endpoints in the virtual network are addressed by overlay addresses such as overlay Layer-2 addresses (e.g., overlay MAC addresses) and overlay Layer-3 addresses (e.g., overlay IP addresses). Network overlays enable flexibility by allowing network managers to move around the overlay addresses associated with network endpoints using software management (e.g., via software implementing a control plane for the virtual network). Accordingly, unlike in a physical network, in a virtual network, an overlay address (e.g., an overlay IP address) can be moved from one endpoint to another using network management software. Since the virtual network is built on top of a physical network, communications between components in the virtual network involves both the virtual network and the underlying physical network. In order to facilitate such communications, the components of CSPI are configured to learn and store mappings that map overlay addresses in the virtual network to actual physical addresses in the substrate network, and vice versa. These mappings are then used to facilitate the communications. Customer traffic is encapsulated to facilitate routing in the virtual network.

Accordingly, physical addresses (e.g., physical IP addresses) are associated with components in physical networks and overlay addresses (e.g., overlay IP addresses) are associated with entities in virtual or overlay networks. A physical IP address is an IP address associated with a physical device (e.g., a network device) in the substrate or physical network. For example, each NVD has an associated physical IP address. An overlay IP address is an overlay address associated with an entity in an overlay network, such as with a compute instance in a customer's virtual cloud network (VCN). Two different customers or tenants, each with their own private VCNs can potentially use the same overlay IP address in their VCNs without any knowledge of each other. Both the physical IP addresses and overlay IP addresses are types of real IP addresses. These are separate from virtual IP addresses. A virtual IP address is typically a single IP address that is represents or maps to multiple real IP addresses. A virtual IP address provides a 1-to-many mapping between the virtual IP address and multiple real IP addresses. For example, a load balancer may use a VIP to map to or represent multiple servers, each server having its own real IP address.

The cloud infrastructure or CSPI is physically hosted in one or more data centers in one or more regions around the world. The CSPI may include components in the physical or substrate network and virtualized components (e.g., virtual networks, compute instances, virtual machines, etc.) that are in an virtual network built on top of the physical network components. In certain embodiments, the CSPI is organized and hosted in realms, regions and availability domains. A region is typically a localized geographic area that contains one or more data centers. Regions are generally independent of each other and can be separated by vast distances, for example, across countries or even continents. For example, a first region may be in Australia, another one in Japan, yet another one in India, and the like. CSPI resources are divided among regions such that each region has its own independent subset of CSPI resources. Each region may provide a set of core infrastructure services and resources, such as, compute resources (e.g., bare metal servers, virtual machine, containers and related infrastructure, etc.); storage resources (e.g., block volume storage, file storage, object storage, archive storage); networking resources (e.g., virtual cloud networks (VCNs), load balancing resources, connections to on-premise networks), database resources; edge networking resources (e.g., DNS); and access management and monitoring resources, and others. Each region generally has multiple paths connecting it to other regions in the realm.

Generally, an application is deployed in a region (i.e., deployed on infrastructure associated with that region) where it is most heavily used, because using nearby resources is faster than using distant resources. Applications can also be deployed in different regions for various reasons, such as redundancy to mitigate the risk of region-wide events such as large weather systems or earthquakes, to meet varying requirements for legal jurisdictions, tax domains, and other business or social criteria, and the like.

The data centers within a region can be further organized and subdivided into availability domains (ADs). An availability domain may correspond to one or more data centers located within a region. A region can be composed of one or more availability domains. In such a distributed environment, CSPI resources are either region-specific, such as a virtual cloud network (VCN), or availability domain-specific, such as a compute instance.

ADs within a region are isolated from each other, fault tolerant, and are configured such that they are very unlikely to fail simultaneously. This is achieved by the ADs not sharing critical infrastructure resources such as networking, physical cables, cable paths, cable entry points, etc., such that a failure at one AD within a region is unlikely to impact the availability of the other ADs within the same region. The ADs within the same region may be connected to each other by a low latency, high bandwidth network, which makes it possible to provide high-availability connectivity to other networks (e.g., the Internet, customers' on-premise networks, etc.) and to build replicated systems in multiple ADs for both high-availability and disaster recovery. Cloud services use multiple ADs to ensure high availability and to protect against resource failure. As the infrastructure provided by the IaaS provider grows, more regions and ADs may be added with additional capacity. Traffic between availability domains is usually encrypted.

In certain embodiments, regions are grouped into realms. A realm is a logical collection of regions. Realms are isolated from each other and do not share any data. Regions in the same realm may communicate with each other, but regions in different realms cannot. A customer's tenancy or account with the CSP exists in a single realm and can be spread across one or more regions that belong to that realm. Typically, when a customer subscribes to an IaaS service, a tenancy or account is created for that customer in the customer-specified region (referred to as the “home” region) within a realm. A customer can extend the customer's tenancy across one or more other regions within the realm. A customer cannot access regions that are not in the realm where the customer's tenancy exists.

An IaaS provider can provide multiple realms, each realm catered to a particular set of customers or users. For example, a commercial realm may be provided for commercial customers. As another example, a realm may be provided for a specific country for customers within that country. As yet another example, a government realm may be provided for a government, and the like. For example, the government realm may be catered for a specific government and may have a heightened level of security than a commercial realm. For example, Oracle Cloud Infrastructure (OCI) currently offers a realm for commercial regions and two realms (e.g., FedRAMP authorized and IL5 authorized) for government cloud regions.

In certain embodiments, an AD can be subdivided into one or more fault domains. A fault domain is a grouping of infrastructure resources within an AD to provide anti-affinity. Fault domains allow for the distribution of compute instances such that the instances are not on the same physical hardware within a single AD. This is known as anti-affinity. A fault domain refers to a set of hardware components (computers, switches, and more) that share a single point of failure. A compute pool is logically divided up into fault domains. Due to this, a hardware failure or compute hardware maintenance event that affects one fault domain does not affect instances in other fault domains. Depending on the embodiment, the number of fault domains for each AD may vary. For instance, in certain embodiments each AD contains three fault domains. A fault domain acts as a logical data center within an AD.

When a customer subscribes to an IaaS service, resources from CSPI are provisioned for the customer and associated with the customer's tenancy. The customer can use these provisioned resources to build private networks and deploy resources on these networks. The customer networks that are hosted in the cloud by the CSPI are referred to as virtual cloud networks (VCNs). A customer can set up one or more virtual cloud networks (VCNs) using CSPI resources allocated for the customer. A VCN is a virtual or software defined private network. The customer resources that are deployed in the customer's VCN can include compute instances (e.g., virtual machines, bare-metal instances) and other resources. These compute instances may represent various customer workloads such as applications, load balancers, databases, and the like. A compute instance deployed on a VCN can communicate with public accessible endpoints (“public endpoints”) over a public network such as the Internet, with other instances in the same VCN or other VCNs (e.g., the customer's other VCNs, or VCNs not belonging to the customer), with the customer's on-premise data centers or networks, and with service endpoints, and other types of endpoints.

The CSP may provide various services using the CSPI. In some instances, customers of CSPI may themselves act like service providers and provide services using CSPI resources. A service provider may expose a service endpoint, which is characterized by identification information (e.g., an IP Address, a DNS name and port). A customer's resource (e.g., a compute instance) can consume a particular service by accessing a service endpoint exposed by the service for that particular service. These service endpoints are generally endpoints that are publicly accessible by users using public IP addresses associated with the endpoints via a public communication network such as the Internet. Network endpoints that are publicly accessible are also sometimes referred to as public endpoints.

In certain embodiments, a service provider may expose a service via an endpoint (sometimes referred to as a service endpoint) for the service. Customers of the service can then use this service endpoint to access the service. In certain implementations, a service endpoint provided for a service can be accessed by multiple customers that intend to consume that service. In other implementations, a dedicated service endpoint may be provided for a customer such that only that customer can access the service using that dedicated service endpoint.

In certain embodiments, when a VCN is created, it is associated with a private overlay Classless Inter-Domain Routing (CIDR) address space, which is a range of private overlay IP addresses that are assigned to the VCN (e.g., 10.0/16). A VCN includes associated subnets, route tables, and gateways. A VCN resides within a single region but can span one or more or all of the region's availability domains. A gateway is a virtual interface that is configured for a VCN and enables communication of traffic to and from the VCN to one or more endpoints outside the VCN. One or more different types of gateways may be configured for a VCN to enable communication to and from different types of endpoints.

A VCN can be subdivided into one or more sub-networks such as one or more subnets. A subnet is thus a unit of configuration or a subdivision that can be created within a VCN. A VCN can have one or multiple subnets. Each subnet within a VCN is associated with a contiguous range of overlay IP addresses (e.g., 10.0.0.0/24 and 10.0.1.0/24) that do not overlap with other subnets in that VCN and which represent an address space subset within the address space of the VCN.

Each compute instance is associated with a virtual network interface card (VNIC), that enables the compute instance to participate in a subnet of a VCN. A VNIC is a logical representation of physical Network Interface Card (NIC). In general. a VNIC is an interface between an entity (e.g., a compute instance, a service) and a virtual network. A VNIC exists in a subnet, has one or more associated IP addresses, and associated security rules or policies. A VNIC is equivalent to a Layer-2 port on a switch. A VNIC is attached to a compute instance and to a subnet within a VCN. A VNIC associated with a compute instance enables the compute instance to be a part of a subnet of a VCN and enables the compute instance to communicate (e.g., send and receive packets) with endpoints that are on the same subnet as the compute instance, with endpoints in different subnets in the VCN, or with endpoints outside the VCN. The VNIC associated with a compute instance thus determines how the compute instance connects with endpoints inside and outside the VCN. A VNIC for a compute instance is created and associated with that compute instance when the compute instance is created and added to a subnet within a VCN. For a subnet comprising a set of compute instances, the subnet contains the VNICs corresponding to the set of compute instances, each VNIC attached to a compute instance within the set of computer instances.

Each compute instance is assigned a private overlay IP address via the VNIC associated with the compute instance. This private overlay IP address is assigned to the VNIC that is associated with the compute instance when the compute instance is created and used for routing traffic to and from the compute instance. All VNICs in a given subnet use the same route table, security lists, and DHCP options. As described above, each subnet within a VCN is associated with a contiguous range of overlay IP addresses (e.g., 10.0.0.0/24 and 10.0.1.0/24) that do not overlap with other subnets in that VCN and which represent an address space subset within the address space of the VCN. For a VNIC on a particular subnet of a VCN, the private overlay IP address that is assigned to the VNIC is an address from the contiguous range of overlay IP addresses allocated for the subnet.

In certain embodiments, a compute instance may optionally be assigned additional overlay IP addresses in addition to the private overlay IP address, such as, for example, one or more public IP addresses if in a public subnet. These multiple addresses are assigned either on the same VNIC or over multiple VNICs that are associated with the compute instance. Each instance however has a primary VNIC that is created during instance launch and is associated with the overlay private IP address assigned to the instance—this primary VNIC cannot be removed. Additional VNICs, referred to as secondary VNICs, can be added to an existing instance in the same availability domain as the primary VNIC. All the VNICs are in the same availability domain as the instance. A secondary VNIC can be in a subnet in the same VCN as the primary VNIC, or in a different subnet that is either in the same VCN or a different one.

A compute instance may optionally be assigned a public IP address if it is in a public subnet. A subnet can be designated as either a public subnet or a private subnet at the time the subnet is created. A private subnet means that the resources (e.g., compute instances) and associated VNICs in the subnet cannot have public overlay IP addresses. A public subnet means that the resources and associated VNICs in the subnet can have public IP addresses. A customer can designate a subnet to exist either in a single availability domain or across multiple availability domains in a region or realm.

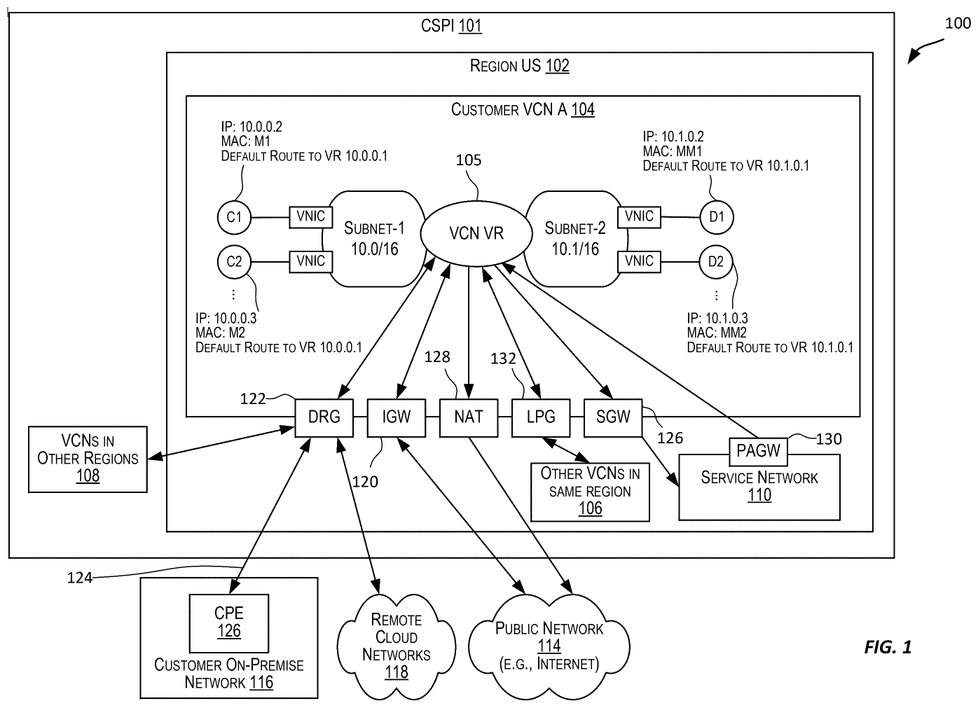

As described above, a VCN may be subdivided into one or more subnets. In certain embodiments, a Virtual Router (VR) configured for the VCN (referred to as the VCN VR or just VR) enables communications between the subnets of the VCN. For a subnet within a VCN, the VR represents a logical gateway for that subnet that enables the subnet (i.e., the compute instances on that subnet) to communicate with endpoints on other subnets within the VCN, and with other endpoints outside the VCN. The VCN VR is a logical entity that is configured to route traffic between VNICs in the VCN and virtual gateways (“gateways”) associated with the VCN. Gateways are further described below with respect to FIG. 1. A VCN VR is a Layer-3/IP Layer concept. In one embodiment, there is one VCN VR for a VCN where the VCN VR has potentially an unlimited number of ports addressed by IP addresses, with one port for each subnet of the VCN. In this manner, the VCN VR has a different IP address for each subnet in the VCN that the VCN VR is attached to. The VR is also connected to the various gateways configured for a VCN. In certain embodiments, a particular overlay IP address from the overlay IP address range for a subnet is reserved for a port of the VCN VR for that subnet. For example, consider a VCN having two subnets with associated address ranges 10.0/16 and 10.1/16, respectively. For the first subnet within the VCN with address range 10.0/16, an address from this range is reserved for a port of the VCN VR for that subnet. In some instances, the first IP address from the range may be reserved for the VCN VR. For example, for the subnet with overlay IP address range 10.0/16, IP address 10.0.0.1 may be reserved for a port of the VCN VR for that subnet. For the second subnet within the same VCN with address range 10.1/16, the VCN VR may have a port for that second subnet with IP address 10.1.0.1. The VCN VR has a different IP address for each of the subnets in the VCN.

In some other embodiments, each subnet within a VCN may have its own associated VR that is addressable by the subnet using a reserved or default IP address associated with the VR. The reserved or default IP address may, for example, be the first IP address from the range of IP addresses associated with that subnet. The VNICs in the subnet can communicate (e.g., send and receive packets) with the VR associated with the subnet using this default or reserved IP address. In such an embodiment, the VR is the ingress/egress point for that subnet. The VR associated with a subnet within the VCN can communicate with other VRs associated with other subnets within the VCN. The VRs can also communicate with gateways associated with the VCN. The VR function for a subnet is running on or executed by one or more NVDs executing VNICs functionality for VNICs in the subnet.

Route tables, security rules, and DHCP options may be configured for a VCN. Route tables are virtual route tables for the VCN and include rules to route traffic from subnets within the VCN to destinations outside the VCN by way of gateways or specially configured instances. A VCN's route tables can be customized to control how packets are forwarded/routed to and from the VCN. DHCP options refers to configuration information that is automatically provided to the instances when they boot up.

Security rules configured for a VCN represent overlay firewall rules for the VCN. The security rules can include ingress and egress rules, and specify the types of traffic (e.g., based upon protocol and port) that is allowed in and out of the instances within the VCN. The customer can choose whether a given rule is stateful or stateless. For instance, the customer can allow incoming SSH traffic from anywhere to a set of instances by setting up a stateful ingress rule with source CIDR 0.0.0.0/0, and destination TCP port 22. Security rules can be implemented using network security groups or security lists. A network security group consists of a set of security rules that apply only to the resources in that group. A security list, on the other hand, includes rules that apply to all the resources in any subnet that uses the security list. A VCN may be provided with a default security list with default security rules. DHCP options configured for a VCN provide configuration information that is automatically provided to the instances in the VCN when the instances boot up.

In certain embodiments, the configuration information for a VCN is determined and stored by a VCN Control Plane. The configuration information for a VCN may include, for example, information about: the address range associated with the VCN, subnets within the VCN and associated information, one or more VRs associated with the VCN, compute instances in the VCN and associated VNICs, NVDs executing the various virtualization network functions (e.g., VNICs, VRs, gateways) associated with the VCN, state information for the VCN, and other VCN-related information. In certain embodiments, a VCN Distribution Service publishes the configuration information stored by the VCN Control Plane, or portions thereof, to the NVDs. The distributed information may be used to update information (e.g., forwarding tables, routing tables, etc.) stored and used by the NVDs to forward packets to and from the compute instances in the VCN.

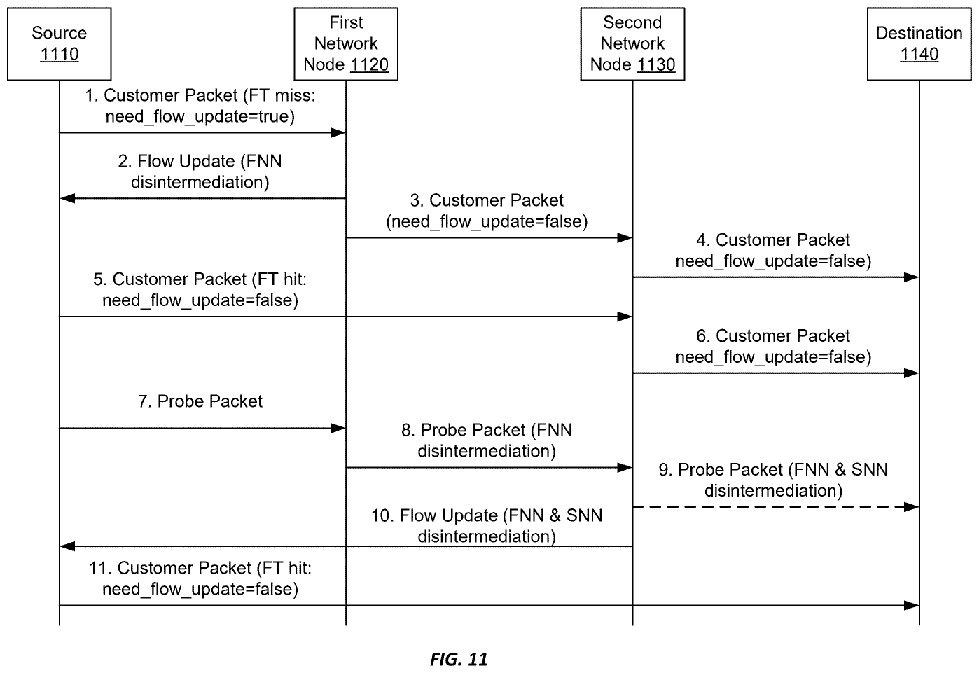

In certain embodiments, the creation of VCNs and subnets are handled by a VCN Control Plane (CP) and the launching of compute instances is handled by a Compute Control Plane. The Compute Control Plane is responsible for allocating the physical resources for the compute instance and then calls the VCN Control Plane to create and attach VNICs to the compute instance. The VCN CP also sends VCN data mappings to the VCN data plane that is configured to perform packet forwarding and routing functions. In certain embodiments, the VCN CP provides a distribution service that is responsible for providing updates to the VCN data plane. Examples of a VCN Control Plane are also depicted in FIGS. 11, 12, 13, and 14 (see references 1116, 1216, 1316, and 1416) and described below.

A customer may create one or more VCNs using resources hosted by CSPI. A compute instance deployed on a VCN.

In Subnet-1 and a compute instance in Subnet-2); an endpoint in a different VCN in the same region (e.g., communications between a compute instance in Subnet-1 and an endpoint in a VCN in the same region 106 or 110, communications between a compute instance in Subnet-1 and an endpoint in service network 110 in the same region); or an endpoint in a VCN in a different region (e.g., communications between a compute instance in Subnet-1 and an endpoint in a VCN in a different region 108). A compute instance in a subnet hosted by CSPI 101 may also communicate with endpoints that are not hosted by CSPI 101 (i.e., are outside CSPI 101). These outside endpoints include endpoints in the customer's on-premise network 116, endpoints within other remote cloud hosted networks 118, public endpoints 114 accessible via a public network such as the Internet, and other endpoints.

Communications between compute instances on the same subnet are facilitated using VNICs associated with the source compute instance and the destination compute instance. For example, compute instance C1 in Subnet-1 may customer VCN may communicate with different endpoints. These endpoints can include endpoints that are hosted by CSPI and endpoints outside CSPI.

Various different architectures for implementing cloud-based service using CSPI are depicted in FIGS. 1, 2, 3, 4, 5, 11, 12, 13, and 15, and are described below. FIG. 1 is a high level diagram of a distributed environment 100 showing an overlay or customer VCN hosted by CSPI according to certain embodiments. The distributed environment depicted in FIG. 1 includes multiple components in the overlay network. Distributed environment 100 depicted in FIG. 1 is merely an example and is not intended to unduly limit the scope of claimed embodiments. Many variations, alternatives, and modifications are possible. For example, in some implementations, the distributed environment depicted in FIG. 1 may have more or fewer systems or components than those shown in FIG. 1, may combine two or more systems, or may have a different configuration or arrangement of systems.

As shown in the example depicted in FIG. 1, distributed environment 100 comprises CSPI 101 that provides services and resources that customers can subscribe to and use to build their virtual cloud networks (VCNs). In certain embodiments, CSPI 101 offers IaaS services to subscribing customers. The data centers within CSPI 101 may be organized into one or more regions. One example region “Region US” 102 is shown in FIG. 1. A customer has configured a customer VCN 104 for region 102. The customer may deploy various compute instances on VCN 104, where the compute instances may include virtual machines or bare metal instances. Examples of instances include applications, database, load balancers, and the like.

In the embodiment depicted in FIG. 1, customer VCN 104 comprises two subnets, namely, “Subnet-1” and “Subnet-2”, each subnet with its own CIDR IP address range. In FIG. 1, the overlay IP address range for Subnet-1 is 10.0/16 and the address range for Subnet-2 is 10.1/16. A VCN Virtual Router 105 represents a logical gateway for the VCN that enables communications between subnets of the VCN 104, and with other endpoints outside the VCN. VCN VR 105 is configured to route traffic between VNICs in VCN 104 and gateways associated with VCN 104. VCN VR 105 provides a port for each subnet of VCN 104. For example, VR 105 may provide a port with IP address 10.0.0.1 for Subnet-1 and a port with IP address 10.1.0.1 for Subnet-2.

Multiple compute instances may be deployed on each subnet, where the compute instances can be virtual machine instances, and/or bare metal instances. The compute instances in a subnet may be hosted by one or more host machines within CSPI 101. A compute instance participates in a subnet via a VNIC associated with the compute instance. For example, as shown in FIG. 1, a compute instance C1 is part of Subnet-1 via a VNIC associated with the compute instance. Likewise, compute instance C2 is part of Subnet-1 via a VNIC associated with C2. In a similar manner, multiple compute instances, which may be virtual machine instances or bare metal instances, may be part of Subnet-1. Via its associated VNIC, each compute instance is assigned a private overlay IP address and a MAC address. For example, in FIG. 1, compute instance C1 has an overlay IP address of 10.0.0.2 and a MAC address of M1, while compute instance C2 has an private overlay IP address of 10.0.0.3 and a MAC address of M2. Each compute instance in Subnet-1, including compute instances C1 and C2, has a default route to VCN VR 105 using IP address 10.0.0.1, which is the IP address for a port of VCN VR 105 for Subnet-1.

Subnet-2 can have multiple compute instances deployed on it, including virtual machine instances and/or bare metal instances. For example, as shown in FIG. 1, compute instances D1 and D2 are part of Subnet-2 via VNICs associated with the respective compute instances. In the embodiment depicted in FIG. 1, compute instance D1 has an overlay IP address of 10.1.0.2 and a MAC address of MM1, while compute instance D2 has an private overlay IP address of 10.1.0.3 and a MAC address of MM2. Each compute instance in Subnet-2, including compute instances D1 and D2, has a default route to VCN VR 105 using IP address 10.1.0.1, which is the IP address for a port of VCN VR 105 for Subnet-2.

VCN A 104 may also include one or more load balancers. For example, a load balancer may be provided for a subnet and may be configured to load balance traffic across multiple compute instances on the subnet. A load balancer may also be provided to load balance traffic across subnets in the VCN.

A particular compute instance deployed on VCN 104 can communicate with various different endpoints. These endpoints may include endpoints that are hosted by CSPI 200 and endpoints outside CSPI 200. Endpoints that are hosted by CSPI 101 may include: an endpoint on the same subnet as the particular compute instance (e.g., communications between two compute instances in Subnet-1); an endpoint on a different subnet but within the same VCN (e.g., communication between a compute instance want to send packets to compute instance C2 in Subnet-1. For a packet originating at a source compute instance and whose destination is another compute instance in the same subnet, the packet is first processed by the VNIC associated with the source compute instance. Processing performed by the VNIC associated with the source compute instance can include determining destination information for the packet from the packet headers, identifying any policies (e.g., security lists) configured for the VNIC associated with the source compute instance, determining a next hop for the packet, performing any packet encapsulation/decapsulation functions as needed, and then forwarding/routing the packet to the next hop with the goal of facilitating communication of the packet to its intended destination. When the destination compute instance is in the same subnet as the source compute instance, the VNIC associated with the source compute instance is configured to identify the VNIC associated with the destination compute instance and forward the packet to that VNIC for processing. The VNIC associated with the destination compute instance is then executed and forwards the packet to the destination compute instance.

For a packet to be communicated from a compute instance in a subnet to an endpoint in a different subnet in the same VCN, the communication is facilitated by the VNICs associated with the source and destination compute instances and the VCN VR. For example, if compute instance C1 in Subnet-1 in FIG. 1 wants to send a packet to compute instance D1 in Subnet-2, the packet is first processed by the VNIC associated with compute instance C1. The VNIC associated with compute instance C1 is configured to route the packet to the VCN VR 105 using default route or port 10.0.0.1 of the VCN VR. VCN VR 105 is configured to route the packet to Subnet-2 using port 10.1.0.1. The packet is then received and processed by the VNIC associated with D1 and the VNIC forwards the packet to compute instance D1.

For a packet to be communicated from a compute instance in VCN 104 to an endpoint that is outside VCN 104, the communication is facilitated by the VNIC associated with the source compute instance, VCN VR 105, and gateways associated with VCN 104. One or more types of gateways may be associated with VCN 104. A gateway is an interface between a VCN and another endpoint, where the other endpoint is outside the VCN. A gateway is a Layer-3/IP layer concept and enables a VCN to communicate with endpoints outside the VCN. A gateway thus facilitates traffic flow between a VCN and other VCNs or networks. Various different types of gateways may be configured for a VCN to facilitate different types of communications with different types of endpoints. Depending upon the gateway, the communications may be over public networks (e.g., the Internet) or over private networks. Various communication protocols may be used for these communications.

For example, compute instance C1 may want to communicate with an endpoint outside VCN 104. The packet may be first processed by the VNIC associated with source compute instance C1. The VNIC processing determines that the destination for the packet is outside the Subnet-1 of CL. The VNIC associated with C1 may forward the packet to VCN VR 105 for VCN 104. VCN VR 105 then processes the packet and as part of the processing, based upon the destination for the packet, determines a particular gateway associated with VCN 104 as the next hop for the packet. VCN VR 105 may then forward the packet to the particular identified gateway. For example, if the destination is an endpoint within the customer's on-premise network, then the packet may be forwarded by VCN VR 105 to Dynamic Routing Gateway (DRG) gateway 122 configured for VCN 104. The packet may then be forwarded from the gateway to a next hop to facilitate communication of the packet to it final intended destination.

Various different types of gateways may be configured for a VCN. Examples of gateways that may be configured for a VCN are depicted in FIG. 1 and described below. Examples of gateways associated with a VCN are also depicted in FIGS. 11, 12, 13, and 14 (for example, gateways referenced by reference numbers 1134, 1136, 1138, 1234, 1236, 1238, 1334, 1336, 1338, 1434, 1436, and 1438) and described below. As shown in the embodiment depicted in FIG. 1, a Dynamic Routing Gateway (DRG) 122 may be added to or be associated with customer VCN 104 and provides a path for private network traffic communication between customer VCN 104 and another endpoint, where the another endpoint can be the customer's on-premise network 116, a VCN 108 in a different region of CSPI 101, or other remote cloud networks 118 not hosted by CSPI 101. Customer on-premise network 116 may be a customer network or a customer data center built using the customer's resources. Access to customer on-premise network 116 is generally very restricted. For a customer that has both a customer on-premise network 116 and one or more VCNs 104 deployed or hosted in the cloud by CSPI 101, the customer may want their on-premise network 116 and their cloud-based VCN 104 to be able to communicate with each other. This enables a customer to build an extended hybrid environment encompassing the customer's VCN 104 hosted by CSPI 101 and their on-premises network 116. DRG 122 enables this communication. To enable such communications, a communication channel 124 is set up where one endpoint of the channel is in customer on-premise network 116 and the other endpoint is in CSPI 101 and connected to customer VCN 104. Communication channel 124 can be over public communication networks such as the Internet or private communication networks. Various different communication protocols may be used such as IPsec VPN technology over a public communication network such as the Internet, Oracle's FastConnect technology that uses a private network instead of a public network, and others. The device or equipment in customer on-premise network 116 that forms one end point for communication channel 124 is referred to as the customer premise equipment (CPE), such as CPE 126 depicted in FIG. 1. On the CSPI 101 side, the endpoint may be a host machine executing DRG 122.

In certain embodiments, a Remote Peering Connection (RPC) can be added to a DRG, which allows a customer to peer one VCN with another VCN in a different region. Using such an RPC, customer VCN 104 can use DRG 122 to connect with a VCN 108 in another region. DRG 122 may also be used to communicate with other remote cloud networks 118, not hosted by CSPI 101 such as a Microsoft Azure cloud, Amazon AWS cloud, and others.

As shown in FIG. 1, an Internet Gateway (IGW) 120 may be configured for customer VCN 104 the enables a compute instance on VCN 104 to communicate with public endpoints 114 accessible over a public network such as the Internet. IGW 120 is a gateway that connects a VCN to a public network such as the Internet. IGW 120 enables a public subnet (where the resources in the public subnet have public overlay IP addresses) within a VCN, such as VCN 104, direct access to public endpoints 112 on a public network 114 such as the Internet. Using IGW 120, connections can be initiated from a subnet within VCN 104 or from the Internet.

A Network Address Translation (NAT) gateway 128 can be configured for customer's VCN 104 and enables cloud resources in the customer's VCN, which do not have dedicated public overlay IP addresses, access to the Internet and it does so without exposing those resources to direct incoming Internet connections (e.g., L4-L7 connections). This enables a private subnet within a VCN, such as private Subnet-1 in VCN 104, with private access to public endpoints on the Internet. In NAT gateways, connections can be initiated only from the private subnet to the public Internet and not from the Internet to the private subnet.

In certain embodiments, a Service Gateway (SGW) 126 can be configured for customer VCN 104 and provides a path for private network traffic between VCN 104 and supported services endpoints in a service network 110. In certain embodiments, service network 110 may be provided by the CSP and may provide various services. An example of such a service network is Oracle's Services Network, which provides various services that can be used by customers. For example, a compute instance (e.g., a database system) in a private subnet of customer VCN 104 can back up data to a service endpoint (e.g., Object Storage) without needing public IP addresses or access to the Internet. In certain embodiments, a VCN can have only one SGW, and connections can only be initiated from a subnet within the VCN and not from service network 110. If a VCN is peered with another, resources in the other VCN typically cannot access the SGW. Resources in on-premises networks that are connected to a VCN with FastConnect or VPN Connect can also use the service gateway configured for that VCN.

In certain implementations, SGW 126 uses the concept of a service Classless Inter-Domain Routing (CIDR) label, which is a string that represents all the regional public IP address ranges for the service or group of services of interest. The customer uses the service CIDR label when they configure the SGW and related route rules to control traffic to the service. The customer can optionally utilize it when configuring security rules without needing to adjust them if the service's public IP addresses change in the future.

A Local Peering Gateway (LPG) 132 is a gateway that can be added to customer VCN 104 and enables VCN 104 to peer with another VCN in the same region. Peering means that the VCNs communicate using private IP addresses, without the traffic traversing a public network such as the Internet or without routing the traffic through the customer's on-premises network 116. In preferred embodiments, a VCN has a separate LPG for each peering it establishes. Local Peering or VCN Peering is a common practice used to establish network connectivity between different applications or infrastructure management functions.

Service providers, such as providers of services in service network 110, may provide access to services using different access models. According to a public access model, services may be exposed as public endpoints that are publicly accessible by compute instance in a customer VCN via a public network such as the Internet and or may be privately accessible via SGW 126. According to a specific private access model, services are made accessible as private IP endpoints in a private subnet in the customer's VCN. This is referred to as a Private Endpoint (PE) access and enables a service provider to expose their service as an instance in the customer's private network. A Private Endpoint resource represents a service within the customer's VCN. Each PE manifests as a VNIC (referred to as a PE-VNIC, with one or more private IPs) in a subnet chosen by the customer in the customer's VCN. A PE thus provides a way to present a service within a private customer VCN subnet using a VNIC. Since the endpoint is exposed as a VNIC, all the features associates with a VNIC such as routing rules, security lists, etc., are now available for the PE VNIC.

A service provider can register their service to enable access through a PE. The provider can associate policies with the service that restricts the service's visibility to the customer tenancies. A provider can register multiple services under a single virtual IP address (VIP), especially for multi-tenant services. There may be multiple such private endpoints (in multiple VCNs) that represent the same service.

Compute instances in the private subnet can then use the PE VNIC's private IP address or the service DNS name to access the service. Compute instances in the customer VCN can access the service by sending traffic to the private IP address of the PE in the customer VCN. A Private Access Gateway (PAGW) 130 is a gateway resource that can be attached to a service provider VCN (e.g., a VCN in service network 110) that acts as an ingress/egress point for all traffic from/to customer subnet private endpoints. PAGW 130 enables a provider to scale the number of PE connections without utilizing its internal IP address resources. A provider needs only configure one PAGW for any number of services registered in a single VCN. Providers can represent a service as a private endpoint in multiple VCNs of one or more customers. From the customer's perspective, the PE VNIC, which, instead of being attached to a customer's instance, appears attached to the service with which the customer wishes to interact. The traffic destined to the private endpoint is routed via PAGW 130 to the service. These are referred to as customer-to-service private connections (C2S connections).

The PE concept can also be used to extend the private access for the service to customer's on-premises networks and data centers, by allowing the traffic to flow through FastConnect/IPsec links and the private endpoint in the customer VCN. Private access for the service can also be extended to the customer's peered VCNs, by allowing the traffic to flow between LPG 132 and the PE in the customer's VCN.

A customer can control routing in a VCN at the subnet level, so the customer can specify which subnets in the customer's VCN, such as VCN 104, use each gateway. A VCN's route tables are used to decide if traffic is allowed out of a VCN through a particular gateway. For example, in a particular instance, a route table for a public subnet within customer VCN 104 may send non-local traffic through IGW 120. The route table for a private subnet within the same customer VCN 104 may send traffic destined for CSP services through SGW 126. All remaining traffic may be sent via the NAT gateway 128. Route tables only control traffic going out of a VCN.

Security lists associated with a VCN are used to control traffic that comes into a VCN via a gateway via inbound connections. All resources in a subnet use the same route table and security lists. Security lists may be used to control specific types of traffic allowed in and out of instances in a subnet of a VCN. Security list rules may comprise ingress (inbound) and egress (outbound) rules. For example, an ingress rule may specify an allowed source address range, while an egress rule may specify an allowed destination address range. Security rules may specify a particular protocol (e.g., TCP, ICMP), a particular port (e.g., 22 for SSH, 3389 for Windows RDP), etc. In certain implementations, an instance's operating system may enforce its own firewall rules that are aligned with the security list rules. Rules may be stateful (e.g., a connection is tracked and the response is automatically allowed without an explicit security list rule for the response traffic) or stateless.

Access from a customer VCN (i.e., by a resource or compute instance deployed on VCN 104) can be categorized as public access, private access, or dedicated access. Public access refers to an access model where a public IP address or a NAT is used to access a public endpoint. Private access enables customer workloads in VCN 104 with private IP addresses (e.g., resources in a private subnet) to access services without traversing a public network such as the Internet. In certain embodiments, CSPI 101 enables customer VCN workloads with private IP addresses to access the (public service endpoints of) services using a service gateway. A service gateway thus offers a private access model by establishing a virtual link between the customer's VCN and the service's public endpoint residing outside the customer's private network.

Additionally, CSPI may offer dedicated public access using technologies such as FastConnect public peering where customer on-premises instances can access one or more services in a customer VCN using a FastConnect connection and without traversing a public network such as the Internet. CSPI also may also offer dedicated private access using FastConnect private peering where customer on-premises instances with private IP addresses can access the customer's VCN workloads using a FastConnect connection. FastConnect is a network connectivity alternative to using the public Internet to connect a customer's on-premise network to CSPI and its services. FastConnect provides an easy, elastic, and economical way to create a dedicated and private connection with higher bandwidth options and a more reliable and consistent networking experience when compared to Internet-based connections.

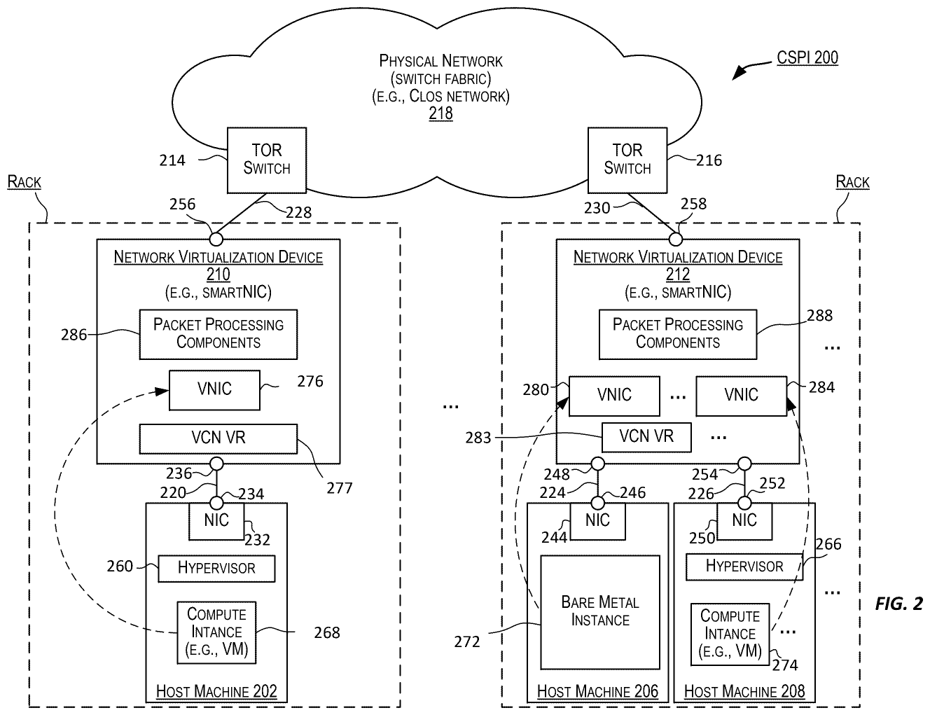

FIG. 1 and the accompanying description above describes various virtualized components in an example virtual network. As described above, the virtual network is built on the underlying physical or substrate network. FIG. 2 depicts a simplified architectural diagram of the physical components in the physical network within CSPI 200 that provide the underlay for the virtual network according to certain embodiments. As shown, CSPI 200 provides a distributed environment comprising components and resources (e.g., compute, memory, and networking resources) provided by a cloud service provider (CSP). These components and resources are used to provide cloud services (e.g., IaaS services) to subscribing customers, i.e., customers that have subscribed to one or more services provided by the CSP. Based upon the services subscribed to by a customer, a subset of resources (e.g., compute, memory, and networking resources) of CSPI 200 are provisioned for the customer. Customers can then build their own cloud-based (i.e., CSPI-hosted) customizable and private virtual networks using physical compute, memory, and networking resources provided by CSPI 200. As previously indicated, these customer networks are referred to as virtual cloud networks (VCNs). A customer can deploy one or more customer resources, such as compute instances, on these customer VCNs. Compute instances can be in the form of virtual machines, bare metal instances, and the like. CSPI 200 provides infrastructure and a set of complementary cloud services that enable customers to build and run a wide range of applications and services in a highly available hosted environment.

In the example embodiment depicted in FIG. 2, the physical components of CSPI 200 include one or more physical host machines or physical servers (e.g., 202, 206, 208), network virtualization devices (NVDs) (e.g., 210, 212), top-of-rack (TOR) switches (e.g., 214, 216), and a physical network (e.g., 218), and switches in physical network 218. The physical host machines or servers may host and execute various compute instances that participate in one or more subnets of a VCN. The compute instances may include virtual machine instances, and bare metal instances. For example, the various compute instances depicted in FIG. 1 may be hosted by the physical host machines depicted in FIG. 2. The virtual machine compute instances in a VCN may be executed by one host machine or by multiple different host machines. The physical host machines may also host virtual host machines, container-based hosts or functions, and the like. The VNICs and VCN VR depicted in FIG. 1 may be executed by the NVDs depicted in FIG. 2. The gateways depicted in FIG. 1 may be executed by the host machines and/or by the NVDs depicted in FIG. 2.

The host machines or servers may execute a hypervisor (also referred to as a virtual machine monitor or VMM) that creates and enables a virtualized environment on the host machines. The virtualization or virtualized environment facilitates cloud-based computing. One or more compute instances may be created, executed, and managed on a host machine by a hypervisor on that host machine. The hypervisor on a host machine enables the physical computing resources of the host machine (e.g., compute, memory, and networking resources) to be shared between the various compute instances executed by the host machine.

For example, as depicted in FIG. 2, host machines 202 and 208 execute hypervisors 260 and 266, respectively. These hypervisors may be implemented using software, firmware, or hardware, or combinations thereof. Typically, a hypervisor is a process or a software layer that sits on top of the host machine's operating system (OS), which in turn executes on the hardware processors of the host machine. The hypervisor provides a virtualized environment by enabling the physical computing resources (e.g., processing resources such as processors/cores, memory resources, networking resources) of the host machine to be shared among the various virtual machine compute instances executed by the host machine. For example, in FIG. 2, hypervisor 260 may sit on top of the OS of host machine 202 and enables the computing resources (e.g., processing, memory, and networking resources) of host machine 202 to be shared between compute instances (e.g., virtual machines) executed by host machine 202. A virtual machine can have its own operating system (referred to as a guest operating system), which may be the same as or different from the OS of the host machine. The operating system of a virtual machine executed by a host machine may be the same as or different from the operating system of another virtual machine executed by the same host machine. A hypervisor thus enables multiple operating systems to be executed alongside each other while sharing the same computing resources of the host machine. The host machines depicted in FIG. 2 may have the same or different types of hypervisors.

A compute instance can be a virtual machine instance or a bare metal instance. In FIG. 2, compute instances 268 on host machine 202 and 274 on host machine 208 are examples of virtual machine instances. Host machine 206 is an example of a bare metal instance that is provided to a customer.

In certain instances, an entire host machine may be provisioned to a single customer, and all of the one or more compute instances (either virtual machines or bare metal instance) hosted by that host machine belong to that same customer. In other instances, a host machine may be shared between multiple customers (i.e., multiple tenants). In such a multi-tenancy scenario, a host machine may host virtual machine compute instances belonging to different customers. These compute instances may be members of different VCNs of different customers. In certain embodiments, a bare metal compute instance is hosted by a bare metal server without a hypervisor. When a bare metal compute instance is provisioned, a single customer or tenant maintains control of the physical CPU, memory, and network interfaces of the host machine hosting the bare metal instance and the host machine is not shared with other customers or tenants.

As previously described, each compute instance that is part of a VCN is associated with a VNIC that enables the compute instance to become a member of a subnet of the VCN. The VNIC associated with a compute instance facilitates the communication of packets or frames to and from the compute instance. A VNIC is associated with a compute instance when the compute instance is created. In certain embodiments, for a compute instance executed by a host machine, the VNIC associated with that compute instance is executed by an NVD connected to the host machine. For example, in FIG. 2, host machine 202 executes a virtual machine compute instance 268 that is associated with VNIC 276, and VNIC 276 is executed by NVD 210 connected to host machine 202. As another example, bare metal instance 272 hosted by host machine 206 is associated with VNIC 280 that is executed by NVD 212 connected to host machine 206. As yet another example, VNIC 284 is associated with compute instance 274 executed by host machine 208, and VNIC 284 is executed by NVD 212 connected to host machine 208.

For compute instances hosted by a host machine, an NVD connected to that host machine also executes VCN VRs corresponding to VCNs of which the compute instances are members. For example, in the embodiment depicted in FIG. 2, NVD 210 executes VCN VR 277 corresponding to the VCN of which compute instance 268 is a member. NVD 212 may also execute one or more VCN VRs 283 corresponding to VCNs corresponding to the compute instances hosted by host machines 206 and 208.

A host machine may include one or more network interface cards (NIC) that enable the host machine to be connected to other devices. A NIC on a host machine may provide one or more ports (or interfaces) that enable the host machine to be communicatively connected to another device. For example, a host machine may be connected to an NVD using one or more ports (or interfaces) provided on the host machine and on the NVD. A host machine may also be connected to other devices such as another host machine.

For example, in FIG. 2, host machine 202 is connected to NVD 210 using link 220 that extends between a port 234 provided by a NIC 232 of host machine 202 and between a port 236 of NVD 210. Host machine 206 is connected to NVD 212 using link 224 that extends between a port 246 provided by a NIC 244 of host machine 206 and between a port 248 of NVD 212. Host machine 208 is connected to NVD 212 using link 226 that extends between a port 252 provided by a NIC 250 of host machine 208 and between a port 254 of NVD 212.

The NVDs are in turn connected via communication links to top-of-the-rack (TOR) switches, which are connected to physical network 218 (also referred to as the switch fabric). In certain embodiments, the links between a host machine and an NVD, and between an NVD and a TOR switch are Ethernet links. For example, in FIG. 2, NVDs 210 and 212 are connected to TOR switches 214 and 216, respectively, using links 228 and 230. In certain embodiments, the links 220, 224, 226, 228, and 230 are Ethernet links. The collection of host machines and NVDs that are connected to a TOR is sometimes referred to as a rack.

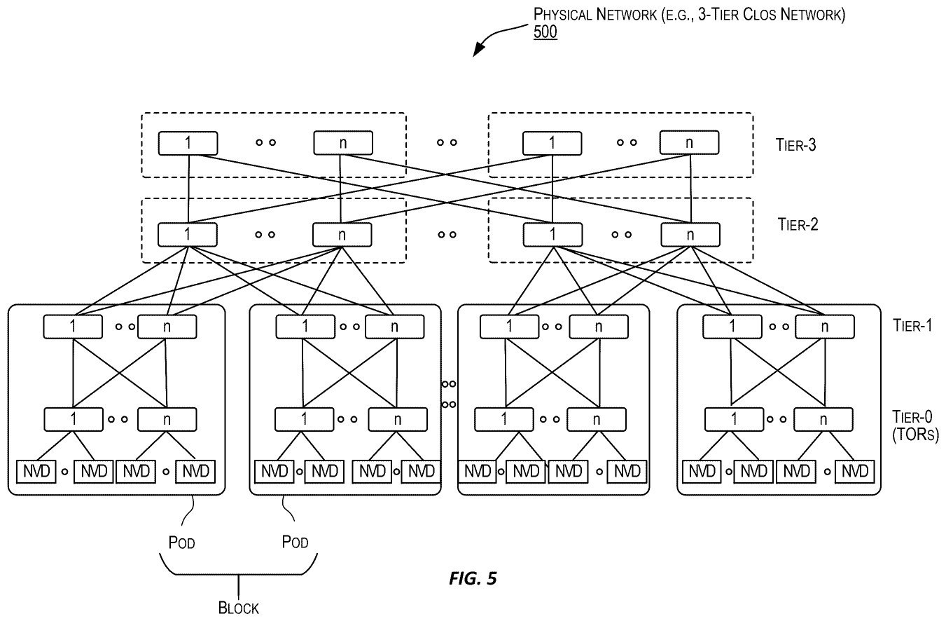

Physical network 218 provides a communication fabric that enables TOR switches to communicate with each other. Physical network 218 can be a multi-tiered network. In certain implementations, physical network 218 is a multi-tiered Clos network of switches, with TOR switches 214 and 216 representing the leaf level nodes of the multi-tiered and multi-node physical switching network 218. Different Clos network configurations are possible including but not limited to a 2-tier network, a 3-tier network, a 4-tier network, a 5-tier network, and in general a “n”-tiered network. An example of a Clos network is depicted in FIG. 5 and described below.

Various different connection configurations are possible between host machines and NVDs such as one-to-one configuration, many-to-one configuration, one-to-many configuration, and others. In a one-to-one configuration implementation, each host machine is connected to its own separate NVD. For example, in FIG. 2, host machine 202 is connected to NVD 210 via NIC 232 of host machine 202. In a many-to-one configuration, multiple host machines are connected to one NVD. For example, in FIG. 2, host machines 206 and 208 are connected to the same NVD 212 via NICs 244 and 250, respectively.

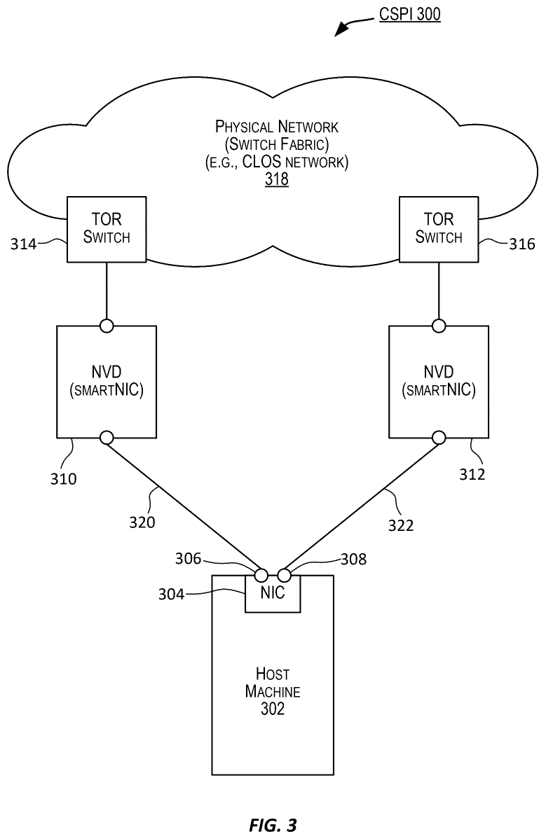

In a one-to-many configuration, one host machine is connected to multiple NVDs. FIG. 3 shows an example within CSPI 300 where a host machine is connected to multiple NVDs. As shown in FIG. 3, host machine 302 comprises a network interface card (NIC) 304 that includes multiple ports 306 and 308. Host machine 300 is connected to a first NVD 310 via port 306 and link 320, and connected to a second NVD 312 via port 308 and link 322. Ports 306 and 308 may be Ethernet ports and the links 320 and 322 between host machine 302 and NVDs 310 and 312 may be Ethernet links. NVD 310 is in turn connected to a first TOR switch 314 and NVD 312 is connected to a second TOR switch 316. The links between NVDs 310 and 312, and TOR switches 314 and 316 may be Ethernet links. TOR switches 314 and 316 represent the Tier-0 switching devices in multi-tiered physical network 318.

The arrangement depicted in FIG. 3 provides two separate physical network paths to and from physical switch network 318 to host machine 302: a first path traversing TOR switch 314 to NVD 310 to host machine 302, and a second path traversing TOR switch 316 to NVD 312 to host machine 302. The separate paths provide for enhanced availability (referred to as high availability) of host machine 302. If there are problems in one of the paths (e.g., a link in one of the paths goes down) or devices (e.g., a particular NVD is not functioning), then the other path may be used for communications to/from host machine 302.

In the configuration depicted in FIG. 3, the host machine is connected to two different NVDs using two different ports provided by a NIC of the host machine. In other embodiments, a host machine may include multiple NICs that enable connectivity of the host machine to multiple NVDs.

Referring back to FIG. 2, an NVD is a physical device or component that performs one or more network and/or storage virtualization functions. An NVD may be any device with one or more processing units (e.g., CPUs, Network Processing Units (NPUs), FPGAs, packet processing pipelines, etc.), memory including cache, and ports. The various virtualization functions may be performed by software/firmware executed by the one or more processing units of the NVD.

An NVD may be implemented in various different forms. For example, in certain embodiments, an NVD is implemented as an interface card referred to as a smartNIC or an intelligent NIC with an embedded processor onboard. A smartNIC is a separate device from the NICs on the host machines. In FIG. 2, the NVDs 210 and 212 may be implemented as smartNICs that are connected to host machines 202, and host machines 206 and 208, respectively.

A smartNIC is however just one example of an NVD implementation. Various other implementations are possible. For example, in some other implementations, an NVD or one or more functions performed by the NVD may be incorporated into or performed by one or more host machines, one or more TOR switches, and other components of CSPI 200. For example, an NVD may be embodied in a host machine where the functions performed by an NVD are performed by the host machine. As another example, an NVD may be part of a TOR switch or a TOR switch may be configured to perform functions performed by an NVD that enables the TOR switch to perform various complex packet transformations that are used for a public cloud. A TOR that performs the functions of an NVD is sometimes referred to as a smart TOR. In yet other implementations, where virtual machines (VMs) instances, but not bare metal (BM) instances, are offered to customers, functions performed by an NVD may be implemented inside a hypervisor of the host machine. In some other implementations, some of the functions of the NVD may be offloaded to a centralized service running on a fleet of host machines.

In certain embodiments, such as when implemented as a smartNIC as shown in FIG. 2, an NVD may comprise multiple physical ports that enable it to be connected to one or more host machines and to one or more TOR switches. A port on an NVD can be classified as a host-facing port (also referred to as a “south port”) or a network-facing or TOR-facing port (also referred to as a “north port”). A host-facing port of an NVD is a port that is used to connect the NVD to a host machine. Examples of host-facing ports in FIG. 2 include port 236 on NVD 210, and ports 248 and 254 on NVD 212. A network-facing port of an NVD is a port that is used to connect the NVD to a TOR switch. Examples of network-facing ports in FIG. 2 include port 256 on NVD 210, and port 258 on NVD 212. As shown in FIG. 2, NVD 210 is connected to TOR switch 214 using link 228 that extends from port 256 of NVD 210 to the TOR switch 214. Likewise, NVD 212 is connected to TOR switch 216 using link 230 that extends from port 258 of NVD 212 to the TOR switch 216.

An NVD receives packets and frames from a host machine (e.g., packets and frames generated by a compute instance hosted by the host machine) via a host-facing port and, after performing the necessary packet processing, may forward the packets and frames to a TOR switch via a network-facing port of the NVD. An NVD may receive packets and frames from a TOR switch via a network-facing port of the NVD and, after performing the necessary packet processing, may forward the packets and frames to a host machine via a host-facing port of the NVD.

In certain embodiments, there may be multiple ports and associated links between an NVD and a TOR switch. These ports and links may be aggregated to form a link aggregator group of multiple ports or links (referred to as a LAG). Link aggregation allows multiple physical links between two end-points (e.g., between an NVD and a TOR switch) to be treated as a single logical link. All the physical links in a given LAG may operate in full-duplex mode at the same speed. LAGs help increase the bandwidth and reliability of the connection between two endpoints. If one of the physical links in the LAG goes down, traffic is dynamically and transparently reassigned to one of the other physical links in the LAG. The aggregated physical links deliver higher bandwidth than each individual link. The multiple ports associated with a LAG are treated as a single logical port. Traffic can be load-balanced across the multiple physical links of a LAG. One or more LAGs may be configured between two endpoints. The two endpoints may be between an NVD and a TOR switch, between a host machine and an NVD, and the like.

An NVD implements or performs network virtualization functions. These functions are performed by software/firmware executed by the NVD. Examples of network virtualization functions include without limitation: packet encapsulation and de-capsulation functions; functions for creating a VCN network; functions for implementing network policies such as VCN security list (firewall) functionality; functions that facilitate the routing and forwarding of packets to and from compute instances in a VCN; and the like. In certain embodiments, upon receiving a packet, an NVD is configured to execute a packet processing pipeline for processing the packet and determining how the packet is to be forwarded or routed. As part of this packet processing pipeline, the NVD may execute one or more virtual functions associated with the overlay network such as executing VNICs associated with compute instances in the VCN, executing a Virtual Router (VR) associated with the VCN, the encapsulation and decapsulation of packets to facilitate forwarding or routing in the virtual network, execution of certain gateways (e.g., the Local Peering Gateway), the implementation of Security Lists, Network Security Groups, network address translation (NAT) functionality (e.g., the translation of Public IP to Private IP on a host by host basis), throttling functions, and other functions.

In certain embodiments, the packet processing data path in an NVD may comprise multiple packet pipelines, each composed of a series of packet transformation stages. In certain implementations, upon receiving a packet, the packet is parsed and classified to a single pipeline. The packet is then processed in a linear fashion, one stage after another, until the packet is either dropped or sent out over an interface of the NVD. These stages provide basic functional packet processing building blocks (e.g., validating headers, enforcing throttle, inserting new Layer-2 headers, enforcing L4 firewall, VCN encapsulation/decapsulation, etc.) so that new pipelines can be constructed by composing existing stages, and new functionality can be added by creating new stages and inserting them into existing pipelines.

An NVD may perform both control plane and data plane functions corresponding to a control plane and a data plane of a VCN. Examples of a VCN Control Plane are also depicted in FIGS. 11, 12, 13, and 14 (see references 1116, 1216, 1316, and 1416) and described below. Examples of a VCN Data Plane are depicted in FIGS. 11, 12, 13, and 14 (see references 1118, 1218, 1318, and 1418) and described below. The control plane functions include functions used for configuring a network (e.g., setting up routes and route tables, configuring VNICs, etc.) that controls how data is to be forwarded. In certain embodiments, a VCN Control Plane is provided that computes all the overlay-to-substrate mappings centrally and publishes them to the NVDs and to the virtual network edge devices such as various gateways such as the DRG, the SGW, the IGW, etc. Firewall rules may also be published using the same mechanism. In certain embodiments, an NVD only gets the mappings that are relevant for that NVD. The data plane functions include functions for the actual routing/forwarding of a packet based upon configuration set up using control plane. A VCN data plane is implemented by encapsulating the customer's network packets before they traverse the substrate network. The encapsulation/decapsulation functionality is implemented on the NVDs. In certain embodiments, an NVD is configured to intercept all network packets in and out of host machines and perform network virtualization functions.

As indicated above, an NVD executes various virtualization functions including VNICs and VCN VRs. An NVD may execute VNICs associated with the compute instances hosted by one or more host machines connected to the VNIC. For example, as depicted in FIG. 2, NVD 210 executes the functionality for VNIC 276 that is associated with compute instance 268 hosted by host machine 202 connected to NVD 210. As another example, NVD 212 executes VNIC 280 that is associated with bare metal compute instance 272 hosted by host machine 206, and executes VNIC 284 that is associated with compute instance 274 hosted by host machine 208. A host machine may host compute instances belonging to different VCNs, which belong to different customers, and the NVD connected to the host machine may execute the VNICs (i.e., execute VNICs-relate functionality) corresponding to the compute instances.

An NVD also executes VCN Virtual Routers corresponding to the VCNs of the compute instances. For example, in the embodiment depicted in FIG. 2, NVD 210 executes VCN VR 277 corresponding to the VCN to which compute instance 268 belongs. NVD 212 executes one or more VCN VRs 283 corresponding to one or more VCNs to which compute instances hosted by host machines 206 and 208 belong. In certain embodiments, the VCN VR corresponding to that VCN is executed by all the NVDs connected to host machines that host at least one compute instance belonging to that VCN. If a host machine hosts compute instances belonging to different VCNs, an NVD connected to that host machine may execute VCN VRs corresponding to those different VCNs.

In addition to VNICs and VCN VRs, an NVD may execute various software (e.g., daemons) and include one or more hardware components that facilitate the various network virtualization functions performed by the NVD. For purposes of simplicity, these various components are grouped together as “packet processing components” shown in FIG. 2. For example, NVD 210 comprises packet processing components 286 and NVD 212 comprises packet processing components 288. For example, the packet processing components for an NVD may include a packet processor that is configured to interact with the NVD's ports and hardware interfaces to monitor all packets received by and communicated using the NVD and store network information. The network information may, for example, include network flow information identifying different network flows handled by the NVD and per flow information (e.g., per flow statistics). In certain embodiments, network flows information may be stored on a per VNIC basis. The packet processor may perform packet-by-packet manipulations as well as implement stateful NAT and L4 firewall (FW). As another example, the packet processing components may include a replication agent that is configured to replicate information stored by the NVD to one or more different replication target stores. As yet another example, the packet processing components may include a logging agent that is configured to perform logging functions for the NVD. The packet processing components may also include software for monitoring the performance and health of the NVD and, also possibly of monitoring the state and health of other components connected to the NVD.

FIG. 1 shows the components of an example virtual or overlay network including a VCN, subnets within the VCN, compute instances deployed on subnets, VNICs associated with the compute instances, a VR for a VCN, and a set of gateways configured for the VCN. The overlay components depicted in FIG. 1 may be executed or hosted by one or more of the physical components depicted in FIG. 2. For example, the compute instances in a VCN may be executed or hosted by one or more host machines depicted in FIG. 2. For a compute instance hosted by a host machine, the VNIC associated with that compute instance is typically executed by an NVD connected to that host machine (i.e., the VNIC functionality is provided by the NVD connected to that host machine). The VCN VR function for a VCN is executed by all the NVDs that are connected to host machines hosting or executing the compute instances that are part of that VCN. The gateways associated with a VCN may be executed by one or more different types of NVDs. For example, certain gateways may be executed by smartNICs, while others may be executed by one or more host machines or other implementations of NVDs.

As described above, a compute instance in a customer VCN may communicate with various different endpoints, where the endpoints can be within the same subnet as the source compute instance, in a different subnet but within the same VCN as the source compute instance, or with an endpoint that is outside the VCN of the source compute instance. These communications are facilitated using VNICs associated with the compute instances, the VCN VRs, and the gateways associated with the VCNs.

For communications between two compute instances on the same subnet in a VCN, the communication is facilitated using VNICs associated with the source and destination compute instances. The source and destination compute instances may be hosted by the same host machine or by different host machines. A packet originating from a source compute instance may be forwarded from a host machine hosting the source compute instance to an NVD connected to that host machine. On the NVD, the packet is processed using a packet processing pipeline, which can include execution of the VNIC associated with the source compute instance. Since the destination endpoint for the packet is within the same subnet, execution of the VNIC associated with the source compute instance results in the packet being forwarded to an NVD executing the VNIC associated with the destination compute instance, which then processes and forwards the packet to the destination compute instance. The VNICs associated with the source and destination compute instances may be executed on the same NVD (e.g., when both the source and destination compute instances are hosted by the same host machine) or on different NVDs (e.g., when the source and destination compute instances are hosted by different host machines connected to different NVDs). The VNICs may use routing/forwarding tables stored by the NVD to determine the next hop for the packet.

For a packet to be communicated from a compute instance in a subnet to an endpoint in a different subnet in the same VCN, the packet originating from the source compute instance is communicated from the host machine hosting the source compute instance to the NVD connected to that host machine. On the NVD, the packet is processed using a packet processing pipeline, which can include execution of one or more VNICs, and the VR associated with the VCN. For example, as part of the packet processing pipeline, the NVD executes or invokes functionality corresponding to the VNIC (also referred to as executes the VNIC) associated with source compute instance. The functionality performed by the VNIC may include looking at the VLAN tag on the packet. Since the packet's destination is outside the subnet, the VCN VR functionality is next invoked and executed by the NVD. The VCN VR then routes the packet to the NVD executing the VNIC associated with the destination compute instance. The VNIC associated with the destination compute instance then processes the packet and forwards the packet to the destination compute instance. The VNICs associated with the source and destination compute instances may be executed on the same NVD (e.g., when both the source and destination compute instances are hosted by the same host machine) or on different NVDs (e.g., when the source and destination compute instances are hosted by different host machines connected to different NVDs).

If the destination for the packet is outside the VCN of the source compute instance, then the packet originating from the source compute instance is communicated from the host machine hosting the source compute instance to the NVD connected to that host machine. The NVD executes the VNIC associated with the source compute instance. Since the destination end point of the packet is outside the VCN, the packet is then processed by the VCN VR for that VCN. The NVD invokes the VCN VR functionality, which may result in the packet being forwarded to an NVD executing the appropriate gateway associated with the VCN. For example, if the destination is an endpoint within the customer's on-premise network, then the packet may be forwarded by the VCN VR to the NVD executing the DRG gateway configured for the VCN. The VCN VR may be executed on the same NVD as the NVD executing the VNIC associated with the source compute instance or by a different NVD. The gateway may be executed by an NVD, which may be a smartNIC, a host machine, or other NVD implementation. The packet is then processed by the gateway and forwarded to a next hop that facilitates communication of the packet to its intended destination endpoint. For example, in the embodiment depicted in FIG. 2, a packet originating from compute instance 268 may be communicated from host machine 202 to NVD 210 over link 220 (using NIC 232). On NVD 210, VNIC 276 is invoked since it is the VNIC associated with source compute instance 268. VNIC 276 is configured to examine the encapsulated information in the packet, and determine a next hop for forwarding the packet with the goal of facilitating communication of the packet to its intended destination endpoint, and then forward the packet to the determined next hop.

A compute instance deployed on a VCN can communicate with various different endpoints. These endpoints may include endpoints that are hosted by CSPI 200 and endpoints outside CSPI 200. Endpoints hosted by CSPI 200 may include instances in the same VCN or other VCNs, which may be the customer's VCNs, or VCNs not belonging to the customer. Communications between endpoints hosted by CSPI 200 may be performed over physical network 218. A compute instance may also communicate with endpoints that are not hosted by CSPI 200, or are outside CSPI 200. Examples of these endpoints include endpoints within a customer's on-premise network or data center, or public endpoints accessible over a public network such as the Internet. Communications with endpoints outside CSPI 200 may be performed over public networks (e.g., the Internet) (not shown in FIG. 2) or private networks (not shown in FIG. 2) using various communication protocols.

The architecture of CSPI 200 depicted in FIG. 2 is merely an example and is not intended to be limiting. Variations, alternatives, and modifications are possible in alternative embodiments. For example, in some implementations, CSPI 200 may have more or fewer systems or components than those shown in FIG. 2, may combine two or more systems, or may have a different configuration or arrangement of systems. The systems, subsystems, and other components depicted in FIG. 2 may be implemented in software (e.g., code, instructions, program) executed by one or more processing units (e.g., processors, cores) of the respective systems, using hardware, or combinations thereof. The software may be stored on a non-transitory storage medium (e.g., on a memory device).

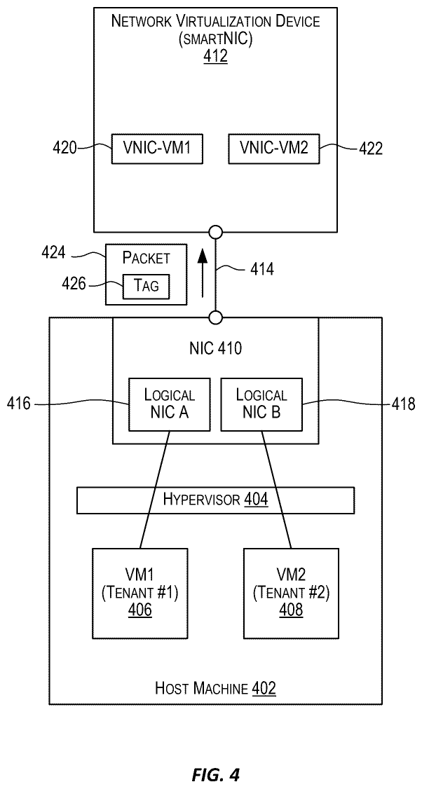

FIG. 4 depicts connectivity between a host machine and an NVD for providing I/O virtualization for supporting multitenancy according to certain embodiments. As depicted in FIG. 4, host machine 402 executes a hypervisor 404 that provides a virtualized environment. Host machine 402 executes two virtual machine instances, VM1 406 belonging to customer/tenant #1 and VM2 408 belonging to customer/tenant #2. Host machine 402 comprises a physical NIC 410 that is connected to an NVD 412 via link 414. Each of the compute instances is attached to a VNIC that is executed by NVD 412. In the embodiment in FIG. 4, VM1 406 is attached to VNIC-VM1 420 and VM2 408 is attached to VNIC-VM2 422.

As shown in FIG. 4, NIC 410 comprises two logical NICs, logical NIC A 416 and logical NIC B 418. Each virtual machine is attached to and configured to work with its own logical NIC. For example, VM1 406 is attached to logical NIC A 416 and VM2 408 is attached to logical NIC B 418. Even though host machine 402 comprises only one physical NIC 410 that is shared by the multiple tenants, due to the logical NICs, each tenant's virtual machine believes they have their own host machine and NIC.

In certain embodiments, each logical NIC is assigned its own VLAN ID. Thus, a specific VLAN ID is assigned to logical NIC A 416 for Tenant #1 and a separate VLAN ID is assigned to logical NIC B 418 for Tenant #2. When a packet is communicated from VM1 406, a tag assigned to Tenant #1 is attached to the packet by the hypervisor and the packet is then communicated from host machine 402 to NVD 412 over link 414. In a similar manner, when a packet is communicated from VM2 408, a tag assigned to Tenant #2 is attached to the packet by the hypervisor and the packet is then communicated from host machine 402 to NVD 412 over link 414. Accordingly, a packet 424 communicated from host machine 402 to NVD 412 has an associated tag 426 that identifies a specific tenant and associated VM. On the NVD, for a packet 424 received from host machine 402, the tag 426 associated with the packet is used to determine whether the packet is to be processed by VNIC-VM1 420 or by VNIC-VM2 422. The packet is then processed by the corresponding VNIC. The configuration depicted in FIG. 4 enables each tenant's compute instance to believe that they own their own host machine and NIC. The setup depicted in FIG. 4 provides for I/O virtualization for supporting multi-tenancy.

FIG. 5 depicts a simplified block diagram of a physical network 500 according to certain embodiments. The embodiment depicted in FIG. 5 is structured as a Clos network. A Clos network is a particular type of network topology designed to provide connection redundancy while maintaining high bisection bandwidth and maximum resource utilization. A Clos network is a type of non-blocking, multistage or multi-tiered switching network, where the number of stages or tiers can be two, three, four, five, etc. The embodiment depicted in FIG. 5 is a 3-tiered network comprising tiers 1, 2, and 3. The TOR switches 504 represent Tier-0 switches in the Clos network. One or more NVDs are connected to the TOR switches. Tier-0 switches are also referred to as edge devices of the physical network. The Tier-0 switches are connected to Tier-1 switches, which are also referred to as leaf switches. In the embodiment depicted in FIG. 5, a set of “n” Tier-0 TOR switches are connected to a set of “n” Tier-1 switches and together form a pod. Each Tier-0 switch in a pod is interconnected to all the Tier-1 switches in the pod, but there is no connectivity of switches between pods. In certain implementations, two pods are referred to as a block. Each block is served by or connected to a set of “n” Tier-2 switches (sometimes referred to as spine switches). There can be several blocks in the physical network topology. The Tier-2 switches are in turn connected to “n” Tier-3 switches (sometimes referred to as super-spine switches). Communication of packets over physical network 500 is typically performed using one or more Layer-3 communication protocols. Typically, all the layers of the physical network, except for the TORs layer are n-ways redundant thus allowing for high availability. Policies may be specified for pods and blocks to control the visibility of switches to each other in the physical network so as to enable scaling of the physical network.

A feature of a Clos network is that the maximum hop count to reach from one Tier-0 switch to another Tier-0 switch (or from an NVD connected to a Tier-0-switch to another NVD connected to a Tier-0 switch) is fixed. For example, in a 3-Tiered Clos network at most seven hops are needed for a packet to reach from one NVD to another NVD, where the source and target NVDs are connected to the leaf tier of the Clos network. Likewise, in a 4-tiered Clos network, at most nine hops are needed for a packet to reach from one NVD to another NVD, where the source and target NVDs are connected to the leaf tier of the Clos network. Thus, a Clos network architecture maintains consistent latency throughout the network, which is important for communication within and between data centers. A Clos topology scales horizontally and is cost effective. The bandwidth/throughput capacity of the network can be easily increased by adding more switches at the various tiers (e.g., more leaf and spine switches) and by increasing the number of links between the switches at adjacent tiers.

In certain embodiments, each resource within CSPI is assigned a unique identifier called a Cloud Identifier (CID). This identifier is included as part of the resource's information and can be used to manage the resource, for example, via a Console or through APIs. An example syntax for a CID is:
ocid1.<RESOURCE TYPE>.<REALM>.[REGION][.FUTURE USE].<UNIQUE ID>
where,
ocid1: The literal string indicating the version of the CID;
resource type: The type of resource (for example, instance, volume, VCN, subnet, user, group, and so on);
realm: The realm the resource is in. Example values are “c1” for the commercial realm, “c2” for the Government Cloud realm, or “c3” for the Federal Government Cloud realm, etc. Each realm may have its own domain name;
region: The region the resource is in. If the region is not applicable to the resource, this part might be blank;
future use: Reserved for future use.
unique ID: The unique portion of the ID. The format may vary depending on the type of resource or service.

### Dynamic Programming With Routing Information

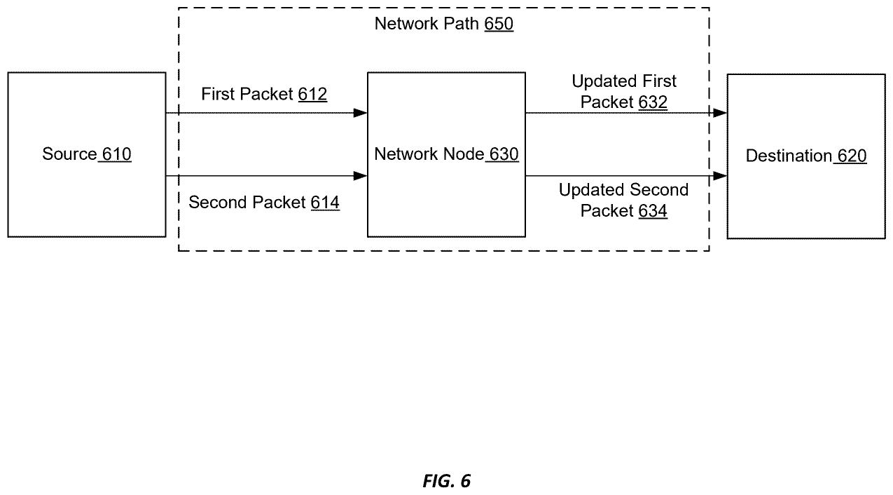

FIG. 6 depicts a simplified block diagram for a traffic flow between a source 610 and a destination 620. In an example, the source 610 includes a VNIC corresponding to a compute instance (the source 610 can but need not also include the compute instance). Similarly, the destination 620 includes a VNIC corresponding to a compute instance (the destination 620 can but need not also include the compute instance). In this example, the source 610 and the destination 620 belong to a virtual network and, possibly, to a same or two different private cloud networks (e.g., VCNs). For example, and referring to OCI, the source 610 can be a first smart NIC associated with a first compute instance, whereas the destination 620 can be a second smart NIC associated with a second compute instance. Nonetheless, the embodiments are not limited as such. For example, Nonetheless, it is possible that the source 610 and the destination 620 belong to the same private network or to different virtual networks. Similarly, it is possible that one or both of the source 610 and the destination 620 are physical devices (e.g., non-virtualized endpoints) that belong to the same or different substrate networks.

The source 610 sends packets destined to the destination 620. To do so, the source 610 sends a first packet 612 to a network node 630 that is on a network path 650 between the source and the destination. Generally, the network node 630 performs a network operation on the first packet 612, such as on its header (e.g., by updating header information of the packet, performing network address translation (NATs), updating port numbers, etc.) and/or the entire packet 612 (e.g., by performing encapsulating the packet, generating and sending a copy of the packet and to a different destination as part of a traffic access point (TAP) or virtual TAP (vTAP) function), etc.). In the context of virtual networks, the network node 630 can be a virtualized node or a physical node that executes a network function, where the network function performs the network operation. Referring back to the virtual network example, the network node 630 can include a virtualized node for routing traffic between sources and destinations. For example, the network node 630 can be a network load balancer (NLB), a service gateway, a VNIC as a service on a server fleet, etc. In this and other examples, the network node 630 can maintain route and flow information and, based on this information, updates the first packet 612, resulting in an updated first packet 632. The network node 630 then sends the updated first packet 632 on the remaining leg of the network path 650 (e.g., on to the next network node on this network path 650 or, as illustrated for simplicity in FIG. 6, to the destination 620).

For any subsequent packets to be sent to the destination 620, each of the source 610 and the network node 650 performs similar operations to the ones described above. In FIG. 6, a second packet 614 is illustrated. In particular, the source 610 sends this packet 614 to the network node 630 that, in turn, updates it resulting in an updated second packet 634. This updated second packet 634 is then sent forward.

As such, all packets sent from the source 610 to the destination 620 are sent on the same network path 650 that includes the network node 630. On each of these packets, the network node 630 performs an update to the corresponding header.

As the number of sources increases, the number of traffic flows from the sources to destinations that the network node 630 needs to handle also increases. One approach to handle this increase, is to scale up the number of available network nodes. Even if this approach is adopted, each time a network node updates a packet header, a network latency is introduced to the corresponding traffic flow (this network latency corresponds to the processing time needed for the update).

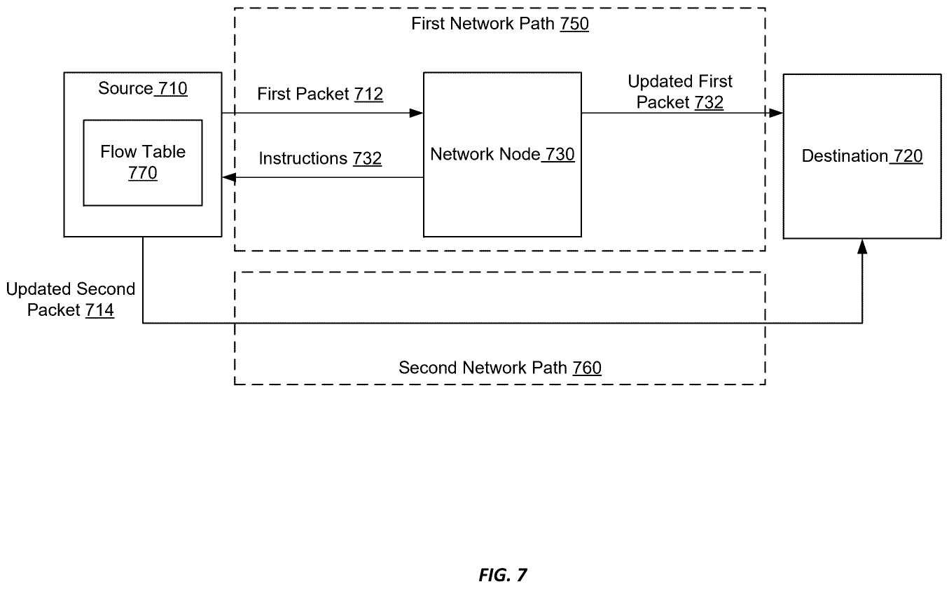

FIG. 7 depicts a simplified block diagram for a traffic flow between a source 710 and a destination 720 using dynamic programming for flow information, according to some embodiments. The dynamic programming can address, among other things, the scaling up and the latency described in FIG. 6. In particular, the increase to the number of sources need not necessitate an increase at all or at the same increase rate to the number of network nodes. Further, a network node can be bypassed, thereby avoiding network latency that would have been otherwise introduced due to the packet header processing by the network node, and possibly reducing the overall processing latency.

In the illustration of FIG. 7, the source 710 and the destination 720 are similar to the source 610 and the destination 620, respectively, of FIG. 6. A network node 730 is also similar to the network node 630 of FIG. 6. Similarities are not repeated herein in the interest of brevity.

In an example, the source 710 sends a first packet 712 destined to the destination 720 (e.g., as part of establishing a connection for a traffic flow to (unidirectional) and from (bidirectional) the destination 720). Given its flow table 770 (e.g., which may be stored in a cache of the source 710), the first packet 712 is sent to the network node 730 on a first network path 750 for the traffic flow (e.g., when there is a cache miss because the flow table 700 does not include disintermediation information for the flow between the source 710 and the destination 720). In the context of the present disclosure, “disintermediation” refers to the capability of bypassing at least one network node for packet transmission between a source and a destination.

This network path 750 includes the network node 730. Next, the network node 730 updates the packet of the first packet 712 resulting in an updated first packet 732 and sends the updated first packet 732 on the remaining leg of the first network path 750 (e.g., to the next network node 720, or, as shown in FIG. 7 for simplicity, to the destination 720). The update can be to a header of the first packet 712 (e.g., in the case of a network operation applied by the network node 730 on the header, such as a NAT) or to the first packet 712 (e.g., in the case of a network operation applied to the network node 730 on the entire packet 712, such as a vTAP or an encapsulation). In addition, the network node 730 generates instructions 732 specifying the update to the packet header.

Generally, the instructions 732 represents disintermediation information: information (e.g., in the form of text, programmable statements, etc.) usable by the source 710 to send a subsequent packet to the destination 720 by bypassing the network node 739. In an example, the instructions 732 describe the network operation and a set of values used for the network operation (e.g., for a NAT operation, the instructions can include “set destination: IPaddressvalue”, where “set destination” describes the particular network operation, and “IPaddressvalue” is the value used for that network operation). The instructions 732 can be a set of text descriptions, an array, a list, etc. In one particular example, the instructions 732 may be compiled into a program code, where the source 710 may receive the program code instead of or in addition to the instructions 732. The instructions 732 are sent to the source 710 that, in turn, can store them in the flow table 770. For example, an entry in the flow table 770 is added. A key of the entry is set to an identifier of the flow between the source 710 and the destination 720. The value associated with this key in the entry includes the instructions 732 (and/or possibly, the program code). Thus, the source 710 can be thought of being dynamically programmed with disintermediation information as part of establishing a connection with a destination.

In an example, the network node 730 generates and/or sends the instructions 732 after receiving (e.g., based on a pull mechanism or a push mechanism) information from the source 710 that the source 710 supports dynamic programming. For example, the first packet 712 can indicate that the source 710 supports disintermediating the network path. This indication can be explicit (e.g., included as capability information in the payload of the first packet 712) or implicit (e.g., the payload requests the disintermediation information, thereby indicating that the source 712 supports it). Otherwise (e.g., in the case whether the source 710 is not capable of dynamic programming), no such instructions 732 are sent and, instead, the same network path continues to be used for subsequent packets of the traffic flow (similar to the approach in FIG. 6).

As part of the dynamic programming, the source 710 can use its flow table 770 such that, for subsequent packets of the traffic flow, the source 710 can update the packet headers of these packets in a same manner as what the network node 730 would have performed on such packets. In the illustration of FIG. 7, the source 710 is to send a second packet of the traffic flow to the destination 730. Here, the source 710 determines the entry in the flow table 770 corresponding to the traffic low (e.g., based on a lookup that uses an identifier of the traffic flow and that is matched with the key of the entry). From the entry (e.g., from the value), the source 710 determines the instructions 732. As such, rather than sending the second packet to the network node 730, the source 710 updates the corresponding packet header (e.g., by performing the NAT operation using the instructions 732 of “set destination: IPaddressvalue”), resulting in an updated second packet 714, and sends this updated second packet 714 on a second network path 760 that is different from the first network path 750 and that bypasses the network node 730 (e.g., that excludes the network node 730). In the simplified illustration of FIG. 7, the updated second packet 714 is sent directly to the destination 720 (e.g., where the IP address of the destination is “IPaddressvalue”; in the simplified illustrative use case of FIG. 7, a “peer-to-peer” like connection between the source 710 and the destination 720 is used).

Accordingly, once a connection is established, via the network node 730, for a traffic flow between the source 710 and the destination 720, the network path used for this traffic flow changes to a different path that bypasses the network node 730. Because the network node 730 need no longer be used for the remaining packets of the traffic flow, no scaling up of network nodes may be needed (or a scaling up at a smaller scaling rate can be used) when the number of sources increases. Also, because the second packet is updated prior to being sent from the source 710, the traffic flows through a shorter (or more direct) network path that involves a lower number of network nodes. Thereby, the network latency is reduced. Furthermore, the processing of the updates at the source 710 rather than at network node(s) can be more efficient (given that the network node(s) may need to handle a larger number of incoming packets and, therefore, a processing bottle neck may exist, in addition to needing to execute other more complex processes). As such, the processing latency can also be reduced.

The illustration of FIG. 7 shows an original network path that includes a single network node. However, the embodiments are not limited as such. The original network path can include multiple nodes. Generally, each network node of the original network path performs a set of network operations using a set of values to a packet sent from a source. More than one or each network node (e.g., its network function executing the set of network operations) generates a set of instructions corresponding to the set of operations. The different sets of instructions can be sent to the source (e.g., in a flow update that following a probing mechanism), as further described in FIG. 11. As such, the entire or at least a portion of the original network path is disintermediated.

Furthermore, and as part of a security mechanism, when sending a packet to the destination on the disintermediated network path (e.g., the second network path 760), the source can include information about the last network node (e.g., the network node 730), where the network path stops being disintermediated. This information is used by the next network hop (e.g., the destination 720) to determine that the packet is valid and can be processed by the next network hop. For example, and referring back to FIG. 7, the destination 720 may have a security group configuration (or some access control mechanism) that limits reception of packets on the traffic flow to being received directly from the network node 730. As such, when disintermediation occurs, and packets are received directly from the source 710 on the second network path 760, these packets would be dropped by the destination 720 because of the security group configuration prohibiting such direct packet transmission. To resolve this issue and maintain security of packet transmission, the source 710 includes information about the network node 730 (e.g., an identifier thereof, a security group identifier of this node 730, etc.) in the payload of a packet. Upon receiving this packet on the second network path 760, the destination 720 can determine this information, compare it to the security configuration, and determine that the packet can be processed. The information to add can be included in the instructions 732 or derived from the receipt of such instructions 732 from the network node 730.

When multiple network nodes exist on the original network path, the disintermediation can be across the entire original network path or are a portion thereof. It is across the entire the original network path if all the network nodes and the destination supports its. It is partial if only a subset of the network nodes supports it, where in this case the disintermediation starts at the first network node on the original network path that supports its and ends at the last network node on the original network path that supports it. First refers to the network node that is at the smallest number of hops away from the source, whereas last refers to the network node that is at the largest number of hops away from the source.

The disintermediation of a flow can be unidirectional, although the flow itself is bi-directional. In this case, to achieve bidirectional disintermediation, packet(s) sent from the destination 720 can be processed in a similar manner as the ones sent by the source 710. In particular, the network node 730 can send instructions to the destination 720, the destination 720 can store such instructions in a flow table, and the destination 720 can apply the instructions from the flow table on subsequent packets that it sends. Bi-directional disintermediation need not be used, where for example only the packets sent from the source 710 are disintermediated (e.g., after the first packet 712, subsequent non-probe packets are sent on the second network path 760, whereas the destination 720 sends its packets on the first network path 750 only). Of course, if bi-directional disintermediation is performed, the destination 720 can send a first packet on the first network path 750 and a second packet on the second network path 760.

Referring back to the flow table 770, this flow table 770 can be updated using a probe packets and flow updates, as further described in FIG. 11. However, if the flow table 770 (or at least the entry for the traffic flow between the source 710 and the destination 720) has not been updated for a predefined period of time, the flow table 770 (or the entry) is deemed to have been aged out and is no longer usable for the disintermediation between the source 710 and the destination 720. Similarly, when the traffic flow terminates, the flow table 770 (or the entry) is considered to have expired and is no longer usable for the disintermediation between the source 710 and the destination 720. In comparison, if a software update installation is performed on the source 710 (e.g., the source 710 installs software or a software update), the flow table 770 (or the at least the entry) is persisted and, thus, remains usable for the disintermediation between the source 710 and the destination 720 (assuming the traffic flow did not terminate).

Further, in the above embodiments, a destination is configured to validate packets received from both a network node and a source. For example, and referring back to FIG. 7, the updated first packet 732 is received from the network node 730. The destination 720 is configured to validate that the network node 730 is a valid packet sender (e.g., by storing configuration information about the network node 730). Similarly, the updated second packet 714 is received from the source 710. The destination 720 is also configured to validate that the source 710 is a valid packet sender (e.g., by storing configuration information about the source 710). The configuration information about the source 710 can be passed from the network node 730 as part of the connection establishment.

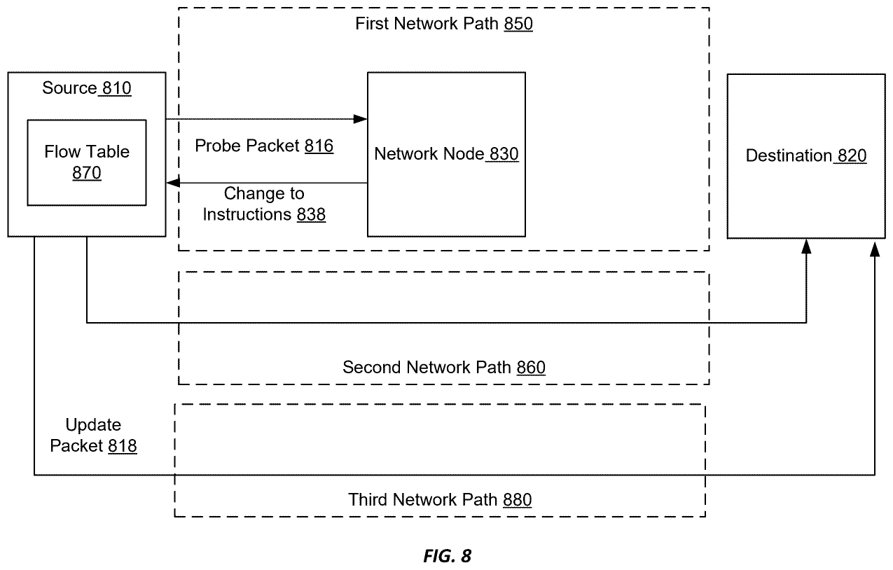

FIG. 8 depicts a simplified block diagram for a traffic flow between a source 810 and a destination 820 using an update to dynamic programming for flow information, according to some embodiments. In the illustration of FIG. 8, the source 810 and the destination 820 are similar to the source 710 and the destination 720, respectively, of FIG. 7. A network node 830 is also similar to the network node 730 of FIG. 7. Like in FIG. 7, the source 810 supports dynamic programming, whereby a first network path 850 that includes the network node 830 is used to establish a connection for a traffic flow to the destination 820, and a second network path 860 that bypasses the network node 830 is used for subsequent packets sent by the source 810 as part of the traffic flow. Here also, the first network path 850 and the second network path 860 are similar to the first network path 750 and the second network path 760, respectively, of FIG. 7. Similarities are not repeated herein in the interest of brevity.

Assume that a change occurs after the connection is established and necessitates an update to the flow information that the source 810 uses for packets of the traffic flow, where the update renders the second network path 860 unusable for the traffic flow. The change can include, for example, a change to a network security group, a configuration change, etc. To update a flow table 870 of the source 810 such that the flow information can be updated, probing is used.

In an example, the source 810 can send probe packets on the first network path 850 the original network path used to establish the connection. The probe packets can be sent periodically, or upon a request from the network node 830. For simplicity, FIG. 8 illustrates the source 810 sending a probe packet 816 to the network node 830. In turn, the network node 830 can update the probe packet 816. Here, the update to the probe packet 816 is new and is different from the original update that the network node 830 performed on the first packet sent from the source 810 (e.g., the first packet 712 of FIG. 7). The difference is caused by the change that has occurred. The network node 830 sends a change to the instructions 838 back to the source 810. The instructions change 838 specifies the new update that the network node 830 has performed on the probe packet 816 such that the source 810 can perform this same new update on subsequent packets of the traffic flow.

As illustrated in FIG. 8, after the instructions change 838 is received (and resulting in a change to the flow table 870), the source 810 sends a packet to the destination 820. To do so and given the instructions change 838, the source 810 updates the header of the packet, resulting in an updated packet 818. Given the updated packet header, the updated packet 818 is sent on a third network path 880 that is different from the second network path 860 and that also bypasses the network node 830.

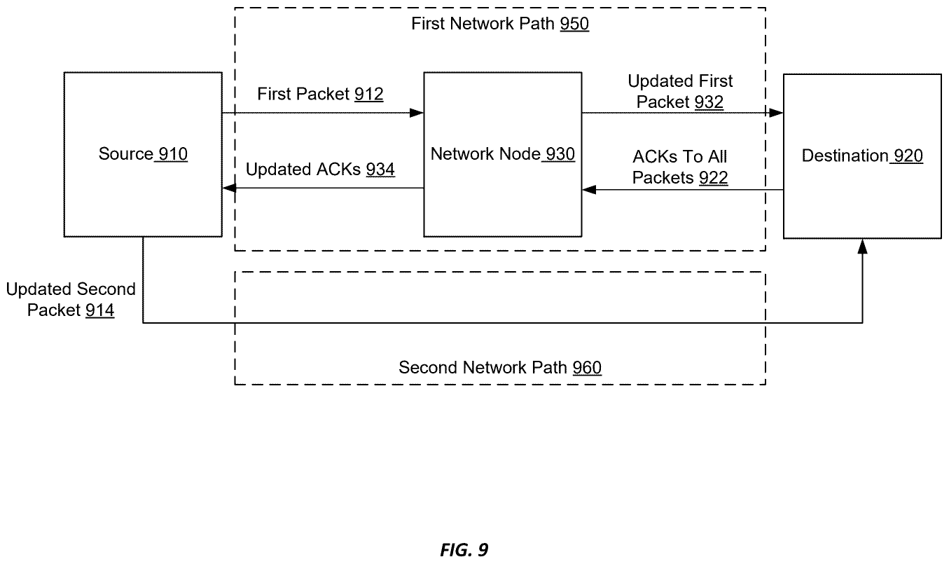

FIG. 9 depicts a simplified block diagram for a response from a destination 920 to a source 910, according to some embodiments. In the illustration of FIG. 9, the source 910 and the destination 920 are similar to the source 710 and the destination 720, respectively, of FIG. 7. A network node 930 is also similar to the network node 730 of FIG. 7. Like in FIG. 7, the source 910 supports dynamic programming, whereby a first network path 950 that includes the network node 930 is used to establish a connection for a traffic flow to the destination 920, and a second network path 960 that bypasses the network node 930 is used for subsequent packets sent by the source 910 as part of the traffic flow. Here also, the first network path 950 and the second network path 960 are similar to the first network path 750 and the second network path 760, respectively, of FIG. 7. Similarities are not repeated herein in the interest of brevity.

Although FIG. 9 illustrates that a packet acknowledgment is not disintermediated, the embodiments of the present disclosure are not limited as such. For example, any packet sent from the destination 920 to the source 910 need not be disintermediated (e.g., all such packets are sent on the first network path 950).

As illustrated in FIG. 9, as part of establishing the connection for the traffic flow, the source 910 sends a first packet 912 on the first network path 950. In turn, the network node 930 receives and updates this first packet 912, resulting in an updated first packet 932 that is sent on the remaining leg of the first network path 950 to the destination. In response, the destination 920 sends a first response acknowledging the packet reception (e.g., a first ACK). After the connection is established and the source 910 is dynamically programmed, the source 910 sends an updated second packet 914 to the destination 920, where this updated second packet 914 is sent on the second network path 960, thereby bypassing the network node 930. Here also, the destination 920 sends a second response acknowledging the packet reception (e.g., a second ACK).

In an example, all responses of the destination 920 to packets sent by the source 910 as part of the traffic flow are sent on the first network path 950, regardless of the network paths used for these packets. In other words, the first response (e.g., the first ACK) and the second response (e.g., the second ACK) are sent on the first network path 950 despite that the first packet 912 was sent on the first network path 950, whereas the updated second packet 914 was sent on the second network path 960. FIG. 9 illustrates this approach, whereby all ACKs to all packets 922 are sent by the destination 920 on the first network path 950 and are received by the network node 930. In turn, the network node 930 updates the headers of the ACK packets and sends updated ACKs 934 on the remaining leg of the first network path 950 to the source 910.

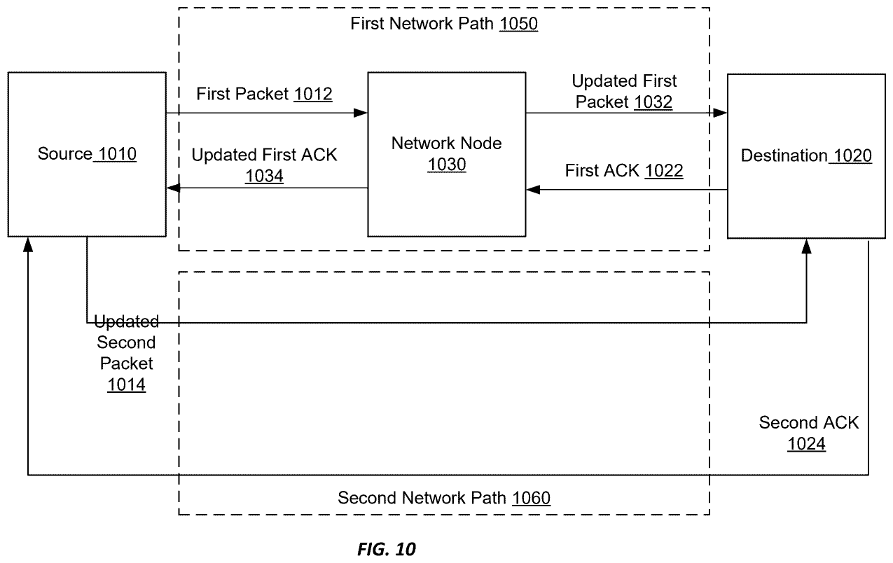

FIG. 10 depicts another simplified block diagram for a response from a destination 1020 to a source 1010, according to some embodiments. Unlike the approach of FIG. 9, here the destination 1020 sends a response to a packet on a same network path used for the packet.

In the illustration of FIG. 10, the source 1010 and the destination 1020 are similar to the source 710 and the destination 720, respectively, of FIG. 7. A network node 1030 is also similar to the network node 730 of FIG. 7. Like in FIG. 7, the source 1010 supports dynamic programming, whereby a first network path 1050 that includes the network node 1030 is used to establish a connection for a traffic flow to the destination 1020, and a second network path 1060 that bypasses the network node 1030 is used for subsequent packets sent by the source 1010 as part of the traffic flow. Here also, the first network path 1050 and the second network path 1060 are similar to the first network path 750 and the second network path 760, respectively, of FIG. 7. Similarities are not repeated herein in the interest of brevity.

As illustrated in FIG. 10, as part of establishing the connection for the traffic flow, the source 1010 sends a first packet 1012 on the first network path 1050. In turn, the network node 1030 receives and updates this first packet 1012, resulting in an updated first packet 1032 that is sent on the remaining leg of the first network path 1050 to the destination. In response, the destination 1020 sends a first response acknowledging the packet reception (e.g., a first ACK). This first response is sent back on the first network path 1050. As shown in FIG. 10, the destination sends a first ACK 1022 on the first network path 1050. In turn, the network node 1030 receives the first ACK 1022 updates its header, resulting in an updated first ACK 1034 and sends the updated first ACK 1034 on the remaining leg of the first network path 1050 to the source 1010.

After the connection is established and the source 1010 is dynamically programmed, the source 1010 sends an updated second packet 1014 to the destination 1020, where this updated second packet 1014 is sent on the second network path 1060, thereby bypassing the network node 1030. Here also, the destination 1020 sends a second response acknowledging the packet reception (e.g., a second ACK). As shown in FIG. 10, the destination sends a second ACK 1024 on the second network path 1060 because the updated second packet 1014 was received on that second network path 1060.

Although FIG. 10 illustrates that a packet acknowledgment is disintermediated, the embodiments of the present disclosure are not limited as such. For example, any packet sent from the destination 1020 to the source 1010 (subsequent to the first packet from the destination 1020 to the source 1010) can be disintermediated (e.g., sent on the first network path 1060).

FIG. 11 depicts a sequence diagram for a network path disintermediation, according to some embodiments. Here, a flow is established between a source 1110 and a destination 1140. The network path between the source 1110 and the destination 1140 includes multiple network hops, such as a first network node 1120 and a second network node 1130 (e.g., a gateway and a network load balancer). The use of two network nodes is for illustrative purposes only. A different number of network nodes is possible.

In a first step of the sequence diagram, the source 1110 sends a customer packet destined to the destination 1140. The customer packet includes customer data in a payload field, and the header information indicates the destination 1140. Furthermore, the source 1110 can look up its flow table (e.g., the flow table 770 of FIG. 7) and determines that no entry in the flow table corresponds to the flow (e.g., a “flow table (FT) miss”). Because it supports disintermediation, the source can include a request in the customer packet (e.g., in the header field) for disintermediation information. The request can be explicit, such as by indicating the flow table miss and setting a flag to a “true” value, where the flag indicates the request.

Because the first network node 1120 is the next network hop, the first network node 1120 receives the customer packet from the source 1110. Here, the first network node 1120 determines that the source 1110 supports disintermediation (implicitly give the request for the disintermediation information). The first network node 1120 performs a network operation (say a NAT) on the customer packet and generates instructions about the network operations. As shown in the second step of the sequence diagram, the first network node 1120 sends a flow update to the source 1110 (e.g., a packet) that includes the instructions. (e.g., in the payload of the packet) In FIG. 11, the instructions are shown as “FNN disintermediation,” where FNN is abbreviation for “first network node.” The source 1110 updates its flow table by adding an entry thereto, where the entry identifies the flow and includes the instructions. Per the network operation, the first network node 1120 also updates the customer packet (e.g., by changing its header information according to the NAT operation) and removes the request for the disintermediation information (e.g., sets the flag to a “false” value).

In an example, the first network node 1120 is the network hop that is closest to the source 1110 and that supports disintermediation. Accordingly, such a network hop can apply rules (e.g., heuristic-based) or a machine learning algorithm trained to determine if the disintermediation is to be triggered for the source 1110. If so, the flow update is sent. Otherwise, the flow update is not sent. To illustrate, consider an example of a rule that necessitates a minimum number of packets to be sent from the source 1110 to the destination 1140 within a predefined unit of times before the disintermediation can be enabled (e.g., ten packets in the last one minutes). The first network node 1120 can track the number of packets that the source 1110 has sent within the unit of time. If this number exceeds a predefined threshold number (e.g., ten), the first network node 1120 determines that the disintermediation is to be enabled and sends the flow update to the source 1110.

Because the second network node 1130 is the next network hop, the second network node 1130 receives the customer packet from the first network node 1120. Here, the second network node 1130 determines that no disintermediation request is included in the customer packet (given the “false” value of the flag). As such, the second network node 1130 performs its own network operation (e.g., say another NAT) on the customer packet and sends it to the destination 1140, as shown in the fourth step of the sequence diagram.

At this point, the source 1110 has received a flow update specific to the first network node 1120, but not the second network node 1130 and, thus, can bypass only the first network node 1120 when sending packets to the destination 1140. The source 1110 can start doing so. As illustrated in the fifth step of the sequence diagram, the source 1110 sends a next customer packet to the second network node 1130 directly, thereby bypassing the first network node 1120. To do so, the source 1110 looks up the flow table, determines the entry corresponding to the flow, and determines the instructions about the network operation that the first network node 1120 would have performed (e.g., a NAT operation that alters the source or destination of the customer packet to match the expectations of the second network node 11130). The source 1110 then applies the instructions to the customer packet (e.g., by setting the destination address to that of the second network node 11130 IP address) and sends the customer packet. Here, because there is flow table hit (shown in the figure as an “FT hit), the source 1110 sets the flow update flag to the “false” value.

Next, the second network node 1130 receives the customer packet, performs its own network operation (e.g., the other NAT) thereon, and sends it to the destination 1140, as shown in the sixth step of the sequence diagram.

Additionally, or alternatively to the fifth and sixth steps, the reception of the flow update triggers the source 1110 to determine the remaining portion of the disintermediation information. To do so, probing is used. In particular, the source 1110 can send, within a predefined time period (e.g., ten seconds) after the flow update is received, a probe packet requesting the disintermediation instructions be refreshed. Here, the probe packet can include some of header information of the customer packet (e.g., to be destined to the destination 1120 or 1140) such that the probe request represents a synthetized customer packet. The payload information can be different from that of the customer packet. For example, the payload field does not include any customer data. Instead, the payload field can be blank or can include a request for the disintermediation. The probe packet is sent on the original network path, as illustrated in the seventh step of the sequence diagram. Accordingly, because the first network node 1120 is the next network hop on the original network path, the first network node 1120 receives the probe packet.

The first network node 1120 performs its network operation on the probe request (e.g., its NAT operation) and records its instructions about the network operation in the probe packet (e.g., the network function of the first network node is configured to add the FNN disintermediation instructions to the payload field of the probe packet). The first network node 1120 sends the updated packet (including the updated header information and the updated payload information) to the second network node 1130 as illustrated in the eighth step of the sequence diagram.

Because the second network node 1130 is the next network hop, the second network node 1130 receives the updated probe packet. Similarly, here the second network node 1130 performs its network operation on the probe request (e.g., its NAT operation) and records its instructions about the network operation in the probe packet (e.g., the network function of the first network node is configured to add the second network node (SNN) disintermediation instructions to the payload field of the probe packet). Unlike a customer packet, the probe packet does not include customer data. As such, the payload field of the probe packet can be used to accumulate the instructions of the different network nodes along the original path. For instance, the SNN disintermediation instructions can be appended to the FNN disintermediation instructions in the payload field.

In the illustration of FIG. 11, the second network node 1130 is the last network node before disintermediation ends. Optionally, the second network node 1130 may, but need not, send the probe packet to the destination, as illustrated in the ninth step of the sequence diagram. More relevant, because it is the last network node the second network node 1130 sends a flow update to the source 1110 (e.g., a packet), as illustrated in the tenth step of the sequence diagram. The flow update includes the FNN and SNN disintermediation instructions (e.g., the instructions of the first network node 1120 and the instructions of the second network node 1130 are included as an array of instructions in the payload field of the packet).

In turn, the source 1110 can receive the flow update and update the entry in the flow table to include the array of instructions. At this point, the source 1110 can disintermediate the first network node 1120 and the second network node 1130. For example, and as illustrated in the eleventh step of the sequence diagram, the source 1110 needs to send a customer packet to the destination. It determines the entry from the flow table, applies the instructions of the first network node 1120 (e.g., performs a first NAT operation to change an IP address to that of the second network node 1130), applies the instructions of the second network node 1130 (e.g., performs a second NAT operation to change again the IP address to that of the destination 1140), and sends the updated customer packet on a network path that excludes the first network node 1120 and the second network node 1130.

In certain situations, the entry in the flow table can include multiple sets of instructions, each corresponding to a network node. The network nodes can have a particular sequence on the network path. The sets can be arranged in the same sequence and applied according to that sequence (e.g., because the first network node 1120 precedes the second network node 1130 on the network path, the source 1110 applies the instructions of the first network node 1120 before applying the instructions of the second network node 1130). An optimization can be performed, where the source 1110 can store an execute logic to avoid applying redundant instructions, to forego applying a set of instructions that may be overridden by another set of instructions, and/or to combine sets of instructions to increase the processing efficiency. For example, referring back to the two sets of instructions, each indicating a NAT operation, the source 1110 can perform a single NAT operation rather than two to achieve the same result of performing both NAT operations. More specifically, rather than changing the IP address a first time to that of the second network node 1130 and changing it again a second time to that of the destination 1140, the source 1110 can change it directly to that of the destination 1140. Such can reduce the processing latency.

In an example, the first probe packet can be sent immediately (e.g., within a predefined time period, such as one second) after receiving the first flow update. Thereafter, additional probe packets can be sent at a predefined rate (e.g., every ten seconds). Generally, a subsequent probe packet is sent on the original network path (e.g., not bypassing the first network node 1120 and the second network node 1130) to check for changes to the network operations and/or original network path. In one example, at the same or similar predefined rate, the source 1110 receives a flow update in response to a probe request from the last network node at which the disintermediation ends and updates the flow table with the received instructions. In another example, this last network node can maintain a copy of the last probe request (or the last copy of the accumulated instructions) and compare the current probe request (or the current accumulated instructions) thereto to determine if a change to the instructions occurred. If a change occurred, the network node sends a flow update to the source 1110. Here, the flow update can include the latest accumulated instructions or the change only.

In an example, a security mechanism is used to at least maintain the security of packet transmissions on a disintermediated network path. For example, a customer packet to be sent on this network path can include information about the last disintermediated network node of this network path. In this case, the next network hop of the network path would have received the customer packet from the disintermediated network node. But instead, it receives it from the source. Because the customer packet includes the information about the last disintermediated network node, the next network hop can use this information to validate that the packet can be processed. For example, and referring to FIG. 11, at the eleventh step of the sequence diagram, the source 1110 can include information about the second network node 1130 (the last disintermediated network node in this illustrative use case) in the header field of the customer packet. The destination 1140 can have security configuration that allows it process packets received from the second network node 1130. Because the customer packet includes the information about the second network node 1130, the destination 1140 can determine that the security configuration is satisfied and, thus, processes this customer packet.

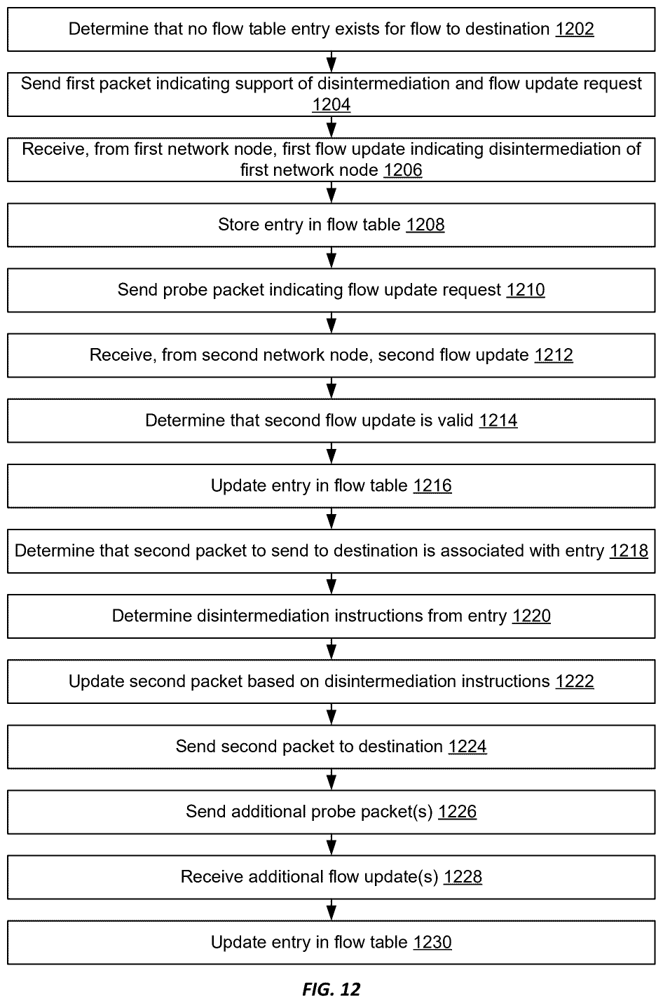

FIGS. 12-19 describe flows for network path disintermediation, according to some embodiments. Each of the flows can be implemented by a source, network node, or destination as described in each figure. Instructions for performing operations for a flow can be stored as computer-readable instructions on one or more non-transitory computer-readable media. As stored, the instructions represent programmable modules that include code executable by one or more processors. The execution of such instructions configures the corresponding network component (e.g., source, network node, or destination) to perform the specific operations shown in the corresponding figure and described herein. Each programmable module in combination with the respective processor(s) represents a means for performing a respective operation(s). While the operations are illustrated in a particular order, it should be understood that no particular order is necessary and that one or more operations may be omitted, skipped, and/or reordered.

FIG. 12 describes a flow implemented by a source for network path disintermediation, according to some embodiments. In an example, the flow includes operation 1202, where the source determines that no flow table entry exists for a flow to a destination. The source can maintain a flow table for flows established with destinations. Each entry in the table can be keyed with an identifier of a corresponding flow. The flow table can be stored in cache memory of the source. An identifier of the flow can be used to look up the flow table in the cache memory. A flow miss indicates that no flow table entry exists.

In an example, the flow includes operation 1204, where the source sends a first packet indicating support of disintermediation and flow update request. This first packet can be destined to a destination and can correspond to the customer packet shown in the first step of the sequence diagram of FIG. 11. The support can be indicated implicitly or explicitly in the packet. The flow update request can be explicit in the packet. The first packet is sent to the next network hop (referred to in this flow as a first network node) on an original, not disintermediated network path. The first packet can be that of a source compute instance, where the source here is a smart NIC associated with this compute instance.

In an example, the flow includes operation 1206, where the source receives, from the first network node, a first flow update indicating disintermediation of first network node. The first flow update can be a packet that includes instructions of the first network node, where the instructions describe a change performed by the first network node on (or, correspondingly, a network operation performed on) the first packet. The first flow update can correspond to the flow update of the second step of the sequence diagram of FIG. 11.

In an example, the flow includes operation 1208, where the source stores an entry in the flow table based on the flow update. The entry can be keyed with an identifier of the flow. The value of the entry can be set to include the instructions.

In an example, the flow includes operation 1210, where the source sends a probe packet indicating a flow update request. This sending can be triggered by the reception of the flow update and/or can occur within a predefined time period from the reception. The probe packet can be similar to the probe packet described in the seventh step of the sequence diagram of FIG. 11.

In an example, the flow includes operation 1212, where the source receives, from a second network node, a second flow update. Here, the second network node can be the last network hop at which the network path disintermediation ends. The flow update can include accumulated sets of instructions, where each set corresponds to one of the network nodes on the network path up to the second network node. The second flow update is an example of the flow update described in the tenth step of the sequence diagram.

In an example, the flow includes operation 1214, where the source determines that the second flow update is valid. Here, a security mechanism is used to increase the security of the network path disintermediation. In particular, the source can include a first secret in the probe packet (e.g., in the payload) and expects to receive that first secret back in the resulting flow update. The second flow update can include a second secret (e.g., a copy of the first secret generated by the second network node and added to the payload field of the packet that is used to send the flow update). The source can retrieve the second secret from the second flow update and compare it to the first secret. If a match is detected, the source can determine that the second flow update is valid and can proceed to the next operation of the flow. Otherwise, the second flow update is invalid and is disregarded. This same security check may, but need not, also be performed at operation 1206 since the first network node is the next network hop and is known to the source.

In an example, the flow includes operation 1216, where the source updates the entry in the flow table. For instance, the flow table is looked up using the identifier of the flow and a write operation is performed to replace the previously stored instructions with the new received instructions.

In an example, the flow includes operation 1218, where the source determines that a second packet to send to the destination is associated with the entry of the flow table. For instance, the flow table is looked up using the identifier of the flow and the entry is determined. The second packet can be that of the source compute instance.

In an example, the flow includes operation 1220, where the source determines disintermediation instructions from the entry. For instance, the stored instructions are read from the value field of the entry.

In an example, the flow includes operation 1222, where the source updates the second packet based on disintermediation instructions. The instructions are applied to the header (e.g., by changing addresses, port information, etc.) and/or to the entire packet (e.g., for encapsulation, vTAP, etc.).

In an example, the flow includes operation 1224, where the source sends the second packet to destination. Here, the second packet is sent by bypassing at least the first network node and the second network node given the instructions that were applied thereto.

In an example, the flow includes operation 1226, where the source sends additional probe packet(s). Such a probe packet can be sent to the first network node at a predefined rate, such that updated instructions can be sent to the source also at a predefined rate, or as needed.

In an example, the flow includes operation 1228, where the source receives additional flow update(s). For instance, a flow update is received from the last network node where the network path disintermediation ends in response to each probe packet. This node may, but need not, be the same as the second network node. Alternatively, a flow update is received in response to a probe packet when a change to the instructions is determined.

In an example, the flow includes operation 1230, where the source updates the entry in the flow table. For instance, the flow table is looked up using the identifier of the flow and a write operation is performed to replace the previously stored instructions with the new received instructions.

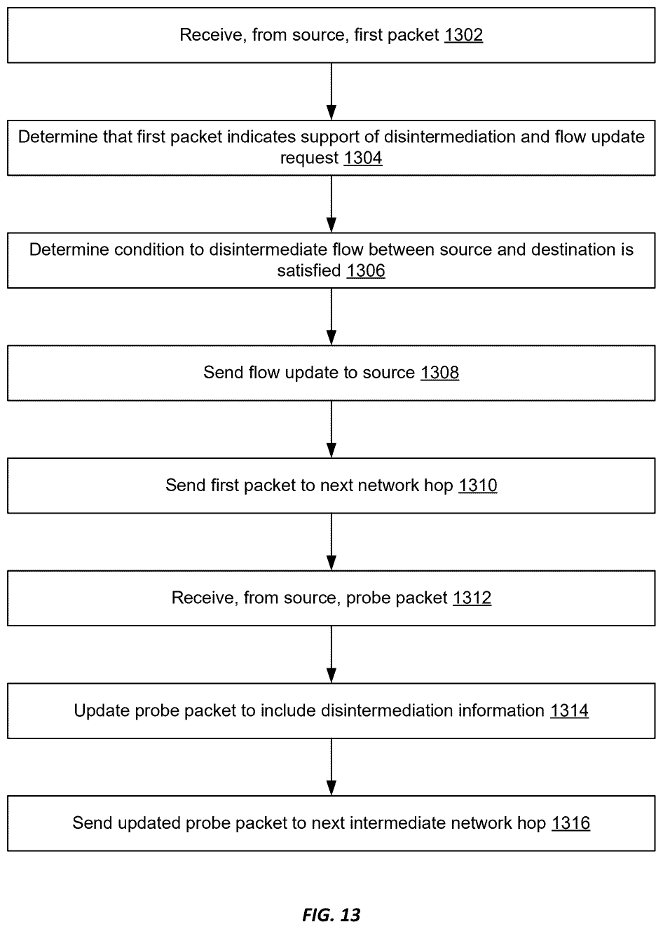

FIG. 13 describes a flow implemented by a network node for network path disintermediation, according to some embodiments. In an example, the flow includes operation 1302, where the network node receives, from a source, a first packet. This first packet can correspond to the first packet described at operation 1202.

In an example, the flow includes operation 1304, where the network node determines that the first packet indicates support of disintermediation and a flow update request. The payload of the first packet can be parsed to perform this determination.

In an example, the flow includes operation 1306, where the network node determines that a conditions to disintermediate the flow between the source and a destination is satisfied. Based on one or more factors, this determination can use heuristic rule or can be output by a machine learning model. An example factor is the number of packets sent by the source to the destination in a predefined unit of time. If the condition is satisfied, the next operation of the flow is performed. Otherwise, the network node determines that no disintermediation is to be performed yet and, thus, foregoes sending a flow update to the source.

In an example, the flow includes operation 1308, where the network node sends a flow update to the source. This flow update corresponds to the flow update of operation 1206 and is sent based on a network operation performed by the network node on the first packet.

In an example, the flow includes operation 1310, where the network node sends the first packet to the next network hop. The packet is sent after the network operation is performed. This packet can correspond to the customer packet described in the third step of the sequence diagram of FIG. 11.

In an example, the flow includes operation 1312, where the network node receives, from the source, a probe packet. This probe packet corresponds to the probe packet of operation 1210.

In an example, the flow includes operation 1314, where the network node updates the probe request to include disintermediation information. The probe packet is updated (e.g., its header or payload) by applying thereto a network operation such that the updated probe packet can be sent to the next network hop. The instructions about this network operation (which are the same instructions as the ones sent in the flow update at operation 1308) are included in the payload field of the updated probe packet. The updated probe packet corresponds to the probe packet in eighth step of the sequence diagram of FIG. 11.

In an example, the flow includes operation 1316, where the network node sends the updated probe packet to the next intermediate network hop. As discussed herein above, probe packets may not be sent to a destination. In such cases, the network node can send the updated probe packet only if the next network hop is an intermediary network hop rather than the destination.

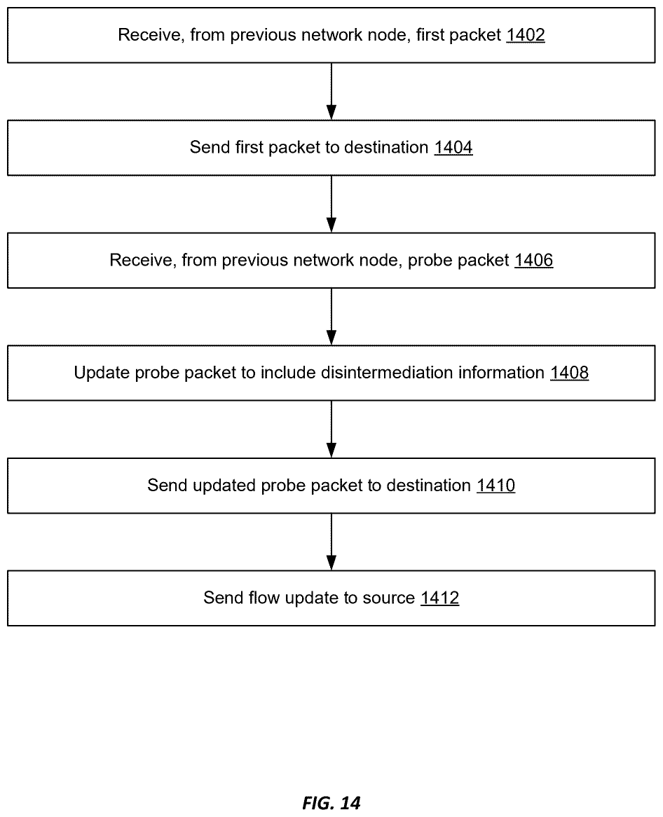

FIG. 14 describes another flow implemented by a network node for network path disintermediation, according to some embodiments. In an example, the flow includes operation 1402, where the network node receives, from a previous network node, a first packet destined to a destination. This first packet can correspond to the customer packet described in the third step of the sequence diagram of FIG. 11.

In an example, the flow includes operation 1404, where the network node sends the first packet to the destination. For instance, a network operation is applied to this packet to update it (e.g., to update its header). The updated packet is forwarded to the destination.

In an example, the flow includes operation 1406, where the network node receives, from the previous network node, a probe packet. This probe packet can correspond to the probe packet sent at operation 1314.

In an example, the flow includes operation 1408, where the network node updates the probe request to include disintermediation information. This operation can be optional. The probe packet is updated (e.g., its header) by applying thereto a network operation such that the updated probe packet can be sent to the next network hop (e.g., the destination). The instructions about this network operation are included in the payload field of the updated probe packet (e.g., by being appended to the instructions of the previous network node). The updated probe packet can correspond to the probe packet in ninth step of the sequence diagram of FIG. 11.

In an example, the flow includes operation 1410, where the network node sends the updated probe packet to the destination. This operation can be optional.

In an example, the flow includes operation 1412, where the network node sends a flow update to the source. Here, the flow update corresponds to the second flow update of operation 1214 and include the different sets of instructions. Additionally, the probe request that the network node processed at operation 1408 can include a secret in its payload. The flow update can also include a copy of this secret.

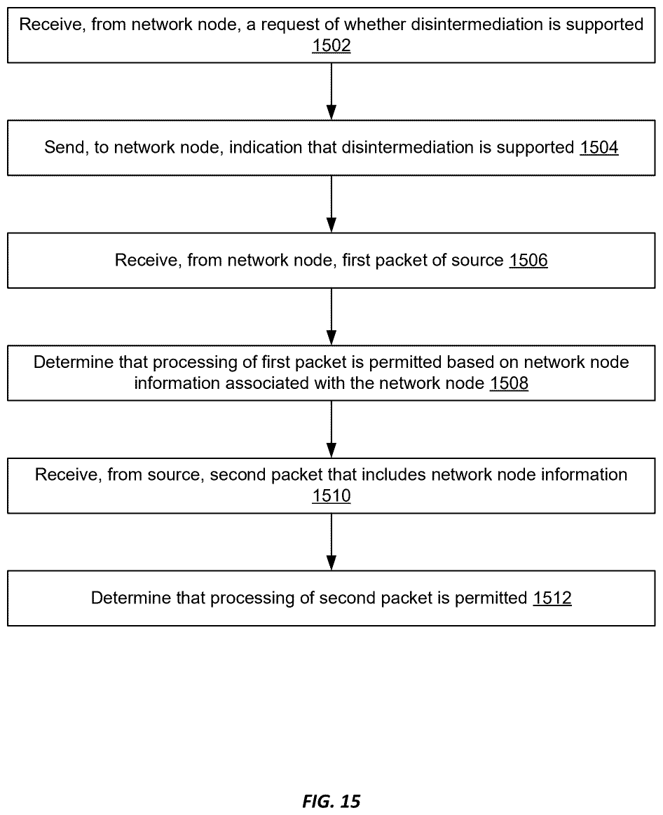

FIG. 15 describes a flow implemented by a destination for network path disintermediation, according to some embodiments. In an example, the flow includes operation 1502, where the destination receives, from a network node, a request (e.g., in the form of one or more packets) of whether the destination supports network path disintermediation. This operation can be optional. The network node can be the last network hop before the destination on a network between a source and the destination.

In an example, the flow includes operation 1504, where the destination sends, to network node, indication that disintermediation is supported. For example, the destination can send a response (e.g., in the form of one or more packets) explicitly or implicitly indicating it support. Additionally, or alternatively to operations 1502-1504, the destination can send a customer packet, in which it indicates that a flow update is requested (e.g., for a unidirectional disintermediation of packets sent from the destination to the source). Given such a packet, the network node can determine that the destination supports the disintermediation.

In an example, the flow includes operation 1506, where the destination receives, from the network node, a first packet of the source. This operation can occur subsequent to operations 1502-1504 if implemented or independently of these operations. The first packet can be received prior to disintermediation and correspond to the customer packet described in the fourth step of the sequence diagram of FIG. 11.

In an example, the flow includes operation 1508, where the destination determines that processing of the first packet is permitted based on network node information associated with the network node. For example, a security configuration associated with the destination can be applied. This security configuration can allow the destination to process packets received from the network node. Given the network information, the destination can determine that the permission applies to the received first packet. This packet is processed accordingly.

In an example, the flow includes operation 1510, where the destination receives, from the source (or from another network node), a second packet of the source. The second packet also includes the network node information and is sent after disintermediation of the original network path. This second packet can correspond to, for example, the customer packet described in the eleventh step of the sequence diagram of FIG. 11.

In an example, the flow includes operation 1512, where the destination determines that processing of the second packet is permitted based on the network node information. For example, given the network information included in the second packet, the destination can determine that the permission applies to this second packet. This packet is processed accordingly.

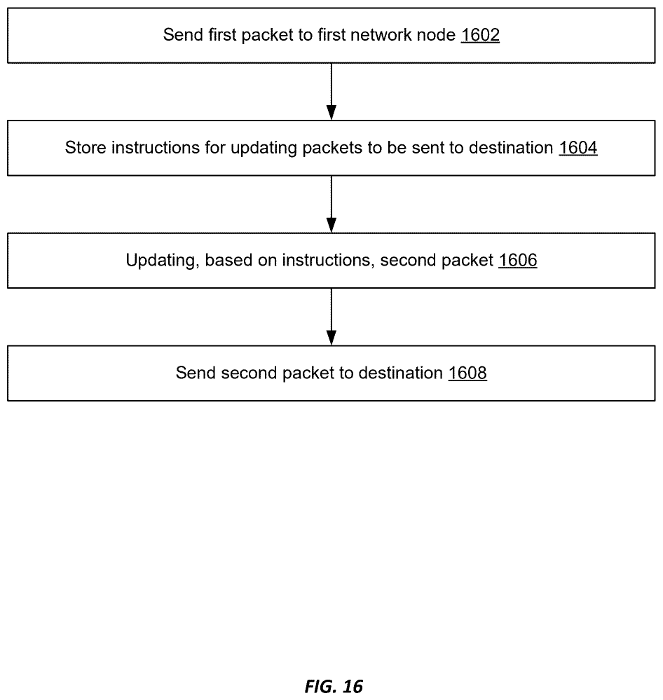

FIG. 16 describes a flow implemented by a source for storing instructions as part of a network path disintermediation, according to some embodiments. In an example, the flow includes operation 1602, where the source sends a first packet to a first network node. The first network node is on a first network path between the source and a destination. The first packet is destined to the destination. The first packet can correspond to the customer packet described in the first step of the sequence diagram of FIG. 11 or any of the first packets described in the above flows.

In an example, the flow includes operation 1604, where the source stores instructions for updating packets to be sent to the destination. The instructions are based on an update to a first header of the first packet. The update is performed by the first network node to send the first packet to the destination. The instructions can be received in a flow update per any of the flow updates of the sequence diagram of FIG. 11 or described in the above flows.

In an example, the flow includes operation 1606, where the source updates, based on the instructions, a second packet destined to the destination. A second header of the second packet is defined based on the update. The second packet can be any of the customer packets of the fifth step or the eleventh step of the sequence diagram of FIG. 11 or any of the second packets described in the above flows.

In an example, the flow includes operation 1608, where the source sends the second packet to the destination. The second packet is sent using a second network path that is based on the second header and that bypasses the first network node.

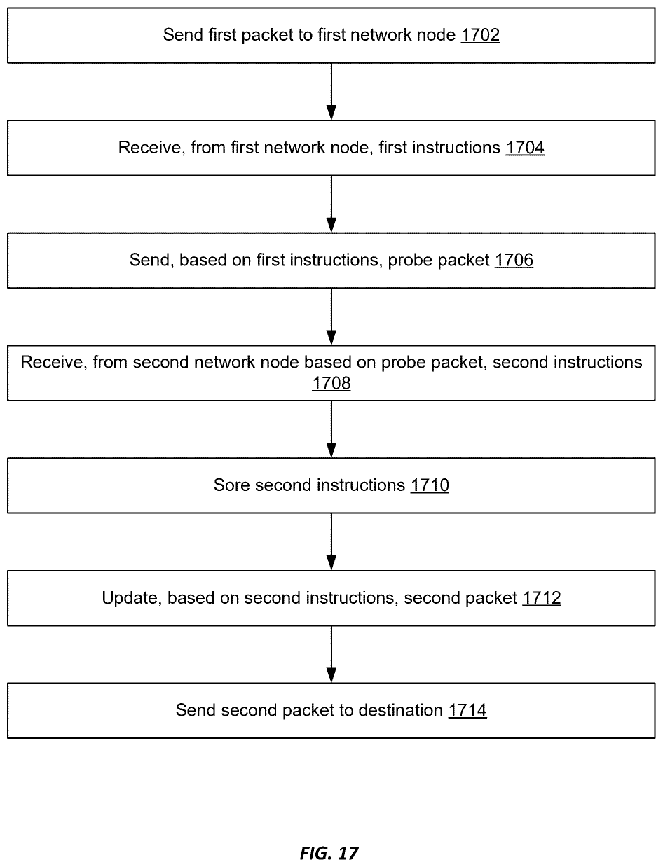

FIG. 17 describes a flow implemented by a source for using probe packets as part of a network path disintermediation, according to some embodiments. In an example, the flow includes operation 1702, where the source sends a first packet to a first network node. The first network node is on a first network path between the source and a destination. The first packet destined to the destination. The first packet can correspond to the customer packet described in the first step of the sequence diagram of FIG. 11 or any of the first packets described in the above flows.

In an example, the flow includes operation 1704, where the source receives, from the first network node based on the first packet, first instructions for updating packets to be sent to the destination. The first instructions are based on a first packet update performed by the first network node and enable the source to bypass the first network node when sending the packets to the destination. The first instructions can be received in a flow update per the flow update of the second step of the sequence diagram of FIG. 11 or any of the first flow updates described in the above flows.

In an example, the flow includes operation 1706, where the source sends, based on the first instructions, a probe packet on the first network path. The probe packet can correspond to the probe packet of the seventh step of the sequence diagram or any of the prove packets described in the above flows.

In an example, the flow includes operation 1708, where the source receives, from a second network node based on the probe packet, second instructions for updating the packets to be sent to the destination, the second instructions are based on a second packet update performed by the second network node and enable the source to bypass the second network node when sending the packets to the destination. The second instructions can be received in a flow update per the flow update of the tenth step of the sequence diagram of FIG. 11 or any of the second flow updates described in the above flows. Generally, in a multi-hop scenario, the probes compile the instructions as they are forwarded, such that the last intermediate network node delivers a single flow update with complete disintermediation instructions (e.g., compound second instructions if the second network node is last intermediate network node).

In an example, the flow includes operation 1710, where the source may store the first instructions and the second instructions, or just the compound second instructions. For example, these instructions are stored in a flow table in association with a flow between the source and the destination (or in association with any other network information, such as an identifier of the network to which the source belongs, an identifier of the network to which the destination belong, an IP address of the source, and/or an IP address of the destination, etc.).

In an example, the flow includes operation 1712, where the source updates, based on the first instructions and the second instructions, or just the compound second instructions, a second packet destined to the destination. The second packet can be the customer packet of the eleventh step of the sequence diagram of FIG. 11 or any of the second packets described in the above flows.

In an example, the flow includes operation 1714, where the source sends the second packet to the destination. The second packet sent using a second network path that bypasses the first network node and the second network node.

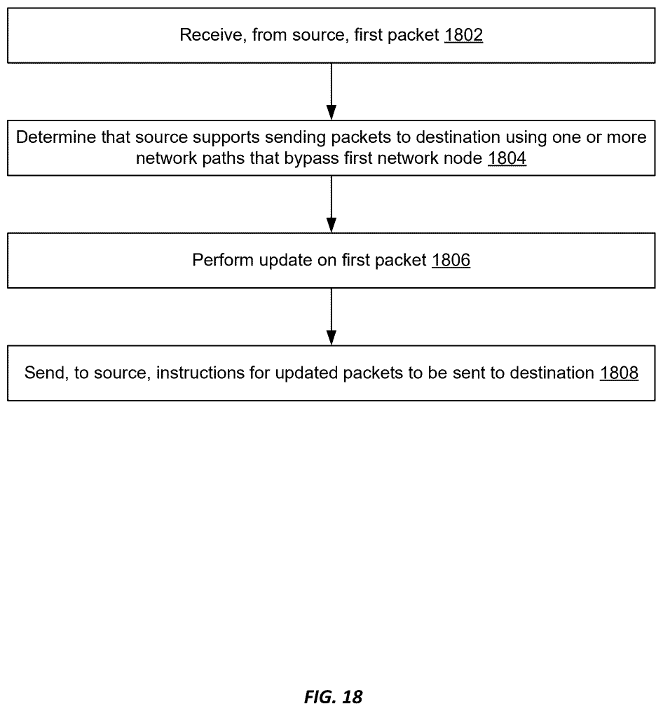

FIG. 18 describes a flow implemented by a network node for sending instructions as part of a network path disintermediation, according to some embodiments. In an example, the flow includes operation 1802, where the network node receives, from a source, a first packet destined to a destination. The first network node is on a first network path between the source and the destination. The first packet corresponds to the first packet described in the first step of the sequence diagram of FIG. 11 or to any of the first packets described in the above flows.

In an example, the flow includes operation 1804, where the network node determines that the source supports sending packets to the destination using one or more network paths that bypass the first network node. For example, based on a disintermediation request included in the packet, the network node determines the support.

In an example, the flow includes operation 1806, where the network node performs an update on the first packet. The update enables the first network node to send the packet to a next network hop. The next network hop is a second network node or the destination. The update can result from performing a network operation on the packet or a portion thereof (e.g., its header).

In an example, the flow includes operation 1808, where the network node sends, to the source, instructions for updating packets to be sent to the destination. The instructions are based on the update and enable the source to send a second packet on a second network path that bypasses the first network node. The instructions can be sent in a flow update per any of the flow updates of the sequence diagram of FIG. 11 or described in the above flows.

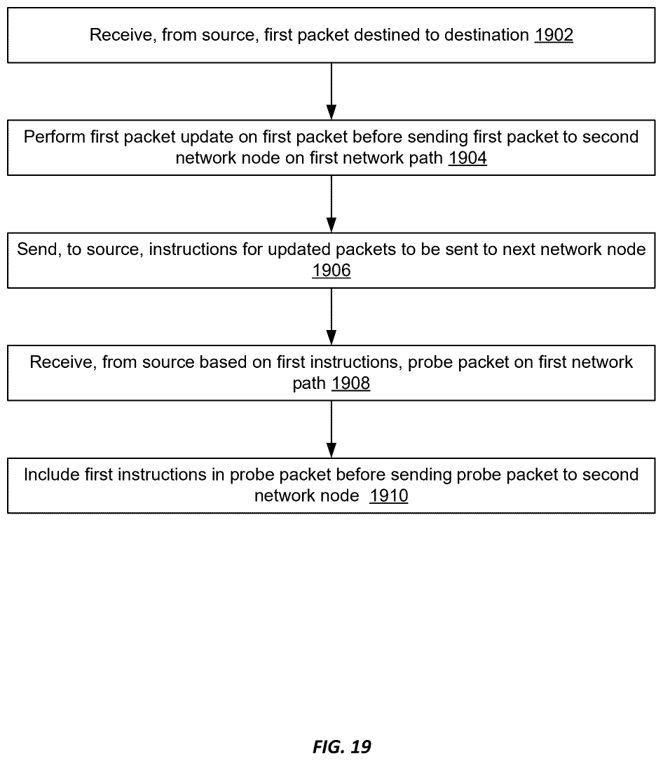

FIG. 19 describes a flow implemented by a network node for responding to probe packets as part of a network path disintermediation, according to some embodiments. In an example, the flow includes operation 1902, where the network node receives, from a source, a first packet destined to a destination. The first network node is on a first network path between the source and a destination. The first packet corresponds to the first packet described in the first step of the sequence diagram of FIG. 11 or to any of the first packets described in the above flows.

In an example, the flow includes operation 1904, where the network node performs a first packet update on the first packet before sending the first packet to a second network node on the first network path. The first packet update can correspond to a network operation applied to the packet (e.g., the entire packet or a portion thereof such as its header).

In an example, the flow includes operation 1906, where the network node sends, to the source, first instructions for updating packets to be sent to the next network node (which may not be the destination in a multi-hop network). The first instructions are based on the first packet update and enable the source to bypass the first network node when sending the packets. The instructions can be sent in a flow update per the flow update of the second step of the sequence diagram of FIG. 11 or any of the first flow updates described in the above flows.

In an example, the flow includes operation 1908, where the network node receives, from the source based on the first instructions, a probe packet on the first network path. The probe packet can be any of the probe packets described in the sequence diagram of FIG. 11 or the above flows.

In an example, the flow includes operation 1910, where the network node includes the first instructions in the probe packet before sending the probe packet to the second network node. The probe packet causes the second network node to send, to the source, second instructions for updating the packets to be sent to the destination. The second instructions are based on a second packet update performed by the second network node and enable the source to bypass the second network node when sending the packets to the destination. The first instructions can correspond to the network operation performed on the first packet or on the probe packet.

The above embodiments for the dynamic programming are described in connection with a source. These embodiments can be similarly and equivalently applied to a destination instead of or in conjunction with a source.

Based on the above, a first packet of a flow between a source and a destination is sent through an original network path. As the packet goes through the network path, network operations are applied thereto and such operations are monitored. When the packet reaches the destination (or the last network node before the destination), all the network operations that were applied to the packet are determined. Instructions about the network operations are sent to the source. So subsequent packets do not have to go through the entire original network path. Instead, the instructions are applied at the source such that the subsequent packets are sent to the destination on a network path that bypasses many if not all of the network nodes of the original path. The source can get an array of instructions to execute.

Probe packets can be used to accumulate the full set of instructions. Also, the probe packets allow detection of configuration changes made to the intermediate nodes. For example, if an intermediate node is disintermediated (skipped), then if changes are made to the configuration of that nodes, the changes could impact the transformations made to a packet proceeded by that node. Probe packets are used to identify such configuration changes for a disintermediated node. If a configuration change is detected, then probe packets are used to capture those changes. The original instructions stored by the source node can be replaced with the updated instructions incorporating the changes, which among other things may result in the reintermediation or termination of the flow if the configuration changes indicate such.

Latency is typically dominated by the network latency. So most of the latency improvements are achieved from reducing the number of network nodes that packets traverse due to embodiments of the present disclosure.

Latency savings can also be achieved from execution of the network functions. If the instructions for performing a network function is simpler (which it normally is since it is very specific to specific flows) than the code executed by the network nodes for performing the network function, execution of the network function using the instructions can be faster than the code executed by the disintermediated nodes. As such, latency can be reduced even from execution of the network functions. Other types of improvements are also possible. For instance, a throughput improvement can be achieved. This type of improvements can be due to network intermediate nodes needing not to throttle flows to protect from noisy neighbor issues.

Consider the example of a network load balancer (NLB) as an intermediary network node between a source and a destination. The NLB changes destination IP and port to a backend IP and port. Encapsulation (e.g., GENEVE) is applied and the next network hop has the backend substrate IP. Based upon a flow table, a SmartNIC of the source encapsulates and sends the packet to a target SmartNIC of the destination. This flow table can be updated so that the SmartNIC of the source changes the destination IP and applies the encapsulation (GENEVE) in the same manner as the NLB. In an example, the value corresponding to the flow is the EDP program.

For probes, the original new hop is preserved since the probe has to go through the original path. Flows can age out. If so, the flow can revert back to the original path. EDP flow tables can be retrained, such as upon updates to the SmartNIC.

Heuristics can be applied before instructing the source and changing its flow table. For example, a minimum number of packets (e.g., ten packets) from the source to the destination has to be seen before instructing the flow table update.

Probes can be sent at a constant rate. There can be delay in pushing changes to the intermediate network nodes. Prior to implementing disintermediation, the source and destination nodes have may have been configured to support disintermediation.

A flow update can be specific to that flow and inapplicable to other flows. The flow update can include changes to packet fields and high level changes with respect to the packet.

The intermediary nodes may need to support the disintermediation (the change of the path to bypass a node, where the change is trigged by observing the functions/transformations applied at the node and instructing the source accordingly). The chain stops at a node that does not support the disintermediation.

The timing for sending probe packets may not be limited to a time window after receiving the first customer packet. Instead, the probe packets can be sent at a predefined rate over time to avoid storing any outdated decision making information for use by the source SNIC. The source SNIC only applies disintermediation after receiving instructions from one or more of intermediate nodes.

The disintermediation can be done in steps. First between the source SNIC and the first intermediary node, then the source SmartNIC (SNIC) and the next intermediary node, and so on, and finally between source SNIC and the destination SNIC.

The flow update information includes changes made to the packet, such as information identifying any packet header fields and transformations/changes made to the fields. Other changes made (e.g., vTAP) can also be included. In general, for an original path (or non-disintermediation path) taken by a packet in a virtual network between a start node and an end node and traversing multiple intermediate nodes, a “disintermediation path” can be set up between a first and a last node of a sequence of three or more consecutive nodes in the non-disintermediation path, where all the nodes in the sequence support disintermediation. For example, for a sequence of nodes A-B-C, where all the three nodes support disintermediation, a disintermediation path can be established between nodes A and C, that skips B.

Embodiments of the present disclosure include the following examples 1-63.

Example 1 includes a computer-implemented method on a source, the computer-implemented method comprising: sending a first packet to a first network node, the first network node being on a first network path between the source and a destination, the first packet destined to the destination; storing instructions for updating packets to be sent to the destination, the instructions being based on an update to a first header of the first packet, the update performed by the first network node to send the first packet to the destination; updating, based on the instructions, a second packet destined to the destination, a second header of the second packet defined based on the update; and sending the second packet to the destination, the second packet sent using a second network path that is based on the second header and that bypasses the first network node.

Example 2 includes the computer-implemented method of example 1, further comprising: receiving, from the first network node, a first flow update that includes first instructions about the update; and updating an entry in a flow table, the entry associating a flow between the source and the destination with the first instructions.

Example 3 includes the computer-implemented method of example 2, further comprising: determining that no entry is included in the flow table for the flow; and including, in the first packet, an indicating that the first flow update is requested.

Example 4 includes the computer-implemented method of any of examples 1-3, further comprising: sending, to the first network node based on the first flow update, a probe packet; receiving, from a second network node on the first network path, a second flow update that includes the first instructions and second instructions about an additional update performed by the second network node on the probe packet; and updating the entry in the flow table to associate the flow with the first instructions and the second instructions, wherein the instructions include the first instructions and the second instructions.

Example 5 includes the computer-implemented method of any of examples 1-4, further comprising: receiving, from the first network node, a first flow update that includes first instructions about the update and second instructions about a different update to the first packet performed by a second network node on the first network path, wherein the instructions include first instructions and the second instructions; and determining that the first instructions rather than the second instructions are to be performed such that the second packet is sent based on the first instructions being performed rather than the second instructions being performed.

Example 6 includes the computer-implemented method of any of examples 1-5, further comprising: determining that the instructions indicate that a copy of the second packet is to be generated and sent to a different destination; and sending the copy to the different destination.

Example 7 includes the computer-implemented method of any of examples 1-6, wherein the instructions are stored in an entry of a flow table, and wherein the computer-implemented method further comprises: determining that the entry applies to the second packet; determining the instructions from the entry; and updating a header of the second packet based on the instructions, wherein the updated header corresponds to the second network path.

Example 8 includes the computer-implemented method of any of examples 1-7, wherein the instructions are stored in an entry of a flow table, wherein the flow table associates a flow between the source and destination with the first network path and with the instructions, and wherein the computer-implemented method further comprises: sending, after the first packet is sent, a probe packet on the first network path, wherein the probe packet is usable to determine a change to the instructions; determining that the instructions in the entry apply to the second packet; and updating a header of the second packet based on the instructions, wherein the updated header corresponds to the second network path.

Example 9 includes the computer-implemented method of any of examples 1-8, wherein the instructions are stored in an entry of a flow table, and wherein the computer-implemented method further comprises: determining that no update has been made to the entry for a predefined time duration; and determining that the entry is no longer usable to send subsequent packets to the destination.

Example 10 includes the computer-implemented method of any of examples 1-9, wherein the instructions are stored in an entry of a flow table, and wherein the computer-implemented method further comprises: completing a software update installation on the source; and persisting the flow table despite the software update installation.

Example 11 includes the computer-implemented method of any of examples 1-10, wherein a first portion of the instructions is received based on the first packet and wherein a second portion of the instructions is received based on a probe packet, wherein receiving the first portion triggers the source to send the probe packet on the first network path.

Example 12 includes the computer-implemented method of any of examples 1-11, wherein the first packet indicates that the source supports using the instructions to bypass the first network node.

Example 13 includes the computer-implemented method of any of examples 1-12, further comprising: including, in the second packet, information about the first network node, wherein the destination is configured to validate the second packet based on the information.

Example 14 includes the computer-implemented method of any of examples 1-13, further comprising: receiving, after the second packet is sent, a third packet on the first network path, the third packet sent by the destination.

Example 15 includes the computer-implemented method of any of examples 1-14, further comprising: receiving, after the second packet is sent, a third packet on the second network path, the third packet sent by the destination.

Example 16 includes the computer-implemented method of any of examples 1-15, wherein the instructions indicate a network operation to apply and a set of values to use for the network operation, and wherein the second packet is updated by applying the network operation using the set of values.

Example 17 includes the computer-implemented method of any of examples 1-16, further comprising: receiving, by the source from the destination, an acknowledgment to the second packet, the acknowledgement received along the first network path.

Example 18 includes the computer-implemented method of any of examples 1-17, further comprising: receiving, by the source from the destination, a first acknowledgment to the first packet, the first acknowledgement received along the first network path; and receiving, by the source from the destination, a second acknowledgment to the second packet, the second acknowledgement received along the second network path.

Example 19 includes a source comprising: one or more processors; and one or more memories storing program code that, upon execution by the one or more processors, configure the source to perform the computer-implemented method of any examples 1-18.

Example 20 includes one or more computer-readable storage media storing program code that, upon execution on a source, cause the source to perform operations comprising those of the computer-implemented method of any examples 1-18. As such, embodiments may be implemented by using a computer program product, comprising computer program/instructions which, when executed by a processor, cause the processor to perform any of the methods described in the disclosure.

Example 21 includes a computer-implemented method on a source, the computer-implemented method comprising: sending a first packet to a first network node, the first network node being on a first network path between the source and a destination, the first packet destined to the destination; receiving, from the first network node based on the first packet, first instructions for updating packets to be sent to the destination, the first instructions being based on a first packet update performed by the first network node and enabling the source to bypass the first network node when sending the packets to the destination; sending, based on the first instructions, a probe packet on the first network path; receiving, from a second network node based on the probe packet, second instructions for updating the packets to be sent to the destination, the second instructions being based on a second packet update performed by the second network node and enabling the source to bypass the second network node when sending the packets to the destination; storing the first instructions and the second instructions; updating, based on the first instructions and the second instructions, a second packet destined to the destination; and sending the second packet to the destination, the second packet sent using a second network path that bypasses the first network node and the second network node.

Example 22 includes the computer-implemented method of example 21, wherein the probe packet has the same header information as the first packet, wherein payload information of the probe packet is different than payload information of the first packet.

Example 23 includes the computer-implemented method of example 22, wherein header information of the second packet is different than the header information of the first packet.

Example 24 includes the computer-implemented method of any of examples 21-23, wherein the second instructions are received in a flow update from the second network node, and wherein the flow update further includes the first instructions.

Example 25 includes the computer-implemented method of any of examples 21-24, wherein the second instructions are received in a flow update from the second network node, and wherein the computer-implemented method further comprises: including a first secret in the probe packet; determining a second secret included in the flow update; and determining that the flow update is valid based on the first secret and the second secret.

Example 26 includes the computer-implemented method of any of examples 21-25, wherein the sending of the probe packet is triggered by the receiving of the first instructions, and wherein the computer-implemented method further comprises sending additional probe packets at a predefined rate after the probe packet is sent.

Example 27 includes the computer-implemented method of example 26, wherein the probe packet is a first probe packet, and wherein the computer-implemented method further comprises: sending, on the first network path, a second probe packet at the predefined rate to determine a change to at least one of the first instructions or the second instructions.

Example 28 includes the computer-implemented method of example 27, further comprising:
receiving, by the source based on the second probe packet, a change to the first instructions, the change corresponding to a modification to the first packet update; updating, based on the change, the first instructions that are stored by the source; updating, based on the updated first instructions, a third packet destined to the destination; and sending, to the destination, the third packet on a third network path that is different from the second network path and that bypasses the first network node.

Example 29 includes the computer-implemented method of any of examples 21-28, wherein the probe packet has the same header information as the first packet, wherein payload information of the probe packet is different than payload information of the first packet.

Example 30 includes the computer-implemented method of example 29, wherein header information of the second packet is different than the header information of the first packet.

Example 31 includes the computer-implemented method of any of examples 21-30, wherein the second instructions are received in a flow update from the second network node, and wherein the flow update further includes the first instructions.

Example 32 includes the computer-implemented method of any of examples 21-31, wherein the second instructions are received in a flow update from the second network node, and wherein the computer-implemented method further comprises: including a first secret in the probe packet; determining a second secret included in the flow update; and determining that the flow update is valid based on the first secret and the second secret.

Example 33 includes the computer-implemented method of any of examples 21-32, wherein the sending of the probe packet is triggered by the receiving of the first instructions, and wherein the computer-implemented method further comprises: sending additional probe packets at a predefined rate after the probe packet is sent.

Example 34 includes the computer-implemented method of example 33, wherein the probe packet is a first probe packet, and wherein the computer-implemented method further comprises sending, on the first network path, a second probe packet at the predefined rate to determine a change to at least one of the first instructions or the second instructions.

Example 35 includes a source comprising: one or more processors; and one or more memories storing program code that, upon execution by the one or more processors, configure the source to perform the computer-implemented method of any examples 21-34.

Example 36 includes one or more computer-readable storage media storing program code that, upon execution on a source, cause the source to perform operations comprising those of the computer-implemented method of any examples 21-34. As such, embodiments may be implemented by using a computer program product, comprising computer program/instructions which, when executed by a processor, cause the processor to perform any of the methods described in the disclosure.

Example 37 includes a computer-implemented method on a first network node, the computer-implemented method comprising: receiving, from a source, a first packet destined to a destination, the first network node being on a first network path between the source and a destination; performing a first packet update on the first packet before sending the first packet to a second network node on the first network path; sending, to the source, first instructions for updating packets to be sent to the destination, the first instructions being based on the first packet update and enabling the source to bypass the first network node when sending the packets to the destination; receiving, from the source based on the first instructions, a probe packet on the first network path; and including the first instructions in the probe packet before sending the probe packet to the second network node, wherein the probe packet causes the second network node to send, to the source, second instructions for updating the packets to be sent to the destination, the second instructions being based on a second packet update performed by the second network node and enabling the source to bypass the second network node when sending the packets to the destination.

Example 38 includes the computer-implemented method of example 37, further comprising:
determining a total number of packets sent by the source to the destination on the first network path within a predefined time period; and determining that the total number exceeds a threshold number, wherein the first instructions are sent based on the total number exceeding the threshold number.

Example 39 includes the computer-implemented method of any of examples 37-38, the second network node is configured to request the destination whether the destination supports receiving the packets from the source, and wherein the second instructions are sent to the source based on an indication of the destination that the destination supports receiving the packets from the source.

Example 40 includes the computer-implemented method of any of examples 37-39, wherein the probe packet further causes the second network node to send the first instructions to the source.

Example 41 includes the computer-implemented method of any of examples 37-40, wherein the first instructions indicate a network operation that the source is to apply and that corresponds to the first packet update, and wherein the first instructions further indicate a set of values when applying the network operation on a second packet.

Example 42 includes a first network node comprising: one or more processors; and one or more memories storing program code that, upon execution by the one or more processors, configure the first network node to perform the computer-implemented method of any examples 37-41.

Example 43 includes one or more computer-readable storage media storing program code that, upon execution on a first network node, cause the first network node to perform operations comprising those of the computer-implemented method of any examples 37-41. As such, embodiments may be implemented by using a computer program product, comprising computer program/instructions which, when executed by a processor, cause the processor to perform any of the methods described in the disclosure.

Example 44 includes a computer-implemented method on a first network node, the computer-implemented method comprising: receiving, from a source, a first packet destined to a destination, the first network node being on a first network path between the source and the destination; determining that the source supports sending packets to the destination using one or more network paths that bypass the first network node; performing an update on the first packet, the update enabling the first network node to send the packet to a next network hop, the next network hop being a second network node or the destination; and sending, to the source, instructions for updating packets to be sent to the destination, the instructions being based on the update and enabling the source to send a second packet on a second network path that bypasses the first network node.

Example 45 includes the computer-implemented method of example 44, wherein the first packet indicates that the source supports bypassing the first network node.

Example 46 includes the computer-implemented method of any examples 44-45, wherein the instructions are sent in a flow update, wherein the flow update causes the source to update a flow table associated with a flow between the source and the destination by including an entry in the flow table, wherein the entry indicates the flow and includes the instructions.

Example 47 includes the computer-implemented method of example 46, further comprising:
determining that the destination supports receiving the packets from the destination rather than the first network node, wherein the flow update is sent based on the destination supporting the receiving of the packets.

Example 48 includes the computer-implemented method of any examples 44-47, further comprising: determining that that the first packet includes an indication that the instructions are requested, wherein the instructions are sent based on the indication.

Example 49 includes the computer-implemented method of any examples 44-48, wherein the instructions are first instructions, and wherein the computer-implemented method further comprises: receiving, from the source, a probe packet based on the first instructions; updating the probe packet by including the first instructions in the probe packet; and sending the updated probe packet to the second network node, wherein the source is configured to receive the first instructions and second instructions of the second network node in a flow update based on the updated probe packet.

Example 50 includes the computer-implemented method of example 49, wherein the first packet and the probe packet include the same header information, and wherein payload information of the probe packet is different from payload information of the first packet.

Example 51 includes the computer-implemented method of example 49, wherein the probe packet includes a secret of the source, and wherein the flow update includes the secret.

Example 52 includes the computer-implemented method of any examples 44-51, wherein the instructions indicate a network operation that the first network node applied to the first packet and that is to be applied by the source to the second packet and a set of values to use for the network operation, wherein the second packet is sent based on the network operation and the set of values.

Example 53 includes the computer-implemented method of any examples 44-52, wherein the instructions are first instructions, and wherein the computer-implemented method further comprises: receiving, from the second network node, a probe packet, the probe packet destined to the source and including second instructions of the second network node, the second instructions indicating a second network operation performed by the second network node on a flow from the destination to the source; and sending, based on the probe packet, a flow update to the destination, wherein the flow update includes the second instructions and enables the destination to send packets to the source by bypassing the second network node.

Example 54 includes the computer-implemented method of example 53, wherein the computer-implemented method further comprises: including, in the flow update, third instructions indicating a first network operation performed by the first network node on the flow from the destination to the source, wherein the flow update enables the destination to send the packets to the source by also bypassing the first network node.

Example 55 includes the computer-implemented method of any examples 44-54, wherein the instructions are first instructions, and wherein the computer-implemented method further comprises: receiving, from the source on the first network path and based on the instructions being sent to the source, a probe packet that has the same header information as the first packet and that has different payload information than the first packet; updating the probe packet to include the instructions; and sending the probe packet to the second network node, wherein the second network node is configured to send a flow update to the source, wherein the flow update includes the instructions and additional instructions about a network operation performed by the second network node on packets received on the first network path.

Example 56 includes the computer-implemented method of example 55, wherein sending the instructions to the source triggers the source to send the probe packet, and wherein the source is configured to send subsequent prob packets at a predefined rate.

Example 57 includes the computer-implemented method of any examples 44-56, wherein the first packet indicates that the source supports bypassing the first network node.

Example 58 includes the computer-implemented method of any examples 44-57, wherein the instructions are sent in a flow update, wherein the flow update causes the source to update a flow table associated with a flow between the source and the destination by including an entry in the flow table, wherein the entry indicates the flow and includes the instructions.

Example 59 includes the computer-implemented method of example 58, wherein the computer-implemented method further comprises: determining that the destination supports receiving the packets from the destination rather than the first network node, wherein the flow update is sent based on the destination supporting the receiving of the packets.

Example 60 includes the computer-implemented method of any examples 44-59, wherein the computer-implemented method further comprises: determining that that the first packet includes an indication that the instructions are requested, wherein the instructions are sent based on the indication.

Example 61 includes the computer-implemented method of any examples 44-60, wherein the instructions are first instructions, and wherein the computer-implemented method further comprises: receiving, from the source, a probe packet based on the first instructions; updating the probe packet by including the first instructions in the probe packet; and sending the updated probe packet to the second network node, wherein the source is configured to receive the first instructions and second instructions of the second network node in a flow update based on the updated probe packet.

Example 62 includes a first network node comprising: one or more processors; and one or more memories storing program code that, upon execution by the one or more processors, configure the first network node to perform the computer-implemented method of any examples 44-61.

Example 63 includes one or more computer-readable storage media storing program code that, upon execution on a first network node, cause the first network node to perform operations comprising those of the computer-implemented method of any examples 44-61. As such, embodiments may be implemented by using a computer program product, comprising computer program/instructions which, when executed by a processor, cause the processor to perform any of the methods described in the disclosure.

### Examples of Cloud Infrastructure

As noted above, infrastructure as a service (IaaS) is one particular type of cloud computing. IaaS can be configured to provide virtualized computing resources over a public network (e.g., the Internet). In an IaaS model, a cloud computing provider can host the infrastructure components (e.g., servers, storage devices, network nodes (e.g., hardware), deployment software, platform virtualization (e.g., a hypervisor layer), or the like). In some cases, an IaaS provider may also supply a variety of services to accompany those infrastructure components (example services include billing software, monitoring software, logging software, load balancing software, clustering software, etc.). Thus, as these services may be policy-driven, IaaS users may be able to implement policies to drive load balancing to maintain application availability and performance.

In some instances, IaaS customers may access resources and services through a wide area network (WAN), such as the Internet, and can use the cloud provider's services to install the remaining elements of an application stack. For example, the user can log in to the IaaS platform to create virtual machines (VMs), install operating systems (OSs) on each VM, deploy middleware such as databases, create storage buckets for workloads and backups, and even install enterprise software into that VM. Customers can then use the provider's services to perform various functions, including balancing network traffic, troubleshooting application issues, monitoring performance, managing disaster recovery, etc.

In most cases, a cloud computing model will require the participation of a cloud provider. The cloud provider may, but need not be, a third-party service that specializes in providing (e.g., offering, renting, selling) IaaS. An entity might also opt to deploy a private cloud, becoming its own provider of infrastructure services.

In some examples, IaaS deployment is the process of putting a new application, or a new version of an application, onto a prepared application server or the like. It may also include the process of preparing the server (e.g., installing libraries, daemons, etc.). This is often managed by the cloud provider, below the hypervisor layer (e.g., the servers, storage, network hardware, and virtualization). Thus, the customer may be responsible for handling (OS), middleware, and/or application deployment (e.g., on self-service virtual machines (e.g., that can be spun up on demand) or the like.

In some examples, IaaS provisioning may refer to acquiring computers or virtual hosts for use, and even installing needed libraries or services on them. In most cases, deployment does not include provisioning, and the provisioning may need to be performed first.

In some cases, there are two different challenges for IaaS provisioning. First, there is the initial challenge of provisioning the initial set of infrastructure before anything is running. Second, there is the challenge of evolving the existing infrastructure (e.g., adding new services, changing services, removing services, etc.) once everything has been provisioned. In some cases, these two challenges may be addressed by enabling the configuration of the infrastructure to be defined declaratively. In other words, the infrastructure (e.g., what components are needed and how they interact) can be defined by one or more configuration files. Thus, the overall topology of the infrastructure (e.g., what resources depend on which, and how they each work together) can be described declaratively. In some instances, once the topology is defined, a workflow can be generated that creates and/or manages the different components described in the configuration files.

In some examples, an infrastructure may have many interconnected elements. For example, there may be one or more virtual private clouds (VPCs) (e.g., a potentially on-demand pool of configurable and/or shared computing resources), also known as a core network. In some examples, there may also be one or more inbound/outbound traffic group rules provisioned to define how the inbound and/or outbound traffic of the network will be set up and one or more virtual machines (VMs). Other infrastructure elements may also be provisioned, such as a load balancer, a database, or the like. As more and more infrastructure elements are desired and/or added, the infrastructure may incrementally evolve.

In some instances, continuous deployment techniques may be employed to enable deployment of infrastructure code across various virtual computing environments. Additionally, the described techniques can enable infrastructure management within these environments. In some examples, service teams can write code that is desired to be deployed to one or more, but often many, different production environments (e.g., across various different geographic locations, sometimes spanning the entire world). However, in some examples, the infrastructure on which the code will be deployed must first be set up. In some instances, the provisioning can be done manually, a provisioning tool may be utilized to provision the resources, and/or deployment tools may be utilized to deploy the code once the infrastructure is provisioned.

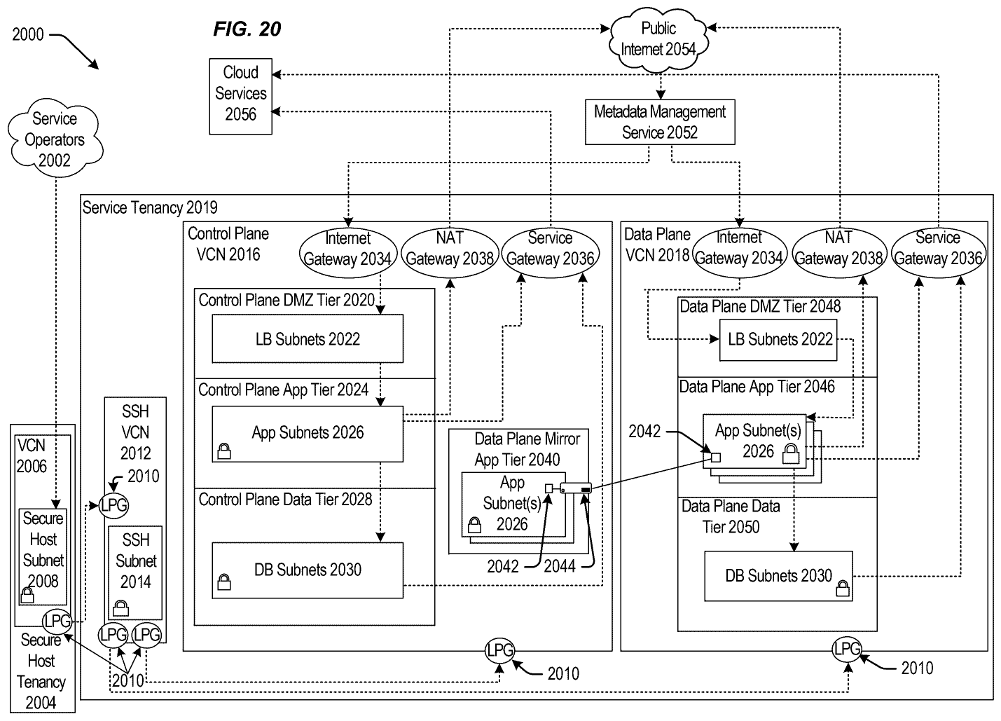

FIG. 20 is a block diagram 2000 illustrating an example pattern of an IaaS architecture, according to at least one embodiment. Service operators 2002 can be communicatively coupled to a secure host tenancy 2004 that can include a virtual cloud network (VCN) 2006 and a secure host subnet 2008. In some examples, the service operators 2002 may be using one or more client computing devices, which may be portable handheld devices (e.g., an iPhone®, cellular telephone, an iPad®, computing tablet, a personal digital assistant (PDA)) or wearable devices (e.g., a Google Glass® head mounted display), running software such as Microsoft Windows Mobile®, and/or a variety of mobile operating systems such as iOS, Windows Phone, Android, BlackBerry 8, Palm OS, and the like, and being Internet, e-mail, short message service (SMS), Blackberry®, or other communication protocol enabled. Alternatively, the client computing devices can be general purpose personal computers including, by way of example, personal computers and/or laptop computers running various versions of Microsoft Windows®, Apple Macintosh®, and/or Linux operating systems. The client computing devices can be workstation computers running any of a variety of commercially-available UNIX® or UNIX-like operating systems, including without limitation the variety of GNU/Linux operating systems, such as for example, Google Chrome OS. Alternatively, or in addition, client computing devices may be any other electronic device, such as a thin-client computer, an Internet-enabled gaming system (e.g., a Microsoft Xbox gaming console with or without a Kinect® gesture input device), and/or a personal messaging device, capable of communicating over a network that can access the VCN 2006 and/or the Internet.

The VCN 2006 can include a local peering gateway (LPG) 2010 that can be communicatively coupled to a secure shell (SSH) VCN 2012 via an LPG 2010 contained in the SSH VCN 2012. The SSH VCN 2012 can include an SSH subnet 2014, and the SSH VCN 2012 can be communicatively coupled to a control plane VCN 2016 via the LPG 2010 contained in the control plane VCN 2016. Also, the SSH VCN 2012 can be communicatively coupled to a data plane VCN 2018 via an LPG 2010. The control plane VCN 2016 and the data plane VCN 2018 can be contained in a service tenancy 2019 that can be owned and/or operated by the IaaS provider.

The control plane VCN 2016 can include a control plane demilitarized zone (DMZ) tier 2020 that acts as a perimeter network (e.g., portions of a corporate network between the corporate intranet and external networks). The DMZ-based servers may have restricted responsibilities and help keep breaches contained. Additionally, the DMZ tier 2020 can include one or more load balancer (LB) subnet(s) 2022, a control plane app tier 2024 that can include app subnet(s) 2026, a control plane data tier 2028 that can include database (DB) subnet(s) 2030 (e.g., frontend DB subnet(s) and/or backend DB subnet(s)). The LB subnet(s) 2022 contained in the control plane DMZ tier 2020 can be communicatively coupled to the app subnet(s) 2026 contained in the control plane app tier 2024 and an Internet gateway 2034 that can be contained in the control plane VCN 2016, and the app subnet(s) 2026 can be communicatively coupled to the DB subnet(s) 2030 contained in the control plane data tier 2028 and a service gateway 2036 and a network address translation (NAT) gateway 2038. The control plane VCN 2016 can include the service gateway 2036 and the NAT gateway 2038.

The control plane VCN 2016 can include a data plane mirror app tier 2040 that can include app subnet(s) 2026. The app subnet(s) 2026 contained in the data plane mirror app tier 2040 can include a virtual network interface controller (VNIC) 2042 that can execute a compute instance 2044. The compute instance 2044 can communicatively couple the app subnet(s) 2026 of the data plane mirror app tier 2040 to app subnet(s) 2026 that can be contained in a data plane app tier 2046.

The data plane VCN 2018 can include the data plane app tier 2046, a data plane DMZ tier 2048, and a data plane data tier 2050. The data plane DMZ tier 2048 can include LB subnet(s) 2022 that can be communicatively coupled to the app subnet(s) 2026 of the data plane app tier 2046 and the Internet gateway 2034 of the data plane VCN 2018. The app subnet(s) 2026 can be communicatively coupled to the service gateway 2036 of the data plane VCN 2018 and the NAT gateway 2038 of the data plane VCN 2018. The data plane data tier 2050 can also include the DB subnet(s) 2030 that can be communicatively coupled to the app subnet(s) 2026 of the data plane app tier 2046.

The Internet gateway 2034 of the control plane VCN 2016 and of the data plane VCN 2018 can be communicatively coupled to a metadata management service 2052 that can be communicatively coupled to public Internet 2054. Public Internet 2054 can be communicatively coupled to the NAT gateway 2038 of the control plane VCN 2016 and of the data plane VCN 2018. The service gateway 2036 of the control plane VCN 2016 and of the data plane VCN 2018 can be communicatively coupled to cloud services 2056.

In some examples, the service gateway 2036 of the control plane VCN 2016 or of the data plane VCN 2018 can make application programming interface (API) calls to cloud services 2056 without going through public Internet 2054. The API calls to cloud services 2056 from the service gateway 2036 can be one-way: the service gateway 2036 can make API calls to cloud services 2056, and cloud services 2056 can send requested data to the service gateway 2036. But, cloud services 2056 may not initiate API calls to the service gateway 2036.

In some examples, the secure host tenancy 2004 can be directly connected to the service tenancy 2019, which may be otherwise isolated. The secure host subnet 2008 can communicate with the SSH subnet 2014 through an LPG 2010 that may enable two-way communication over an otherwise isolated system. Connecting the secure host subnet 2008 to the SSH subnet 2014 may give the secure host subnet 2008 access to other entities within the service tenancy 2019.

The control plane VCN 2016 may allow users of the service tenancy 2019 to set up or otherwise provision desired resources. Desired resources provisioned in the control plane VCN 2016 may be deployed or otherwise used in the data plane VCN 2018. In some examples, the control plane VCN 2016 can be isolated from the data plane VCN 2018, and the data plane mirror app tier 2040 of the control plane VCN 2016 can communicate with the data plane app tier 2046 of the data plane VCN 2018 via VNICs 2042 that can be contained in the data plane mirror app tier 2040 and the data plane app tier 2046.

In some examples, users of the system, or customers, can make requests, for example create, read, update, or delete (CRUD) operations, through public Internet 2054 that can communicate the requests to the metadata management service 2052. The metadata management service 2052 can communicate the request to the control plane VCN 2016 through the Internet gateway 2034. The request can be received by the LB subnet(s) 2022 contained in the control plane DMZ tier 2020. The LB subnet(s) 2022 may determine that the request is valid, and in response to this determination, the LB subnet(s) 2022 can transmit the request to app subnet(s) 2026 contained in the control plane app tier 2024. If the request is validated and requires a call to public Internet 2054, the call to public Internet 2054 may be transmitted to the NAT gateway 2038 that can make the call to public Internet 2054. Metadata that may be desired to be stored by the request can be stored in the DB subnet(s) 2030.

In some examples, the data plane mirror app tier 2040 can facilitate direct communication between the control plane VCN 2016 and the data plane VCN 2018. For example, changes, updates, or other suitable modifications to configuration may be desired to be applied to the resources contained in the data plane VCN 2018. Via a VNIC 2042, the control plane VCN 2016 can directly communicate with, and can thereby execute the changes, updates, or other suitable modifications to configuration to, resources contained in the data plane VCN 2018.

In some embodiments, the control plane VCN 2016 and the data plane VCN 2018 can be contained in the service tenancy 2019. In this case, the user, or the customer, of the system may not own or operate either the control plane VCN 2016 or the data plane VCN 2018. Instead, the IaaS provider may own or operate the control plane VCN 2016 and the data plane VCN 2018, both of which may be contained in the service tenancy 2019. This embodiment can enable isolation of networks that may prevent users or customers from interacting with other users', or other customers', resources. Also, this embodiment may allow users or customers of the system to store databases privately without needing to rely on public Internet 2054, which may not have a desired level of threat prevention, for storage.

In other embodiments, the LB subnet(s) 2022 contained in the control plane VCN 2016 can be configured to receive a signal from the service gateway 2036. In this embodiment, the control plane VCN 2016 and the data plane VCN 2018 may be configured to be called by a customer of the IaaS provider without calling public Internet 2054. Customers of the IaaS provider may desire this embodiment since database(s) that the customers use may be controlled by the IaaS provider and may be stored on the service tenancy 2019, which may be isolated from public Internet 2054.

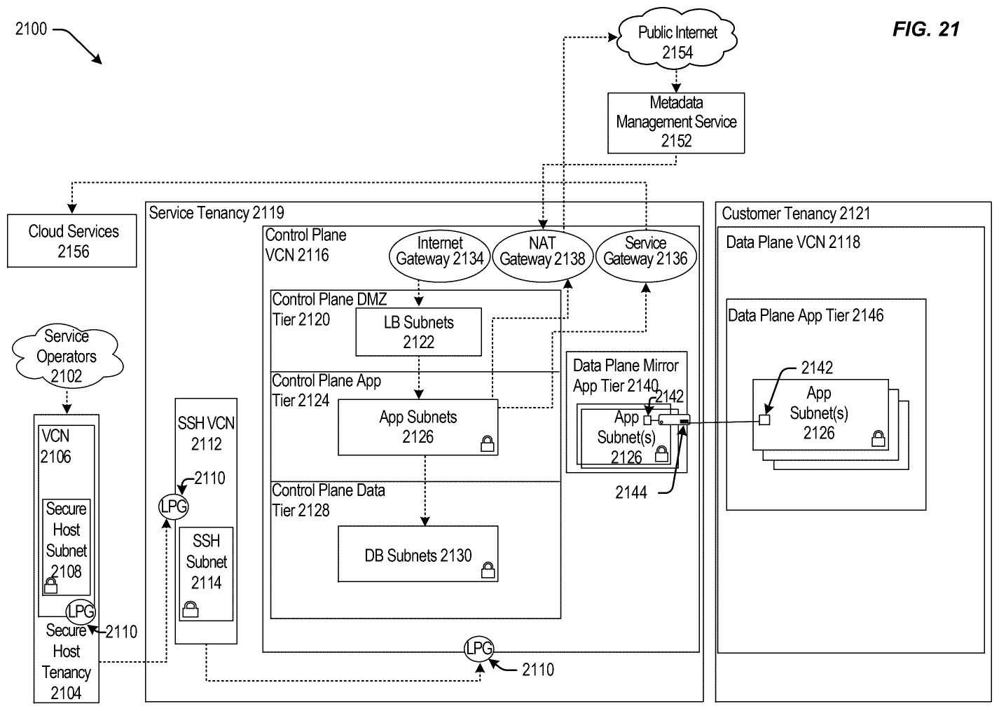

FIG. 21 is a block diagram 2100 illustrating another example pattern of an IaaS architecture, according to at least one embodiment. Service operators 2102 (e.g., service operators 2002 of FIG. 20) can be communicatively coupled to a secure host tenancy 2104 (e.g., the secure host tenancy 2004 of FIG. 20) that can include a virtual cloud network (VCN) 2106 (e.g., the VCN 2006 of FIG. 20) and a secure host subnet 2108 (e.g., the secure host subnet 2008 of FIG. 20). The VCN 2106 can include a local peering gateway (LPG) 2110 (e.g., the LPG 2010 of FIG. 20) that can be communicatively coupled to a secure shell (SSH) VCN 2112 (e.g., the SSH VCN 2012 of FIG. 20) via an LPG 2010 contained in the SSH VCN 2112. The SSH VCN 2112 can include an SSH subnet 2114 (e.g., the SSH subnet 2014 of FIG. 20), and the SSH VCN 2112 can be communicatively coupled to a control plane VCN 2116 (e.g., the control plane VCN 2016 of FIG. 20) via an LPG 2110 contained in the control plane VCN 2116. The control plane VCN 2116 can be contained in a service tenancy 2119 (e.g., the service tenancy 2019 of FIG. 20), and the data plane VCN 2118 (e.g., the data plane VCN 2018 of FIG. 20) can be contained in a customer tenancy 2121 that may be owned or operated by users, or customers, of the system.

The control plane VCN 2116 can include a control plane DMZ tier 2120 (e.g., the control plane DMZ tier 2020 of FIG. 20) that can include LB subnet(s) 2122 (e.g., LB subnet(s) 2022 of FIG. 20), a control plane app tier 2124 (e.g., the control plane app tier 2024 of FIG. 20) that can include app subnet(s) 2126 (e.g., app subnet(s) 2026 of FIG. 20), a control plane data tier 2128 (e.g., the control plane data tier 2028 of FIG. 20) that can include database (DB) subnet(s) 2130 (e.g., similar to DB subnet(s) 2030 of FIG. 20). The LB subnet(s) 2122 contained in the control plane DMZ tier 2120 can be communicatively coupled to the app subnet(s) 2126 contained in the control plane app tier 2124 and an Internet gateway 2134 (e.g., the Internet gateway 2034 of FIG. 20) that can be contained in the control plane VCN 2116, and the app subnet(s) 2126 can be communicatively coupled to the DB subnet(s) 2130 contained in the control plane data tier 2128 and a service gateway 2136 (e.g., the service gateway 2036 of FIG. 20) and a network address translation (NAT) gateway 2138 (e.g., the NAT gateway 2038 of FIG. 20). The control plane VCN 2116 can include the service gateway 2136 and the NAT gateway 2138.

The control plane VCN 2116 can include a data plane mirror app tier 2140 (e.g., the data plane mirror app tier 2040 of FIG. 20) that can include app subnet(s) 2126. The app subnet(s) 2126 contained in the data plane mirror app tier 2140 can include a virtual network interface controller (VNIC) 2142 (e.g., the VNIC of 2042) that can execute a compute instance 2144 (e.g., similar to the compute instance 2044 of FIG. 20). The compute instance 2144 can facilitate communication between the app subnet(s) 2126 of the data plane mirror app tier 2140 and the app subnet(s) 2126 that can be contained in a data plane app tier 2146 (e.g., the data plane app tier 2046 of FIG. 20) via the VNIC 2142 contained in the data plane mirror app tier 2140 and the VNIC 2142 contained in the data plane app tier 2146.

The Internet gateway 2134 contained in the control plane VCN 2116 can be communicatively coupled to a metadata management service 2152 (e.g., the metadata management service 2052 of FIG. 20) that can be communicatively coupled to public Internet 2154 (e.g., public Internet 2054 of FIG. 20). Public Internet 2154 can be communicatively coupled to the NAT gateway 2138 contained in the control plane VCN 2116. The service gateway 2136 contained in the control plane VCN 2116 can be communicatively coupled to cloud services 2156 (e.g., cloud services 2056 of FIG. 20).

In some examples, the data plane VCN 2118 can be contained in the customer tenancy 2121. In this case, the IaaS provider may provide the control plane VCN 2116 for each customer, and the IaaS provider may, for each customer, set up a unique compute instance 2144 that is contained in the service tenancy 2119. Each compute instance 2144 may allow communication between the control plane VCN 2116, contained in the service tenancy 2119, and the data plane VCN 2118 that is contained in the customer tenancy 2121. The compute instance 2144 may allow resources, that are provisioned in the control plane VCN 2116 that is contained in the service tenancy 2119, to be deployed or otherwise used in the data plane VCN 2118 that is contained in the customer tenancy 2121.

In other examples, the customer of the IaaS provider may have databases that live in the customer tenancy 2121. In this example, the control plane VCN 2116 can include the data plane mirror app tier 2140 that can include app subnet(s) 2126. The data plane mirror app tier 2140 can reside in the data plane VCN 2118, but the data plane mirror app tier 2140 may not live in the data plane VCN 2118. That is, the data plane mirror app tier 2140 may have access to the customer tenancy 2121, but the data plane mirror app tier 2140 may not exist in the data plane VCN 2118 or be owned or operated by the customer of the IaaS provider. The data plane mirror app tier 2140 may be configured to make calls to the data plane VCN 2118 but may not be configured to make calls to any entity contained in the control plane VCN 2116. The customer may desire to deploy or otherwise use resources in the data plane VCN 2118 that are provisioned in the control plane VCN 2116, and the data plane mirror app tier 2140 can facilitate the desired deployment, or other usage of resources, of the customer.

In some embodiments, the customer of the IaaS provider can apply filters to the data plane VCN 2118. In this embodiment, the customer can determine what the data plane VCN 2118 can access, and the customer may restrict access to public Internet 2154 from the data plane VCN 2118. The IaaS provider may not be able to apply filters or otherwise control access of the data plane VCN 2118 to any outside networks or databases. Applying filters and controls by the customer onto the data plane VCN 2118, contained in the customer tenancy 2121, can help isolate the data plane VCN 2118 from other customers and from public Internet 2154.

In some embodiments, cloud services 2156 can be called by the service gateway 2136 to access services that may not exist on public Internet 2154, on the control plane VCN 2116, or on the data plane VCN 2118. The connection between cloud services 2156 and the control plane VCN 2116 or the data plane VCN 2118 may not be live or continuous. Cloud services 2156 may exist on a different network owned or operated by the IaaS provider. Cloud services 2156 may be configured to receive calls from the service gateway 2136 and may be configured to not receive calls from public Internet 2154. Some cloud services 2156 may be isolated from other cloud services 2156, and the control plane VCN 2116 may be isolated from cloud services 2156 that may not be in the same region as the control plane VCN 2116. For example, the control plane VCN 2116 may be located in “Region 1,” and cloud service “Deployment 20,” may be located in Region 1 and in “Region 2.” If a call to Deployment 20 is made by the service gateway 2136 contained in the control plane VCN 2116 located in Region 1, the call may be transmitted to Deployment 20 in Region 1. In this example, the control plane VCN 2116, or Deployment 20 in Region 1, may not be communicatively coupled to, or otherwise in communication with, Deployment 20 in Region 2.

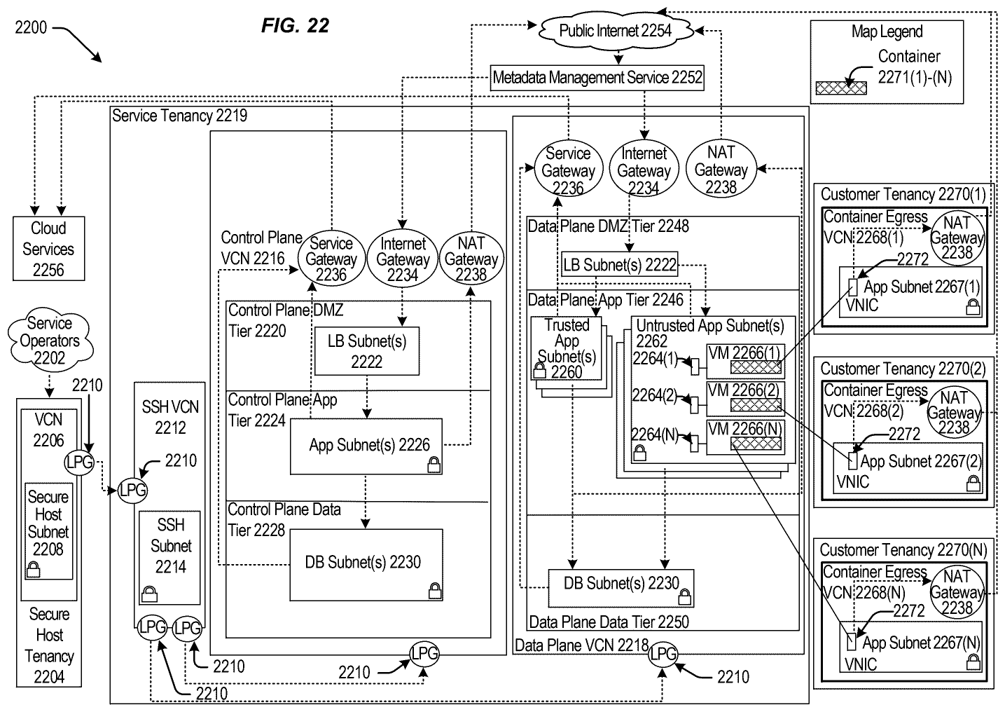

FIG. 22 is a block diagram 2200 illustrating another example pattern of an IaaS architecture, according to at least one embodiment. Service operators 2202 (e.g., service operators 2002 of FIG. 20) can be communicatively coupled to a secure host tenancy 2204 (e.g., the secure host tenancy 2004 of FIG. 20) that can include a virtual cloud network (VCN) 2206 (e.g., the VCN 2006 of FIG. 20) and a secure host subnet 2208 (e.g., the secure host subnet 2008 of FIG. 20). The VCN 2206 can include an LPG 2210 (e.g., the LPG 2010 of FIG. 20) that can be communicatively coupled to an SSH VCN 2212 (e.g., the SSH VCN 2012 of FIG. 20) via an LPG 2210 contained in the SSH VCN 2212. The SSH VCN 2212 can include an SSH subnet 2214 (e.g., the SSH subnet 2014 of FIG. 20), and the SSH VCN 2212 can be communicatively coupled to a control plane VCN 2216 (e.g., the control plane VCN 2016 of FIG. 20) via an LPG 2210 contained in the control plane VCN 2216 and to a data plane VCN 2218 (e.g., the data plane 2018 of FIG. 20) via an LPG 2210 contained in the data plane VCN 2218. The control plane VCN 2216 and the data plane VCN 2218 can be contained in a service tenancy 2219 (e.g., the service tenancy 2019 of FIG. 20).

The control plane VCN 2216 can include a control plane DMZ tier 2220 (e.g., the control plane DMZ tier 2020 of FIG. 20) that can include load balancer (LB) subnet(s) 2222 (e.g., LB subnet(s) 2022 of FIG. 20), a control plane app tier 2224 (e.g., the control plane app tier 2024 of FIG. 20) that can include app subnet(s) 2226 (e.g., similar to app subnet(s) 2026 of FIG. 20), a control plane data tier 2228 (e.g., the control plane data tier 2028 of FIG. 20) that can include DB subnet(s) 2230. The LB subnet(s) 2222 contained in the control plane DMZ tier 2220 can be communicatively coupled to the app subnet(s) 2226 contained in the control plane app tier 2224 and to an Internet gateway 2234 (e.g., the Internet gateway 2034 of FIG. 20) that can be contained in the control plane VCN 2216, and the app subnet(s) 2226 can be communicatively coupled to the DB subnet(s) 2230 contained in the control plane data tier 2228 and to a service gateway 2236 (e.g., the service gateway of FIG. 20) and a network address translation (NAT) gateway 2238 (e.g., the NAT gateway 2038 of FIG. 20). The control plane VCN 2216 can include the service gateway 2236 and the NAT gateway 2238.

The data plane VCN 2218 can include a data plane app tier 2246 (e.g., the data plane app tier 2046 of FIG. 20), a data plane DMZ tier 2248 (e.g., the data plane DMZ tier 2048 of FIG. 20), and a data plane data tier 2250 (e.g., the data plane data tier 2050 of FIG. 20). The data plane DMZ tier 2248 can include LB subnet(s) 2222 that can be communicatively coupled to trusted app subnet(s) 2260 and untrusted app subnet(s) 2262 of the data plane app tier 2246 and the Internet gateway 2234 contained in the data plane VCN 2218. The trusted app subnet(s) 2260 can be communicatively coupled to the service gateway 2236 contained in the data plane VCN 2218, the NAT gateway 2238 contained in the data plane VCN 2218, and DB subnet(s) 2230 contained in the data plane data tier 2250. The untrusted app subnet(s) 2262 can be communicatively coupled to the service gateway 2236 contained in the data plane VCN 2218 and DB subnet(s) 2230 contained in the data plane data tier 2250. The data plane data tier 2250 can include DB subnet(s) 2230 that can be communicatively coupled to the service gateway 2236 contained in the data plane VCN 2218.

The untrusted app subnet(s) 2262 can include one or more primary VNICs 2264(1)-(N) that can be communicatively coupled to tenant virtual machines (VMs) 2266(1)-(N). Each tenant VM 2266(1)-(N) can be communicatively coupled to a respective app subnet 2267(1)-(N) that can be contained in respective container egress VCNs 2268(1)-(N) that can be contained in respective customer tenancies 2270(1)-(N). Respective secondary VNICs 2272(1)-(N) can facilitate communication between the untrusted app subnet(s) 2262 contained in the data plane VCN 2218 and the app subnet contained in the container egress VCNs 2268(1)-(N). Each container egress VCNs 2268(1)-(N) can include a NAT gateway 2238 that can be communicatively coupled to public Internet 2254 (e.g., public Internet 2054 of FIG. 20).

The Internet gateway 2234 contained in the control plane VCN 2216 and contained in the data plane VCN 2218 can be communicatively coupled to a metadata management service 2252 (e.g., the metadata management system 2052 of FIG. 20) that can be communicatively coupled to public Internet 2254. Public Internet 2254 can be communicatively coupled to the NAT gateway 2238 contained in the control plane VCN 2216 and contained in the data plane VCN 2218. The service gateway 2236 contained in the control plane VCN 2216 and contained in the data plane VCN 2218 can be communicatively coupled to cloud services 2256.

In some embodiments, the data plane VCN 2218 can be integrated with customer tenancies 2270. This integration can be useful or desirable for customers of the IaaS provider in some cases such as a case that may desire support when executing code. The customer may provide code to run that may be destructive, may communicate with other customer resources, or may otherwise cause undesirable effects. In response to this, the IaaS provider may determine whether to run code given to the IaaS provider by the customer.

In some examples, the customer of the IaaS provider may grant temporary network access to the IaaS provider and request a function to be attached to the data plane app tier 2246. Code to run the function may be executed in the VMs 2266(1)-(N), and the code may not be configured to run anywhere else on the data plane VCN 2218. Each VM 2266(1)-(N) may be connected to one customer tenancy 2270. Respective containers 2271(1)-(N) contained in the VMs 2266(1)-(N) may be configured to run the code. In this case, there can be a dual isolation (e.g., the containers 2271(1)-(N) running code, where the containers 2271(1)-(N) may be contained in at least the VM 2266(1)-(N) that are contained in the untrusted app subnet(s) 2262), which may help prevent incorrect or otherwise undesirable code from damaging the network of the IaaS provider or from damaging a network of a different customer. The containers 2271(1)-(N) may be communicatively coupled to the customer tenancy 2270 and may be configured to transmit or receive data from the customer tenancy 2270. The containers 2271(1)-(N) may not be configured to transmit or receive data from any other entity in the data plane VCN 2218. Upon completion of running the code, the IaaS provider may kill or otherwise dispose of the containers 2271(1)-(N).

In some embodiments, the trusted app subnet(s) 2260 may run code that may be owned or operated by the IaaS provider. In this embodiment, the trusted app subnet(s) 2260 may be communicatively coupled to the DB subnet(s) 2230 and be configured to execute CRUD operations in the DB subnet(s) 2230. The untrusted app subnet(s) 2262 may be communicatively coupled to the DB subnet(s) 2230, but in this embodiment, the untrusted app subnet(s) may be configured to execute read operations in the DB subnet(s) 2230. The containers 2271(1)-(N) that can be contained in the VM 2266(1)-(N) of each customer and that may run code from the customer may not be communicatively coupled with the DB subnet(s) 2230.

In other embodiments, the control plane VCN 2216 and the data plane VCN 2218 may not be directly communicatively coupled. In this embodiment, there may be no direct communication between the control plane VCN 2216 and the data plane VCN 2218. However, communication can occur indirectly through at least one method. An LPG 2210 may be established by the IaaS provider that can facilitate communication between the control plane VCN 2216 and the data plane VCN 2218. In another example, the control plane VCN 2216 or the data plane VCN 2218 can make a call to cloud services 2256 via the service gateway 2236. For example, a call to cloud services 2256 from the control plane VCN 2216 can include a request for a service that can communicate with the data plane VCN 2218.

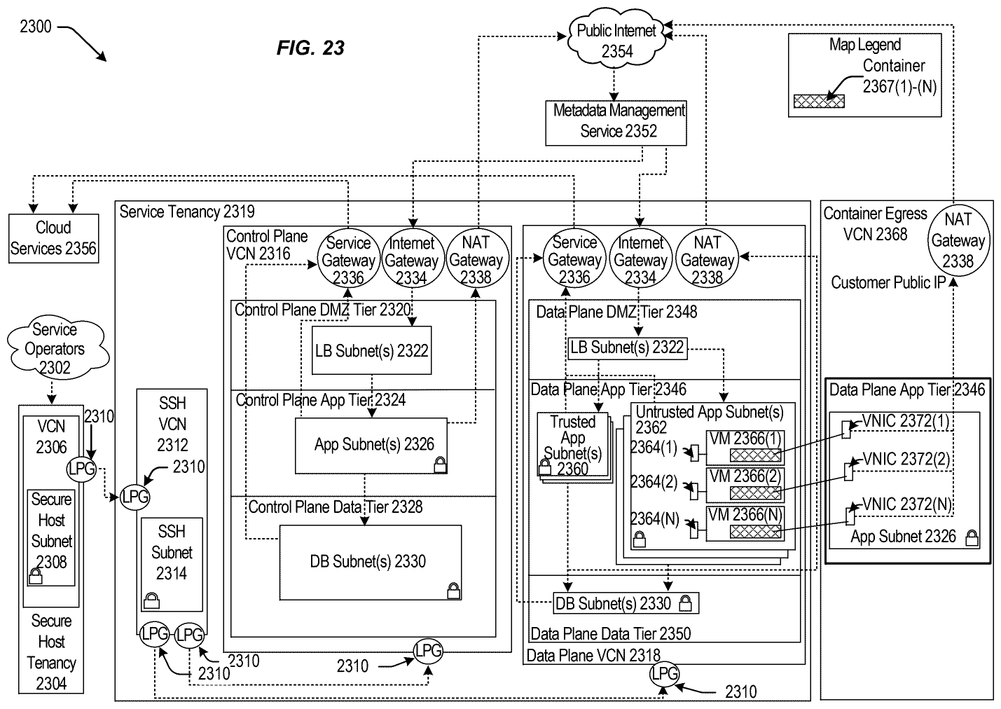

FIG. 23 is a block diagram 2300 illustrating another example pattern of an IaaS architecture, according to at least one embodiment. Service operators 2302 (e.g., service operators 2002 of FIG. 20) can be communicatively coupled to a secure host tenancy 2304 (e.g., the secure host tenancy 2004 of FIG. 20) that can include a virtual cloud network (VCN) 2306 (e.g., the VCN 2006 of FIG. 20) and a secure host subnet 2308 (e.g., the secure host subnet 2008 of FIG. 20). The VCN 2306 can include an LPG 2310 (e.g., the LPG 2010 of FIG. 20) that can be communicatively coupled to an SSH VCN 2312 (e.g., the SSH VCN 2012 of FIG. 20) via an LPG 2310 contained in the SSH VCN 2312. The SSH VCN 2312 can include an SSH subnet 2314 (e.g., the SSH subnet 2014 of FIG. 20), and the SSH VCN 2312 can be communicatively coupled to a control plane VCN 2316 (e.g., the control plane VCN 2016 of FIG. 20) via an LPG 2310 contained in the control plane VCN 2316 and to a data plane VCN 2318 (e.g., the data plane 2018 of FIG. 20) via an LPG 2310 contained in the data plane VCN 2318. The control plane VCN 2316 and the data plane VCN 2318 can be contained in a service tenancy 2319 (e.g., the service tenancy 2019 of FIG. 20).

The control plane VCN 2316 can include a control plane DMZ tier 2320 (e.g., the control plane DMZ tier 2020 of FIG. 20) that can include LB subnet(s) 2322 (e.g., LB subnet(s) 2022 of FIG. 20), a control plane app tier 2324 (e.g., the control plane app tier 2024 of FIG. 20) that can include app subnet(s) 2326 (e.g., app subnet(s) 2026 of FIG. 20), a control plane data tier 2328 (e.g., the control plane data tier 2028 of FIG. 20) that can include DB subnet(s) 2330 (e.g., DB subnet(s) 2230 of FIG. 22). The LB subnet(s) 2322 contained in the control plane DMZ tier 2320 can be communicatively coupled to the app subnet(s) 2326 contained in the control plane app tier 2324 and to an Internet gateway 2334 (e.g., the Internet gateway 2034 of FIG. 20) that can be contained in the control plane VCN 2316, and the app subnet(s) 2326 can be communicatively coupled to the DB subnet(s) 2330 contained in the control plane data tier 2328 and to a service gateway 2336 (e.g., the service gateway of FIG. 20) and a network address translation (NAT) gateway 2338 (e.g., the NAT gateway 2038 of FIG. 20). The control plane VCN 2316 can include the service gateway 2336 and the NAT gateway 2338.

The data plane VCN 2318 can include a data plane app tier 2346 (e.g., the data plane app tier 2046 of FIG. 20), a data plane DMZ tier 2348 (e.g., the data plane DMZ tier 2048 of FIG. 20), and a data plane data tier 2350 (e.g., the data plane data tier 2050 of FIG. 20). The data plane DMZ tier 2348 can include LB subnet(s) 2322 that can be communicatively coupled to trusted app subnet(s) 2360 (e.g., trusted app subnet(s) 2260 of FIG. 22) and untrusted app subnet(s) 2362 (e.g., untrusted app subnet(s) 2262 of FIG. 22) of the data plane app tier 2346 and the Internet gateway 2334 contained in the data plane VCN 2318. The trusted app subnet(s) 2360 can be communicatively coupled to the service gateway 2336 contained in the data plane VCN 2318, the NAT gateway 2338 contained in the data plane VCN 2318, and DB subnet(s) 2330 contained in the data plane data tier 2350. The untrusted app subnet(s) 2362 can be communicatively coupled to the service gateway 2336 contained in the data plane VCN 2318 and DB subnet(s) 2330 contained in the data plane data tier 2350. The data plane data tier 2350 can include DB subnet(s) 2330 that can be communicatively coupled to the service gateway 2336 contained in the data plane VCN 2318.

The untrusted app subnet(s) 2362 can include primary VNICs 2364(1)-(N) that can be communicatively coupled to tenant virtual machines (VMs) 2366(1)-(N) residing within the untrusted app subnet(s) 2362. Each tenant VM 2366(1)-(N) can run code in a respective container 2367(1)-(N), and be communicatively coupled to an app subnet 2326 that can be contained in a data plane app tier 2346 that can be contained in a container egress VCN 2368. Respective secondary VNICs 2372(1)-(N) can facilitate communication between the untrusted app subnet(s) 2362 contained in the data plane VCN 2318 and the app subnet contained in the container egress VCN 2368. The container egress VCN can include a NAT gateway 2338 that can be communicatively coupled to public Internet 2354 (e.g., public Internet 2054 of FIG. 20).

The Internet gateway 2334 contained in the control plane VCN 2316 and contained in the data plane VCN 2318 can be communicatively coupled to a metadata management service 2352 (e.g., the metadata management system 2052 of FIG. 20) that can be communicatively coupled to public Internet 2354. Public Internet 2354 can be communicatively coupled to the NAT gateway 2338 contained in the control plane VCN 2316 and contained in the data plane VCN 2318. The service gateway 2336 contained in the control plane VCN 2316 and contained in the data plane VCN 2318 can be communicatively coupled to cloud services 2356.

In some examples, the pattern illustrated by the architecture of block diagram 2300 of FIG. 23 may be considered an exception to the pattern illustrated by the architecture of block diagram 2200 of FIG. 22 and may be desirable for a customer of the IaaS provider if the IaaS provider cannot directly communicate with the customer (e.g., a disconnected region). The respective containers 2367(1)-(N) that are contained in the VMs 2366(1)-(N) for each customer can be accessed in real-time by the customer. The containers 2367(1)-(N) may be configured to make calls to respective secondary VNICs 2372(1)-(N) contained in app subnet(s) 2326 of the data plane app tier 2346 that can be contained in the container egress VCN 2368. The secondary VNICs 2372(1)-(N) can transmit the calls to the NAT gateway 2338 that may transmit the calls to public Internet 2354. In this example, the containers 2367(1)-(N) that can be accessed in real-time by the customer can be isolated from the control plane VCN 2316 and can be isolated from other entities contained in the data plane VCN 2318. The containers 2367(1)-(N) may also be isolated from resources from other customers.

In other examples, the customer can use the containers 2367(1)-(N) to call cloud services 2356. In this example, the customer may run code in the containers 2367(1)-(N) that requests a service from cloud services 2356. The containers 2367(1)-(N) can transmit this request to the secondary VNICs 2372(1)-(N) that can transmit the request to the NAT gateway that can transmit the request to public Internet 2354. Public Internet 2354 can transmit the request to LB subnet(s) 2322 contained in the control plane VCN 2316 via the Internet gateway 2334. In response to determining the request is valid, the LB subnet(s) can transmit the request to app subnet(s) 2326 that can transmit the request to cloud services 2356 via the service gateway 2336.

It should be appreciated that IaaS architectures 2000, 2100, 2200, 2300 depicted in the figures may have other components than those depicted. Further, the embodiments shown in the figures are only some examples of a cloud infrastructure system that may incorporate an embodiment of the disclosure. In some other embodiments, the IaaS systems may have more or fewer components than shown in the figures, may combine two or more components, or may have a different configuration or arrangement of components.

In certain embodiments, the IaaS systems described herein may include a suite of applications, middleware, and database service offerings that are delivered to a customer in a self-service, subscription-based, elastically scalable, reliable, highly available, and secure manner. An example of such an IaaS system is the Oracle Cloud Infrastructure (OCI) provided by the present assignee.

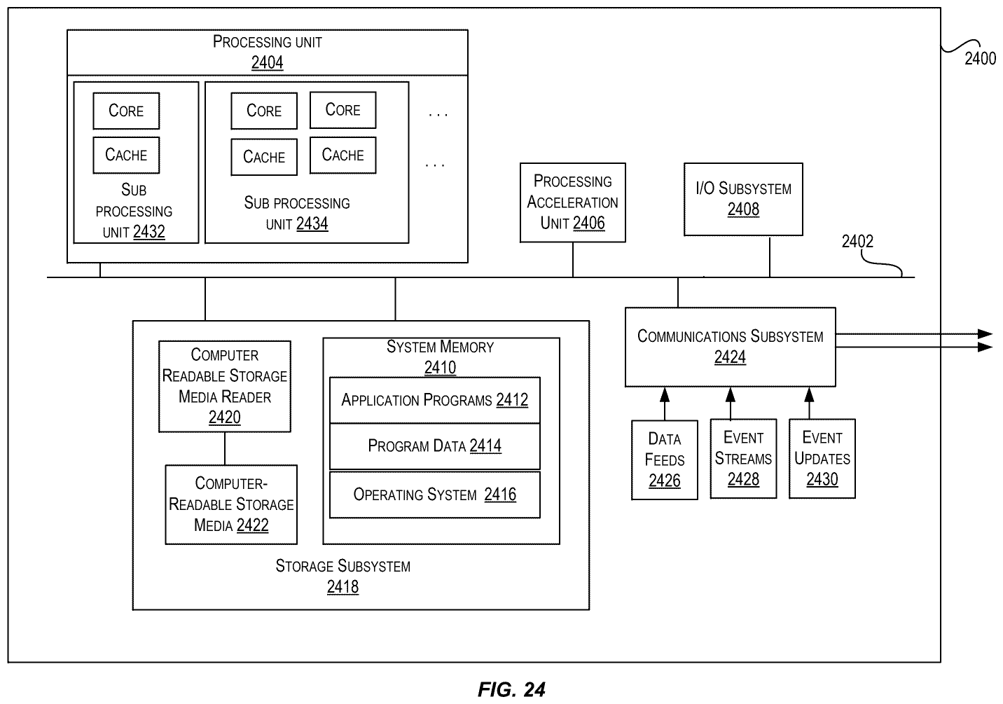

FIG. 24 illustrates an example computer system 2400, in which various embodiments may be implemented. The system 2400 may be used to implement any of the computer systems described above. As shown in the figure, computer system 2400 includes a processing unit 2404 that communicates with a number of peripheral subsystems via a bus subsystem 2402. These peripheral subsystems may include a processing acceleration unit 2406, an I/O subsystem 2408, a storage subsystem 2418 and a communications subsystem 2424. Storage subsystem 2418 includes tangible computer-readable storage media 2422 and a system memory 2410.

Bus subsystem 2402 provides a mechanism for letting the various components and subsystems of computer system 2400 communicate with each other as intended. Although bus subsystem 2402 is shown schematically as a single bus, alternative embodiments of the bus subsystem may utilize multiple buses. Bus subsystem 2402 may be any of several types of bus structures including a memory bus or memory controller, a peripheral bus, and a local bus using any of a variety of bus architectures. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard.

Processing unit 2404, which can be implemented as one or more integrated circuits (e.g., a conventional microprocessor or microcontroller), controls the operation of computer system 2400. One or more processors may be included in processing unit 2404. These processors may include single core or multicore processors. In certain embodiments, processing unit 2404 may be implemented as one or more independent processing units 2432 and/or 2434 with single or multicore processors included in each processing unit. In other embodiments, processing unit 2404 may also be implemented as a quad-core processing unit formed by integrating two dual-core processors into a single chip.

In various embodiments, processing unit 2404 can execute a variety of programs in response to program code and can maintain multiple concurrently executing programs or processes. At any given time, some or all of the program code to be executed can be resident in processor(s) 2404 and/or in storage subsystem 2418. Through suitable programming, processor(s) 2404 can provide various functionalities described above. Computer system 2400 may additionally include a processing acceleration unit 2406, which can include a digital signal processor (DSP), a special-purpose processor, and/or the like.

I/O subsystem 2408 may include user interface input devices and user interface output devices. User interface input devices may include a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may include, for example, motion sensing and/or gesture recognition devices such as the Microsoft Kinect® motion sensor that enables users to control and interact with an input device, such as the Microsoft Xbox® 360 game controller, through a natural user interface using gestures and spoken commands. User interface input devices may also include eye gesture recognition devices such as the Google Glass® blink detector that detects eye activity (e.g., ‘blinking’ while taking pictures and/or making a menu selection) from users and transforms the eye gestures as input into an input device (e.g., Google Glass®). Additionally, user interface input devices may include voice recognition sensing devices that enable users to interact with voice recognition systems (e.g., Siri® navigator), through voice commands.

User interface input devices may also include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, barcode reader 3D scanners, 3D printers, laser rangefinders, and eye gaze tracking devices. Additionally, user interface input devices may include, for example, medical imaging input devices such as computed tomography, magnetic resonance imaging, position emission tomography, medical ultrasonography devices. User interface input devices may also include, for example, audio input devices such as MIDI keyboards, digital musical instruments and the like.

User interface output devices may include a display subsystem, indicator lights, or non-visual displays such as audio output devices, etc. The display subsystem may be a cathode ray tube (CRT), a flat-panel device, such as that using a liquid crystal display (LCD) or plasma display, a projection device, a touch screen, and the like. In general, use of the term “output device” is intended to include all possible types of devices and mechanisms for outputting information from computer system 2400 to a user or other computer. For example, user interface output devices may include, without limitation, a variety of display devices that visually convey text, graphics and audio/video information such as monitors, printers, speakers, headphones, automotive navigation systems, plotters, voice output devices, and modems.

Computer system 2400 may comprise a storage subsystem 2418 that provides a tangible non-transitory computer-readable storage medium for storing software and data constructs that provide the functionality of the embodiments described in this disclosure. The software can include programs, code modules, instructions, scripts, etc., that when executed by one or more cores or processors of processing unit 2404 provide the functionality described above. Storage subsystem 2418 may also provide a repository for storing data used in accordance with the present disclosure.

As depicted in the example in FIG. 24, storage subsystem 2418 can include various components including a system memory 2410, computer-readable storage media 2422, and a computer readable storage media reader 2420. System memory 2410 may store program instructions that are loadable and executable by processing unit 2404. System memory 2410 may also store data that is used during the execution of the instructions and/or data that is generated during the execution of the program instructions. Various different kinds of programs may be loaded into system memory 2410 including but not limited to client applications, Web browsers, mid-tier applications, relational database management systems (RDBMS), virtual machines, containers, etc.

System memory 2410 may also store an operating system 2416. Examples of operating system 2416 may include various versions of Microsoft Windows®, Apple Macintosh®, and/or Linux operating systems, a variety of commercially-available UNIX® or UNIX-like operating systems (including without limitation the variety of GNU/Linux operating systems, the Google Chrome® OS, and the like) and/or mobile operating systems such as iOS, Windows® Phone, Android® OS, BlackBerry® OS, and Palm® OS operating systems. In certain implementations where computer system 2400 executes one or more virtual machines, the virtual machines along with their guest operating systems (GOSs) may be loaded into system memory 2410 and executed by one or more processors or cores of processing unit 2404.

System memory 2410 can come in different configurations depending upon the type of computer system 2400. For example, system memory 2410 may be volatile memory (such as random access memory (RAM)) and/or non-volatile memory (such as read-only memory (ROM), flash memory, etc.) Different types of RAM configurations may be provided including a static random access memory (SRAM), a dynamic random access memory (DRAM), and others. In some implementations, system memory 2410 may include a basic input/output system (BIOS) containing basic routines that help to transfer information between elements within computer system 2400, such as during start-up.

Computer-readable storage media 2422 may represent remote, local, fixed, and/or removable storage devices plus storage media for temporarily and/or more permanently containing, storing, computer-readable information for use by computer system 2400 including instructions executable by processing unit 2404 of computer system 2400.

Computer-readable storage media 2422 can include any appropriate media known or used in the art, including storage media and communication media, such as but not limited to, volatile and non-volatile, removable and non-removable media implemented in any method or technology for storage and/or transmission of information. This can include tangible computer-readable storage media such as RAM, ROM, electronically erasable programmable ROM (EEPROM), flash memory or other memory technology, CD-ROM, digital versatile disk (DVD), or other optical storage, magnetic cassettes, magnetic tape, magnetic disk storage or other magnetic storage devices, or other tangible computer readable media.

By way of example, computer-readable storage media 2422 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM, DVD, and Blu-Ray® disk, or other optical media. Computer-readable storage media 2422 may include, but is not limited to, Zip® drives, flash memory cards, universal serial bus (USB) flash drives, secure digital (SD) cards, DVD disks, digital video tape, and the like. Computer-readable storage media 2422 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, DRAM-based SSDs, magnetoresistive RAM (MRAM) SSDs, and hybrid SSDs that use a combination of DRAM and flash memory based SSDs. The disk drives and their associated computer-readable media may provide non-volatile storage of computer-readable instructions, data structures, program modules, and other data for computer system 2400.

Machine-readable instructions executable by one or more processors or cores of processing unit 2404 may be stored on a non-transitory computer-readable storage medium. A non-transitory computer-readable storage medium can include physically tangible memory or storage devices that include volatile memory storage devices and/or non-volatile storage devices. Examples of non-transitory computer-readable storage medium include magnetic storage media (e.g., disk or tapes), optical storage media (e.g., DVDs, CDs), various types of RAM, ROM, or flash memory, hard drives, floppy drives, detachable memory drives (e.g., USB drives), or other type of storage device.

Communications subsystem 2424 provides an interface to other computer systems and networks. Communications subsystem 2424 serves as an interface for receiving data from and transmitting data to other systems from computer system 2400. For example, communications subsystem 2424 may enable computer system 2400 to connect to one or more devices via the Internet. In some embodiments communications subsystem 2424 can include radio frequency (RF) transceiver components for accessing wireless voice and/or data networks (e.g., using cellular telephone technology, advanced data network technology, such as 3G, 4G or EDGE (enhanced data rates for global evolution), WiFi (IEEE 802.11 family standards, or other mobile communication technologies, or any combination thereof), global positioning system (GPS) receiver components, and/or other components. In some embodiments communications subsystem 2424 can provide wired network connectivity (e.g., Ethernet) in addition to or instead of a wireless interface.

In some embodiments, communications subsystem 2424 may also receive input communication in the form of structured and/or unstructured data feeds 2426, event streams 2428, event updates 2430, and the like on behalf of one or more users who may use computer system 2400.

By way of example, communications subsystem 2424 may be configured to receive data feeds 2426 in real-time from users of social networks and/or other communication services such as Twitter® feeds, Facebook® updates, web feeds such as Rich Site Summary (RSS) feeds, and/or real-time updates from one or more third party information sources.

Additionally, communications subsystem 2424 may also be configured to receive data in the form of continuous data streams, which may include event streams 2428 of real-time events and/or event updates 2430, that may be continuous or unbounded in nature with no explicit end. Examples of applications that generate continuous data may include, for example, sensor data applications, financial tickers, network performance measuring tools (e.g., network monitoring and traffic management applications), clickstream analysis tools, automobile traffic monitoring, and the like.

Communications subsystem 2424 may also be configured to output the structured and/or unstructured data feeds 2426, event streams 2428, event updates 2430, and the like to one or more databases that may be in communication with one or more streaming data source computers coupled to computer system 2400.

Computer system 2400 can be one of various types, including a handheld portable device (e.g., an iPhone® cellular phone, an iPad® computing tablet, a PDA), a wearable device (e.g., a Google Glass® head mounted display), a PC, a workstation, a mainframe, a kiosk, a server rack, or any other data processing system.

Due to the ever-changing nature of computers and networks, the description of computer system 2400 depicted in the figure is intended only as a specific example. Many other configurations having more or fewer components than the system depicted in the figure are possible. For example, customized hardware might also be used and/or particular elements might be implemented in hardware, firmware, software (including applets), or a combination. Further, connection to other computing devices, such as network input/output devices, may be employed. Based on the disclosure and teachings provided herein, a person of ordinary skill in the art will appreciate other ways and/or methods to implement the various embodiments.

Although specific embodiments have been described, various modifications, alterations, alternative constructions, and equivalents are also encompassed within the scope of the disclosure. Embodiments are not restricted to operation within certain specific data processing environments, but are free to operate within a plurality of data processing environments. Additionally, although embodiments have been described using a particular series of transactions and steps, it should be apparent to those skilled in the art that the scope of the present disclosure is not limited to the described series of transactions and steps. Various features and aspects of the above-described embodiments may be used individually or jointly.

Further, while embodiments have been described using a particular combination of hardware and software, it should be recognized that other combinations of hardware and software are also within the scope of the present disclosure. Embodiments may be implemented only in hardware, or only in software, or using combinations thereof. The various processes described herein can be implemented on the same processor or different processors in any combination. Accordingly, where components or services are described as being configured to perform certain operations, such configuration can be accomplished, e.g., by designing electronic circuits to perform the operation, by programming programmable electronic circuits (such as microprocessors) to perform the operation, or any combination thereof. Processes can communicate using a variety of techniques including but not limited to conventional techniques for inter process communication, and different pairs of processes may use different techniques, or the same pair of processes may use different techniques at different times.

The specification and drawings are, accordingly, to be regarded in an illustrative rather than a restrictive sense. It will, however, be evident that additions, subtractions, deletions, and other modifications and changes may be made thereunto without departing from the broader spirit and scope as set forth in the claims. Thus, although specific disclosure embodiments have been described, these are not intended to be limiting. Various modifications and equivalents are within the scope of the following claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments and does not pose a limitation on the scope of the disclosure unless otherwise claimed. No language in the specification should be construed as indicating any non-claimed element as essential to the practice of the disclosure.

Disjunctive language such as the phrase “at least one of X, Y, or Z,” unless specifically stated otherwise, is intended to be understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Preferred embodiments of this disclosure are described herein, including the best mode known for carrying out the disclosure. Variations of those preferred embodiments may become apparent to those of ordinary skill in the art upon reading the foregoing description. Those of ordinary skill should be able to employ such variations as appropriate and the disclosure may be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein.

All references, including publications, patent applications, and patents, cited herein are hereby incorporated by reference to the same extent as if each reference were individually and specifically indicated to be incorporated by reference and were set forth in its entirety herein.

In the foregoing specification, aspects of the disclosure are described with reference to specific embodiments thereof, but those skilled in the art will recognize that the disclosure is not limited thereto. Various features and aspects of the above-described disclosure may be used individually or jointly. Further, embodiments can be utilized in any number of environments and applications beyond those described herein without departing from the broader spirit and scope of the specification. The specification and drawings are, accordingly, to be regarded as illustrative rather than restrictive.

What is claimed is:

1. A computer-implemented method on a source, the computer-implemented method comprising:
sending a first packet to a first network node, the first network node being on a first network path between the source and a destination, the first packet destined to the destination;
storing instructions for updating packets to be sent to the destination, the instructions being based on an update to a first header of the first packet, the update performed by the first network node to send the first packet to the destination;
updating, based on the instructions, a second packet destined to the destination, a second header of the second packet defined based on the update; and
sending the second packet to the destination, the second packet sent using a second network path that is based on the second header and that bypasses the first network node.

2. The computer-implemented method of claim 1, further comprising:
receiving, from the first network node, a first flow update that includes first instructions about the update; and
updating an entry in a flow table, the entry associating a flow between the source and the destination with the first instructions.

3. The computer-implemented method of claim 2, further comprising:
determining that no entry is included in the flow table for the flow; and
including, in the first packet, an indicating that the first flow update is requested.

4. The computer-implemented method of claim 2, further comprising:
sending, to the first network node based on the first flow update, a probe packet;
receiving, from a second network node on the first network path, a second flow update that includes the first instructions and second instructions about an additional update performed by the second network node on the probe packet; and
updating the entry in the flow table to associate the flow with the first instructions and the second instructions, wherein the instructions include the first instructions and the second instructions.

5. The computer-implemented method of claim 1, further comprising:
receiving, from the first network node, a first flow update that includes first instructions about the update and second instructions about a different update to the first packet performed by a second network node on the first network path, wherein the instructions include first instructions and the second instructions; and
determining that the first instructions rather than the second instructions are to be performed such that the second packet is sent based on the first instructions being performed rather than the second instructions being performed.

6. The computer-implemented method of claim 1, further comprising:
determining that the instructions indicate that a copy of the second packet is to be generated and sent to a different destination; and
sending the copy to the different destination.

7. The computer-implemented method of claim 1, wherein the instructions are stored in an entry of a flow table, and wherein the computer-implemented method further comprises:
determining that the entry applies to the second packet;
determining the instructions from the entry; and
updating a header of the second packet based on the instructions, wherein the updated header corresponds to the second network path.

8. The computer-implemented method of claim 1, wherein the instructions are stored in an entry of a flow table, wherein the flow table associates a flow between the source and destination with the first network path and with the instructions, and wherein the computer-implemented method further comprises:
sending, after the first packet is sent, a probe packet on the first network path, wherein the probe packet is usable to determine a change to the instructions;
determining that the instructions in the entry apply to the second packet; and
updating a header of the second packet based on the instructions, wherein the updated header corresponds to the second network path.

9. The computer-implemented method of claim 1, wherein the instructions are stored in an entry of a flow table, and wherein the computer-implemented method further comprises:
determining that no update has been made to the entry for a predefined time duration; and
determining that the entry is no longer usable to send subsequent packets to the destination.

10. The computer-implemented method of claim 1, wherein the instructions are stored in an entry of a flow table, and wherein the computer-implemented method further comprises:
completing a software update installation on the source; and
persisting the flow table despite the software update installation.

11. A source comprising:
one or more processors; and
one or more memories storing program code that, upon execution by the one or more processors, configure the source to:
send a first packet to a first network node, the first network node being on a first network path between the source and a destination, the first packet destined to the destination;
store instructions for updating packets to be sent to the destination, the instructions being based on an update to a first header of the first packet, the update performed by the first network node to send the first packet to the destination;
update, based on the instructions, a second packet destined to the destination, a second header of the second packet defined based on the update; and
send the second packet to the destination, the second packet sent using a second network path that is based on the second header and that bypasses the first network node.

12. The source of claim 11, wherein a first portion of the instructions is received based on the first packet and wherein a second portion of the instructions is received based on a probe packet, wherein receiving the first portion triggers the source to send the probe packet on the first network path.

13. The source of claim 11, wherein the first packet indicates that the source supports using the instructions to bypass the first network node.

14. The source of claim 11, wherein the execution of the program code further configures the source to:
include, in the second packet, information about the first network node, wherein the destination is configured to validate the second packet based on the information.

15. The source of claim 11, wherein the execution of the program code further configures the source to:
receive, after the second packet is sent, a third packet on the first network path, the third packet sent by the destination.

16. The source of claim 11, wherein the execution of the program code further configures the source to:
receive, after the second packet is sent, a third packet on the second network path, the third packet sent by the destination.

17. One or more computer-readable storage media storing program code that, upon execution on a source, cause the source to perform operations comprising:
sending a first packet to a first network node, the first network node being on a first network path between the source and a destination, the first packet destined to the destination;
storing instructions for updating packets to be sent to the destination, the instructions being based on an update to a first header of the first packet, the update performed by the first network node to send the first packet to the destination;
updating, based on the instructions, a second packet destined to the destination, a second header of the second packet defined based on the update; and
sending the second packet to the destination, the second packet sent using a second network path that is based on the second header and that bypasses the first network node.

18. The one or more computer-readable storage media of claim 17, wherein the instructions indicate a network operation to apply and a set of values to use for the network operation, and wherein the second packet is updated by applying the network operation using the set of values.

19. The one or more computer-readable storage media of claim 17, wherein the operations further comprise:
receiving, by the source from the destination, an acknowledgment to the second packet, the acknowledgement received along the first network path.

20. The one or more computer-readable storage media of claim 17, wherein the operations further comprise:
receiving, by the source from the destination, a first acknowledgment to the first packet, the first acknowledgement received along the first network path; and
receiving, by the source from the destination, a second acknowledgment to the second packet, the second acknowledgement received along the second network path.
